(19) United States
(12) Patent Application Publication
(10) Pub. No.: US 2007/0281865 A1
(43) Pub. Date: Dec. 6, 2007

(54) MULTI-FUNCTIONAL SPACER FOR GLYCANS

(76) Inventor: Ola Blixt, La Jolla, CA (US)

Correspondence Address: SCHWEGMAN, LUNDBERG & WOESSNER, P.A., P.O. BOX 2938, MINNEAPOLIS, MN, 55402, US

(21) Appl. No.: 11/749,650

(22) Filed: May 16, 2007

Related U.S. Application Data
(60) Provisional application No. 60/747,395, filed on May 16, 2006.

(51) Int. Cl. C40B 40/04; C40B 30/06

(52) U.S. Cl. 506/9; 506/19; 536/18.7

(57) ABSTRACT

The invention relates to a bi-functional spacer molecule that can be attached to the terminus of glycan molecules without significant alteration of the glycan structure. In addition, the spacer has a reactive moiety on the end distal to the glycan that facilitates linkage of spacer-derivatized glycans to other entities such as solid supports. The spacer molecules of the invention are therefore useful for making arrays of immobilized glycan molecules.

### RELATED APPLICATIONS

This application claims the benefit of U.S. Provisional Ser. No. 60/747,395, filed May 16, 2006, which application is incorporated herein by reference.

This application is also related to U.S. Provisional Ser. No. 60/550,667, filed Mar. 5, 2004, U.S. Provisional Ser. No. 60/558,598, filed Mar. 31, 2004, U.S. Provisional Ser. No. 60/629,833, filed Nov. 19, 2004, and PCT Application Ser. No. PCT/US2005/007370, filed Mar. 7, 2005, the contents of all of which are incorporated herein by reference.

### GOVERNMENT FUNDING

The invention described herein was made with United States Government support under Grant Number U54GM62116 awarded by the National Institutes of Health. The United States Government has certain rights in this invention.

### FIELD OF THE INVENTION

The invention relates to bi-functional spacers or linkers useful for tagging, derivatizing and immobilizing glycans. For example, the spacers can be used to generate glycan libraries, where each glycan is attached to a spacer molecule of the invention, thereby allowing the glycans to be easily manipulated, linked to other molecules or immobilized onto glycan arrays. Methods for making and using the bi-functional spacers of the invention are also provided.

### BACKGROUND OF THE INVENTION

Glycans are typically the first and potentially the most important interface between cells and their environment. However, due to the diversity of monosaccharide and hence, glycan, structures it is difficult to analyze, selectively label and manipulate glycans. Thus, new methods and reagents are needed to facilitate glycan analysis, derivatization and manipulation.

Such analysis, derivatization and manipulation are important because glycans play a key role in biological systems. As vital constituents of all living systems, glycans are involved in recognition, adherence, motility and signaling processes. There are at least three reasons why glycans should be studied: (1) all cells in living organisms, and viruses, are coated with diverse types of glycans; (2) glycosylation is a form of post- or co-translational modification occurring in all living organisms; and (3) altered glycosylation is an indication of an early and possibly critical point in development of human pathologies. Jun Hirabayashi, Oligosaccharide microarrays for glycomics, TRENDS IN BIOTECHNOLOGY 21 (4): 141-143 (2003); Sen-Itiroh Hakomori, Tumor-associated carbohydrate antigens defining tumor malignancy: Basis for development of and-cancer vaccines in THE MOLECULAR IMMUNOLOGY OF COMPLEX CARBOHYDRATES-2 (Albert M Wu, ed., Kluwer Academic/Plenum, 2001). These cell-identifying glycosylated molecules include glycoproteins and glycolipids and are specifically recognized by various glycan-recognition proteins, called ‘lectins.’ However, the enormous complexity of these interactions, and the lack of well-defined glycan libraries and analytical methods have been major obstacles in the development of glycomics.

Derivatization of free reducing glycans has mostly been done via reductive amination with various amine-containing compounds such as proteins, glycolipids and solid-supports. Thus, Xia et al. (Nat Methods 2:845-850) has described a procedure to attach an aromatic 2,6-diaminopyridine (DAP) via reductive amination and obtain an aromatic amine for further functionalization. However, as an anchoring technique, this method suffers from poor reactivity and the end result is an open ring derivative on the penultimate saccharide so that part of the structural integrity of the glycan has been lost. Thus, new methods that avoid structural alteration of the glycans when linking glycans to other entities are needed.

The interaction of glycans with proteins can be studied in various ways but such studies would be facilitated by agents that permit the glycans to be immobilized or linked to other entities (e.g. detectable labels). The inventors have recently developed a new method that employs microarrays of immobilized glycan structures (Blixt et al. Proc Natl Acad Sci USA 101: 17033-17038). The development of nucleotide and protein microarrays has revolutionized proteomics and pharmacogenomics. Microarray technology has become a key tool for new important discoveries highlighted in more than 3,600 articles published in 2005 alone. However, in order to immobilize a glycan onto an array, each glycan type must be synthesized de novo chemically or chemo-enzymatically, and then be subjected to further derivatization where the terminal reducing sugar is coupled to an absorptive or reactive group required for printing on a selected array surface. The ideal glycan array would have the entire glycome on a single chip allowing screening and analysis of interactions with essentially any glycan binding protein. However, the development of glycan microarrays has progressed slowly, in large part because complex methods are required for the synthesis of glycans and reliable immobilization of chemically and structurally diverse glycans is difficult.

Thus, there is a need for new reagents and facile methods to activate microgram quantities of glycans and derivatize any free reducing glycan for direct immobilization, labeling, analysis, further conjugation or manipulation of the glycans.

### SUMMARY OF THE INVENTION

The invention involves a novel bi-functional spacer with two reactive moieties: a first moiety with selective reactivity towards free glycans and an amine that can be used as an attachment site for linking the glycan to a label, a solid support, a drug, or any other entity selected by one of skill in the art. Using the methods provided herein, glycans with diverse structures can be efficiently linked to the present bi-functional spacers. These spacer-derivatized glycans can readily be attached to a label, pharmaceutical agent, solid support or other entity.

Thus, one aspect of the invention is a bi-functional spacer of formula IA or IB:

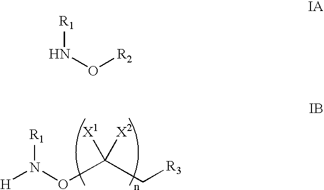

wherein:
R₁ is alkyl, acyl, aryl, lipid, amine, thiol, or hydroxy;
R₂ is alkyl, alkylamine, alkylthiol, polyalkylene glycol, peptide, lipid, alkylcarboxylate, alkylcarboxylate alkyl ester, alkylacyl, alkylketone, or alkylaldehyde that can be substituted with one or more amine groups;
R₃ is amine, alkene, alkyne, alkyl, alkylthiol, thiol, hydroxy, carboxylic acid, alkylcarboxylate, alkylcarboxylate alkyl ester, polyalkylene glycol, peptide, lipid, dye, label, acylalkyl, alkylketone, aldehyde, or alkylaldehyde that can be substituted with one or more amine groups;
n is an integer of from 0 to 50; and
X¹ and X² are each hydrogen or halo.

Another aspect of the invention is a method for linking the bi-functional spacers of the invention to a glycan. This method involves simply mixing the spacer with a glycan in an aqueous buffer. In some embodiments, the pH of the aqueous buffer is somewhat acidic. For example, the pH off the aqueous buffer can be about pH 4.0 to about 6.9, or about 4.1 to about 6.8, or about 4.2 to about 6.7. In some embodiments, an aqueous acetate buffer is used when attaching the spacers onto glycans. In one embodiment, the glycan to linked or attached to the bi-functional spacer is a reducing glycan. Such a reducing glycan has a free terminal hydroxy, aldehyde or ketone group.

Another aspect of the invention involves a spacer-derivatized glycan. In general, the spacer-derivatized glycans of the invention have the following structure. 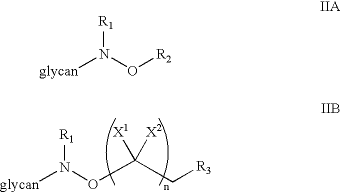
where the definition of R₁, R₂ and R₃ are as defined above. Another aspect of the invention involves a library of glycans, each glycan having a spacer molecule of the invention attached thereto. The libraries of the invention can include two or more spacer-derivatized glycans like those shown in Formulae IIA and IIIB.

Each spacer-derivatized glycan has at least one sugar unit, typically at least two sugar units. The spacer-derivatized glycans of the invention include straight chain and branched oligosaccharides as well as naturally occurring and synthetic glycans. Any type of sugar unit can be present in the spacer-derivatized glycans of the invention, including allose, altrose, arabinose, glucose, galactose, gulose, fucose, fructose, idose, lyxose, mannose, ribose, talose, xylose, neuraminic acid or other sugar units. Such sugar units can have a variety of substituents. For example, substituents that can be present instead of, or in addition to, the substituents typically present on the sugar units include N-acetyl, N-acetylneuraminic acid, oxy (═O), sialic acid, sulfate (—SO₄⁻), phosphate (—PO₄⁻), lower alkoxy, lower alkanoyloxy, lower acyl, and/or lower alkanoylaminoalkyl. Fatty acids, lipids, amino acids, peptides and proteins can also be attached to the glycans of the invention. The spacer-derivatized glycan libraries of the invention generally have many separate glycans, for example, at least about 35 glycans, at least about 50 glycans, or at least about 225 glycans.

Thus, one aspect of the invention is a spacer-derivatized glycan, glycan library, glycan array (or microarray), an immobilized glycan or the like that includes a bi-functional spacer of the invention. For example, when many different spacer-derivatized glycans are attached to a solid support, a glycan array is formed.

In another embodiment, the invention provides an array of glycan molecules comprising a solid support and a library of glycan molecules, wherein each glycan molecule is covalently attached to the solid support via a spacer of the invention. In some embodiments, the array is a microarray. Arrays and microarrays of the invention include a solid support and a multitude of defined glycan probe locations on the solid support, each glycan probe location defining a region of the solid support that has multiple copies of one type of glycan molecule attached thereto, where each glycan is attached to the solid surface of the array by a spacer of the invention. These microarrays can have, for example, between about 2 to about 100,000 different glycan probe locations, or between about 2 to about 10,000 different glycan probe locations. The libraries of the invention can therefore be attached to a solid support though the spacers of the invention to form an array or a microarray.

In another embodiment, the invention provides a method of identifying whether a test molecule or test substance can bind to a glycan present in a library or on an array of the invention. The method involves contacting the library or the array with the test molecule or test substance and observing whether the test molecule or test substance binds to a glycan in the library or on the array.

In another embodiment, the invention provides a method of identifying to which glycan a test molecule or test substance can bind, wherein the glycan is present in a library or on an array of the invention. The method involves contacting the library or the array with the test molecule or test substance and observing to which glycan in the library or on the array the test molecule or test substance can bind.

Another aspect of the invention is a method for attaching or “printing” the spacer-derivatized glycans onto a solid support. The method making of the arrays of the invention involves derivatizing the solid support surface of the array with a trialkoxysilane bearing reactive moieties such as N-hydroxysuccinimide (NHS), amino (—NH₂), isothiocyanate (—NCS) or hydroxyl (—OH) to generate at least one derivatized glycan probe location on the array, and contacting the derivatized probe location with a spacer-derivatized glycan to thereby attach the spacer-derivatized glycan to the derivatized probe location and thereby provide the array. The density of glycans at each glycan probe location can be modulated by varying the concentration of the glycan solution applied to the derivatized glycan probe location.

Another aspect of the invention is a composition comprising a carrier and an effective amount of at least one spacer-derivatized glycan molecule, wherein each glycan molecule in the composition is linked to a spacer of the invention and to an agent selected by one of skill in the art. For example, the agent can be a drug, a small molecule, a toxin, a protein, a nucleic acid, an antibody, a detectable label or other agent. These compositions can be useful for treating a variety of diseases. Examples of diseases that can be treated with the compositions of the invention include bacterial infections, viral infections, inflammations, cancers, transplant rejection, autoimmune diseases or combinations thereof. These compositions can be formulated for immunization of a mammal. Alternatively, some these compositions can be formulated in a food supplement. The compositions of the invention are useful for treating and preventing diseases such as cancer, bacterial infection, viral infection, inflammation, transplant rejection, autoimmune diseases and the like.

Another aspect of the invention is a method of detecting antibodies in bodily fluids of a patient. The method involves contacting a test sample obtained from the patient with a spacer-derivatized glycan library or spacer-derivatized glycan array of the invention, and observing whether antibodies in the test sample bind to glycans in the library or the array. According to one aspect of the invention, the type of glycan bound by such antibodies is indicative of the presence of a distinctive disease, or the propensity to develop a distinctive disease in the patient. The binding pattern of test samples can be compared to the binding of control samples from healthy patients that do not suffer from the disease in question. The test and control samples can, for example, be blood, serum, tissue, urine, saliva, milk or other samples. One convenient sample type for use in the invention is serum.

For example, patients with breast cancer have circulating antibodies that react with glycans such as ceruloplasmin, Neu5Acα2-6GalNAcα, certain T-antigens carrying various modifications, LNT-2 (a known ligand for tumor-promoting Galectin-4; see Huflejt & Leffler (2004). Glycoconjugate J, 20: 247-255), Globo-H-, and GM1-antigens. GM1 is a glycan that includes the following carbohydrate structure: Gal-beta3-GalNAc-beta-4-[Neu5Ac-alpha3]-Gal-beta-4-Glc-beta. Sulfo-T is a T-antigen with sulfate residues, for example, Sulfo-T can include a carbohydrate of the following structure: Galβ3GalNAc. Globo-His a glycan that includes the following carbohydrate structure: Fucose-alpha2-Gal-beta3-GalNAc-beta3-Gal-alpha-4-Gal-beta-4-Glc. LNT-2 is a glycan that includes the following carbohydrate structure: GlcNAc-beta3-Gal-beta4-Glc-beta. The presence of cancer can therefore be detected with the present glycan arrays by detecting antibodies that bind to these glycans. Moreover, cancer can be treated or prevented by administering compositions of these cancer-specific antigens to boost an immune response against cancerous tissues.

In another example, neutralizing antibodies known to be specific for HIV can be detected using spacer-derivatized mannose-containing glycans, in particular Man8 glycans. Hence, HIV infection may be detected by detecting whether a patient has circulating antibodies that bind to Man8 glycans.

Another aspect of the invention is a method of detecting transplant tissue rejection in a transplant recipient comprising contacting a test sample from the transplant recipient with an array of spacer-derivatized glycans and observing whether one or more spacer-derivatized glycan is bound by antibodies in the test sample. The method can also be used to detect xenotransplant tissue rejection. Glycans specific for the transplanted or xenotranplanted tissue are used in spacer-derivatized glycan arrays to observe whether antibodies to the transplant or xenotransplant are present in the test sample. If the antibodies are present they will bind to the glycans on the array. Examples of spacer-derivatized glycans that can be used in an array for detecting transplant rejection include any one of Gal-alpha3-Gal-beta (structure 33 of FIG. 7), Gal-alpha3-Gal-beta4-GlcNAc[alpha3-Fucose]-beta (structure 34 of FIG. 7), Gal-alpha3-Gal-beta4-Glc-beta (structure 35 of FIG. 7), Gal-alpha3-Gal[alpha2-Fucose]-beta4-GlcNAc-beta (structure 36 of FIG. 7), Gal-alpha3-Gal-beta4-GalAc-beta (structure 37 of FIG. 7), Gal-alpha3-GalAc-alpha (structure 38 of FIG. 7), Gal-alpha3-Gal-beta (structure 39 of FIG. 7), or Gal-beta4-GlcNAc[alpha3-Fucose]-beta (structure 65 in FIG. 7) or a combination thereof.

The spacer-derivatized glycans used on the arrays of the invention can therefore include glycans that react with antibodies associated with particular disease or condition. For example, antibodies that are produced in response to cancer, bacterial infection, viral infection, inflammation, transplant rejection, autoimmune diseases and the like can be detected using the glycan arrays of the invention.

Another aspect of the invention is an array or a microarray for detecting breast cancer that includes a solid support and a multitude of defined glycan probe locations on the solid support, each glycan probe location defining a region of the solid support that has multiple copies of one type of spacer-derivatized glycan molecule attached thereto, wherein the glycans are attached to the microarray by a spacer or linker of the invention. These microarrays can have, for example, between about 2 to about 100,000 different glycan probe locations, or between about 2 to about 10,000 different glycan probe locations. Glycans selected for use in the arrays or microarrays include those that react with antibodies associated with neoplasia in sera of mammals with benign or pre-malignant tumors. Glycans such as ceruloplasmin, Neu5Acα2-6GalNAcα, certain T-antigens, LNT-2, Globo-H-, and GM1 can be used in these types of arrays.

Another aspect of the invention is a kit comprising any of the arrays of the invention and instructions for using the array. In another embodiment, the invention provides a kit comprising the library of spacer-derivatized glycans and instructions for making an array from the library of spacer-derivatized glycans.

### DESCRIPTION OF THE FIGURES

This patent or application file contains at least one drawing executed in color. Copies of this patent or patent application publication with color drawings will be provided by the Office upon request and payment of the necessary fee.

FIG. 1 illustrates covalent printing of a diverse glycan library onto an amino-reactive glass surface and image analysis using standard microarray technology. In some embodiments, an amino-functionalized glycan library is printed onto an N-hydroxysuccinimide (NHS) derivatized glass surface to form a microarray of glycans where each glycan type is printed onto a known glycan probe location.

FIG. 2A-B each provide representative glycan structures on an array. Glycan structures detected by glycan binding proteins are shown in the symbol nomenclature nomenclature adopted by the Consortium for Functional Glycomics (http://www.functionalglycomics.org). Symbols employed are shown in the inset shown in FIG. 2B and summarized as follows: galactose (open circles); N-acetyl-galactosamine (open squares); glucose (solid circles); N-acetyl-glucosamine (closed squares); glucuronic acid (GlcA; half-filled diamonds); mannose (cross-hatched circles); fucose (closed triangles); xylose (open stars); N-acetylneuraminic acid (NeuAc; closed diamond); N-glycolylneuraminic acid (NeuGc; open diamonds); 2-Keto-3-deoxynananic acid (KDN; cross-hatched diamonds). The types of bonds (alpha (α) or beta (β)) are indicated above the bond (line). The bond linkage site on the sugar moeity is also indicated. A more complete list of glycans used in the arrays of the invention can be found in FIG. 7 and further description of the types of saccharides, saccharide derivatives and saccharide linkages employed can be found in the tables and text provided herein.

FIG. 3A-C provides data illustrating printing optimization and the specificity of selected plant lectins. FIG. 3A provides a graph relating the glycan concentration and length of printing time to the relative fluorescence of the signal detected from binding Concanavalin A conjugated to fluorescinisothiocyanate (Con A-FITC). Optimized glycan concentrations and printing times were determined by printing selected mannose glycan structures and then detecting Con A binding thereto. A representative mannose glycan (136, see FIG. 7) was printed at various concentrations (4 μM-500 μM) in replicates of eight at six different time points. FIG. 3B illustrates the binding specificities of Con A-FITC and ECA-FITC on the complete array of glycans whose structures are provided in FIG. 7. As shown, Con A binds to mannose-containing glycans that can end with N-acetylglucosamine, and Erythrina cristagalli binds to galactose-β4-N-acetylglucosamine-containing glycans that can end with fucose. The symbols employed for the depicted glycan structures are the same as those described in FIG. 2 and FIG. 7.

FIG. 4 illustrates the specificity of mammalian glycan binding proteins on a glycan array of the invention. C-Type lectin (DC-SIGN): DC-SIGN-Fc chimera (30 μg/mL) detected by secondary goat anti-human-IgG-Alexa-488 antibody (10 μg/mL) bound selectively to α1-2- and/or α1-3/4-fucosylated glycans as well as to Manα1-2-glycans. Siglec (CD22): CD22-Fc chimera (10 μg/mL) pre-complexed with secondary goat anti-human-IgG-Alexa-488 (5 μg/mL) and tertiary rabbit anti-goat-IgG-FITC (2.5 μg/mL) antibodies bound exclusively to Neu5Acα2-6Gal-glycans. Galectin (Galectin-4): Human Galectin-4-Alexa488 (10 μg/mL) evaluated with glycans printed at 100 μM (100 μM) and at 10 μM (10 μM) bound preferentially to blood group glycans. Structures of glycans bound by the mammalian glycan binding proteins are shown.

FIG. 5 illustrates the specificity of various anti-carbohydrate antibodies on the glycan arrays of the invention. Anti-CD15: Mouse anti-CD15-FITC monoclonal antibody (BD Biosciences Clone HI98, 100 tests) bound exclusively to Lewis^{X} glycans. Human anti-HIV 2G12: 2G12 monoclonal antibody (30 μg/mL) pre-complexed with goat anti-human-IgG-FITC (15 μg/mL) bound to specific Manα1-2-glycans including the Man8 and Man9 N-glycans. Human Serum: Human serum of ten healthy individuals (1:25 dilution) were individually bound to glycan arrays and detected by subsequent overlay with monoclonal mouse anti-human-IgG-IgM-IgA-Biotin antibody (10 μg/mL) and Streptavidin-FITC (10 μg/mL) respectively. Results represent the mean and standard deviation for binding in all ten experiments. Anti-carbohydrate antibodies detecting various blood group antigens as well as mannans and bacterial fragments were found. Structures of glycans bound by the anti-carbohydrate antibodies are shown.

FIG. 6 illustrates the specificity of various bacterial and viral glycan binding proteins for certain glycans in the arrays of the invention. Cyanovirin-N: Cyanovirin-N (30 μg/mL) detected with secondary polyclonal rabbit anti-CVN (10 μg/mL) and tertiary anti-rabbit-IgG-FITC (10 μg/mL) bound various α1-2 mannosides. Influenza H3 hemagglutinin: Pure recombinant hemagglutinin (150 μg/mL) derived from Duck/Ukraine/1/63 (H3/N7), pre-complexed with mouse anti-HisTag-IgG-Alexa-488 (75 μg/mL) and anti-mouse-IgG-Alexa-488 (35 μg/mL), bound exclusively to Neu5Acα2-3Gal-terminating glycans. Influenza virus: Intact influenza virus A/Puerto Rico/8/34 (H1N1) was applied at 100 μg/ml in the presence of 10 μM of the neuraminidase inhibitor oseltamivir carboxylate. The virus bound a wide spectrum of sialosides with both NeuAcα2-3Gal and NeuAcα2-6Gal sequences. Structures of glycans bound by the viral glycan binding proteins are shown.

FIG. 7A-D provides a schematic diagram of glycans used in some of the glycan arrays of the invention. Symbols used for sugar moeities, spacers and other chemical entities are shown in FIG. 7D, many of which are the same as the symbols described in FIG. 2 (a few additional symbols for sugar units are defined in the lower right hand corner of FIG. 7D). Glycans 1-200 shown in FIG. 7 correspond to glycans 1-200 provided in Table 3, where a chemical name for each glycan is provided.

FIG. 8 provides a bar graph illustrating which glycans react with anti-carbohydrate antibodies found in sera of metastatic breast cancer patients. Each bar represents the relative fluorescence intensity of a given anti-glycan antibody in an individual patient. Cross-hatched bars represent the intensities observed for reaction of metastatic breast cancer patient serum with background (#1, a negative control), ceruloplasmin (#2), Neu5Gc(2-6)GalNAc (#3), Neu5Ac(2-6)GalNAc (#4), GMI (#5), Sulfo-T (#6), Globo-H (#7), LNT-2 (#8) and Rhamnose (#10, a positive control). Open bars, which are the tenth bar in each cluster of bars, represent the average values for metastatic cancer patients 1-9. Yellow bars, which are the eleventh bars in each cluster or bars, represent the average values for non-metastatic breast cancer patients. Darkly shaded bars, which are the twelfth through twenty-first bars, represent the average values of “healthy” individuals. The last or twenty-second bars in each cluster of bars, represent the average values for healthy patients 12-21.

FIG. 9 provides a bar graph illustrating the relative fluorescence levels of selected breast cancer-associated anti-glycan antibodies in cancer (bars to the left, N=9) and non-cancer patients (bars to the right, N=10). The types of glycans that react with these antibodies are shown with the number of patients whose sera react with the indicated glycan. The inset provides a combined relative fluorescence levels for a group of known cancer-associated T-antigens carrying various modifications in metastatic breast cancer patients (1) and in “healthy” individuals (2).

FIG. 10 provides a bar graph illustrating the levels of tumor associated anti-glycan antibodies (from FIG. 9) in individual breast cancer patients. Cross-hatched bars represent the combined signal observed for each individual metastatic cancer patient. Shaded bars represent the combined signal observed for each individual non-cancer patient.

FIG. 11A provides a structure for alpha-Gal, a glycan structure that is found in several of the glycans that bind to antibodies from patients who received transplanted porcine fetal pancreas islet-like cell clusters (the symbols used for this structure are defined herein, for example, in FIG. 2 or 7).

FIG. 11B provides a structure for the LeX glycan (compound 65 in FIG. 7), which is the glycan corresponding to compound 8 in the bar graph of FIG. 11D. Note that, as shown in FIG. 11D, essentially no anti-LeX antibodies are detected in patient's serum before or after transplantation.

FIG. 11C provides a structure for the alpha-Gal-LeX glycan (compound 34 in FIG. 7), which is the glycan corresponding to compound 9 in the bar graph of FIG. 11D.

FIG. 11D provides a bar graph illustrating that certain circulating antibodies, which are reactive with glycans, are present in diabetic patients who received transplanted porcine fetal pancreas islet-like cell clusters. Serum was taken from these patients before transplantation and at 1 month after (t=1), 6 months after (t=2) and 12 months after (t=3) transplantation. The bars represent the reactivity of serum antibodies with glycans 33-39 (structures shown in FIG. 7) that are identified as glycans 1-7, respectively, on the x-axis. The lighter open bars represent the reactivity of the identified glycan for antibodies in the patient's serum before transplantation. The cross-hatched bars represent the combined reactivities of the identified glycan for antibodies in the patient's serum at t=1-3 after transplantation. In each case, more anti-glycan antibodies are present in the patients' serum after transplantation than before transplantation. Hence, an immune response directed against transplanted tissue can be detected using the glycan arrays of the invention.

FIG. 12 illustrates that human saliva contains antibodies that bind discrete types of glycans. The types of glycans are identified by the numbers along the x-axis, where the numbers correspond to the glycans 1-200 described herein.

FIG. 13A-D illustrate that glycans linked to the spacer molecules of the invention (1006, 1007, 1011, corresponding to 6, 7 and 11 in FIG. 13A-D) are readily immobilized onto an array, whereas other amino-derivatized glycans (1008, 1010, corresponding to 8 and 10 in FIG. 13A-D) are not readily immobilized. Each of the derivatized glycans 1006-1008, 1010-1012, 1016 was printed onto a section of the solid surface of the array (identified on the array as sections 6-8, 10-12, and T-ant/PS Nm glycans, respectively) in a series of concentrations, where the concentration decreased two-fold from each glycan spot to the next, progressing from left to right. FIG. 13A shows a scanned image of the array. The 1006-1008, 1010-1012 LacNAc glycans were detected using the LacNAc-specific plant lectin RCA I. The 1011 glycan was also detected using the Neu5Acα2-6-LacNAc-specific lectin SNA, which binds only to glycans containing the Neu5Acα2-6-LacNAc structure (section 11A in FIG. 13A). In addition, the 1016 glycan was detected with the Galβ1-3GalNAc-specific BPL lectin (section labeled T-ant in FIG. 13A) and with the lpt3 monoclonal antibody, which binds specifically to 1016 (section labeled PS N.m in FIG. 13A). FIG. 13B is a bar-graph of the fluorescence intensity observed for the 1006-1008, 1010-1012, 1016 glycan array as obtained from scanner data out-put file after staining with RCA antibodies. Note that while the 1016 glycan was detected on the array by the Galβ1-3GalNAc-specific BPL lectin (T-ant) and by the PS N.m antibody (FIG. 13A), the RCA lectin did not bind to the 1016 glycan (FIG. 13B). FIG. 13C is a bar graph showing the fluorescence intensity of the glycan 1011 section of the array after staining with the Neu5Acα2-6-LacNAc-specific lectin SNA, which binds only to glycans containing the Neu5Acα2-6-LacNAc structure (see also, section 11A in FIG. 13A).). FIG. 13D is a bar graph showing the fluorescence intensity of the glycan 1016 T-ant and PS N.m sections of the array after staining with the Galβ1-3GalNAc-specific BPL lectin (T-ant), and the lpt3 specific monoclonal antibody that specifically binds 1016 (PS N.m).

### DETAILED DESCRIPTION OF THE INVENTION

The invention provides bi-functional spacer or linker molecules useful for attachment to glycans. The spacers have two reactive groups, an amino group that permits facile attachment of the spacer to a solid surface and an O-linked aminoalkyl that readily reacts with the terminal saccharide residues of glycans under mild, aqueous conditions that do not adversely affect the structures of glycans. Thus, the spacers and methods of the invention can be used to derivatize and/or immobilize glycans to facilitate glycan manipulation, analysis and identification of proteins and other agents that bind to such glycans.

The bi-functional spacers and glycoconjugates containing such spacers have several important advantages over those currently available. First, attachment of the spacer does not adversely affect glycan structure so that when the spacer is attached to a glycan the structural integrity of the glycan is preserved. Second, after attachment of the spacer to a glycan, the spacer provides a reactive amine for efficient coupling onto amine reactive glass slide or other supports. Such attachment can be done under mild conditions that do not adversely affect glycan structures. Third, simple one-pot, one-step coupling procedures are used for spacer attachment to glycans and for immobilization of spacer-derivatized glycans onto solid surfaces (e.g. arrays). Fourth, the spacers of the invention are selectively reactive with various free reducing saccharides on the ends of glycans, rather than with saccharides found in the middle of glycan chains. Finally, glycans linked to the present spacers form stable conjugates.

The invention also relates to libraries and arrays of spacer-derivatized glycans that can be used for identifying which types of proteins, receptors, antibodies, lipids, nucleic acids, carbohydrates and other molecules and substances can bind to a given glycan structure. The inventive libraries, arrays and methods have several advantages. For example, the arrays and methods of the invention provide highly reproducible results. Moreover, the libraries and arrays of the invention provide large numbers and varieties of glycans. For example, the libraries and arrays of the invention have at least two, at least three, at least ten, at least twenty, at least thirty five, at least fifty, at least one hundred, or at least two hundred glycans. In some embodiments, the libraries and arrays of the invention have about 2 to about 100,000, or about 2 to about 10,000, or about 2 to about 1,000, or about 2 to 500 different glycans per array. Such large numbers of glycans permit simultaneous assay of a multitude of glycan types.

As described herein, glycan arrays have been used for successfully screening a variety of glycan binding proteins. Such experiments demonstrate that little degradation of the glycan occurs and only small amounts of glycan binding proteins are consumed during a screening assay. Hence, the arrays of the invention can be used for more than one assay. The arrays and methods of the invention provide high signal to noise ratios. The screening methods provided by the invention are fast and easy because they involve only one or a few steps. No surface modifications or blocking procedures are typically required during the assay procedures of the invention.

Definitions

The following abbreviations may be used: α₁-AGP means alpha-acid glycoprotein; AF488 means AlexaFluour-488; CFG means Consortium for Functional Glycomics; Con A means Concanavalin A; CVN means Cyanovirin-N; DC-SIGN means dendritic cell-specific ICAM-grabbing nonintegrin; ECA means Erythrina cristagalli; ELISA means enzyme-linked immunosorbent assay; FITC means Fluorescinisothiocyanate; GBP means Glycan Binding Protein; HIV means human immunodeficiency virus; HA means influenza hemagglutinin; NHS means N-hydroxysuccinimide; PBS means phosphate buffered saline; SDS means sodium dodecyl sulfate; SEM means standard error of mean; and Siglec means sialic acid immunoglobulin superfamily lectins.

The following definitions are used, unless otherwise described: Halo is fluoro, chloro, bromo, or iodo. Alkyl, alkoxy, alkenyl, alkynyl, etc. denote both straight and branched groups; but reference to an individual radical such as “propyl” embraces only the straight chain radical, a branched chain isomer such as “isopropyl” being specifically referred to. Aryl denotes a phenyl radical or an ortho-fused bicyclic carbocyclic radical having about nine to ten ring atoms in which at least one ring is aromatic. Heteroaryl encompasses a radical attached via a ring carbon of a monocyclic aromatic ring containing five or six ring atoms consisting of carbon and one to four heteroatoms each selected from the group consisting of non-peroxide oxygen, sulfur, and N(X) wherein X is absent or is H, O, (C₁-C₄)alkyl, phenyl or benzyl, as well as a radical of an ortho-fused bicyclic heterocycle of about eight to ten ring atoms derived therefrom, particularly a benz-derivative or one derived by fusing a propylene, trimethylene, or tetramethylene diradical thereto.

It will be appreciated by those skilled in the art that compounds of the invention having a chiral center may exist in and be isolated in optically active and racemic forms.

Some compounds may exhibit polymorphism. It is to be understood that the present invention encompasses any racemic, optically-active, polymorphic, or stereoisomeric form, or mixtures thereof, of a compound of the invention, which possess the useful properties described herein, it being well known in the art how to prepare optically active forms (for example, by resolution of the racemic form by recrystallization techniques, by synthesis from optically-active starting materials, by chiral synthesis, or by chromatographic separation using a chiral stationary phase), or using other similar tests which are well known in the art.

Specific and preferred values listed below for radicals, substituents, and ranges, are for illustration only; they do not exclude other defined values or other values within defined ranges for the radicals and substituents.

Specifically, (C₁-C₆)alkyl can be methyl, ethyl, propyl, isopropyl, butyl, iso-butyl, sec-butyl, pentyl, 3-pentyl, or hexyl; (C₃-C₆)cycloalkyl can be cyclopropyl, cyclobutyl, cyclopentyl, or cyclohexyl; (C₃-C₆)cycloalkyl(C₁-C₆)alkyl can be cyclopropylmethyl, cyclobutylmethyl, cyclopentylmethyl, cyclohexylmethyl, 2-cyclopropylethyl, 2-cyclobutylethyl, 2-cyclopentylethyl, or 2-cyclohexylethyl; (C₁-C₆)alkoxy can be methoxy, ethoxy, propoxy, isopropoxy, butoxy, iso-butoxy, sec-butoxy, pentoxy, 3-pentoxy, or hexyloxy; (C₂-C₆)alkenyl can be vinyl, allyl, 1-propenyl, 2-propenyl, 1-butenyl, 2-butenyl, 3-butenyl, 1,-pentenyl, 2-pentenyl, 3-pentenyl, 4-pentenyl, 1-hexenyl, 2-hexenyl, 3-hexenyl, 4-hexenyl, or 5-hexenyl; (C₂-C₆)alkynyl can be ethynyl, 1-propynyl, 2-propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl, or 5-hexynyl; (C₁-C₆)alkanoyl can be acetyl, propanoyl or butanoyl; halo(C₁-C₆)alkyl can be iodomethyl, bromomethyl, chloromethyl, fluoromethyl, trifluoromethyl, 2-chloroethyl, 2-fluoroethyl, 2,2,2-trifluoroethyl, or pentafluoroethyl; hydroxy(C₁-C₆)alkyl can be hydroxymethyl, 1-hydroxyethyl, 2-hydroxyethyl, 1-hydroxypropyl, 2-hydroxypropyl, 3-hydroxypropyl, 1-hydroxybutyl, 4-hydroxybutyl, 1-hydroxypentyl, 5-hydroxypentyl, 1-hydroxyhexyl, or 6-hydroxyhexyl; (C₁-C₆)alkoxycarbonyl can be methoxycarbonyl, ethoxycarbonyl, propoxycarbonyl, isopropoxycarbonyl, butoxycarbonyl, pentoxycarbonyl, or hexyloxycarbonyl; (C₁-C₆)alkylthio can be methylthio, ethylthio, propylthio, isopropylthio, butylthio, isobutylthio, pentylthio, or hexylthio; (C₂-C₆)alkanoyloxy can be acetoxy, propanoyloxy, butanoyloxy, isobutanoyloxy, pentanoyloxy, or hexanoyloxy; aryl can be phenyl, indenyl, or naphthyl; and heteroaryl can be furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl, (or its N-oxide), thienyl, pyrimidinyl (or its N-oxide), indolyl, isoquinolyl (or its N-oxide) or quinolyl (or its N-oxide).

The term “saccharide” includes monosaccharides, disaccharides, trisaccharides and polysaccharides. The term includes glucose, sucrose fructose and ribose, as well as deoxy sugars such as deoxyribose and the like. Saccharide derivatives can conveniently be prepared as described in International Patent Applications Publication Numbers WO 96/34005 and 97/03995. A saccharide can conveniently be linked to the remainder of a compound of formula I through an ether bond.

A “defined glycan probe location” as used herein is a predefined region of a solid support to which a density of glycan molecules, all having similar glycan structures, is attached. The terms “glycan region,” or “selected region”, or simply “region” are used interchangeably herein for the term defined glycan probe location. The defined glycan probe location may have any convenient shape, for example, circular, rectangular, elliptical, wedge-shaped, and the like. In some embodiments, a defined glycan probe location and, therefore, the area upon which each distinct glycan type or a distinct group of structurally related glycans is attached is smaller than about 1 cm², or less than 1 mm², or less than 0.5 mm². In some embodiments the glycan probe locations have an area less than about 10,000 μm² or less than 100 μm². The glycan molecules attached within each defined glycan probe location are substantially identical. Additionally, multiple copies of each glycan type are present within each defined glycan probe location. The number of copies of each glycan types within each defined glycan probe location can be in the thousands to the millions.

As used herein, the arrays of the invention have defined glycan probe locations, each with “one type of glycan molecule.” The “one type of glycan molecule” employed can be a group of substantially structurally identical glycan molecules or a group of structurally similar glycan molecules. There is no need for every glycan molecule within a defined glycan probe location to have an identical structure. In some embodiments, the glycans within a single defined glycan probe location are structural isomers, have variable numbers of sugar units or are branched in somewhat different ways. However, in general, the glycans within a defined glycan probe location have substantially the same type of sugar units and/or approximately the same proportion of each type of sugar unit. The types of substituents on the sugar units of the glycans within a defined glycan probe location are also substantially the same.

The term lectin refers to a molecule that interacts with, binds, or crosslinks carbohydrates. The term galectin is an animal lectin. Galectins generally bind galactose-containing glycan.

As used herein a “patient” is a mammal or a bird. Such mammals and birds include domesticated animals, farm animals, animals used in experiments, zoo animals and the like. For example, the patient can be a dog, cat, monkey, horse, rat, mouse, rabbit, goat, ape or human mammal. In other embodiments, the animal is a bird such as a chicken, duck, goose or a turkey. In many embodiments, the patient is a human.

Some of the structural elements of the glycans described herein are referenced in abbreviated form. Many of the abbreviations used are provided in the Table 1. Moreover the glycans of the invention can have any of the sugar units, monosaccharides or core structures provided in Table 1 or described elsewhere in this application.

TABLE 1

| | | Long | Short |
|---|---|---|---|
| Trivial Name | Monosaccharide/Core | Code | Code |
| D-Glcp | D-Glucopyranose | Glc | G |
| D-Galp | D-Galactopyranose | Gal | A |
| D-GlcpNAc | N-Acetylglucopyranose | GlcNAc | GN |
| D-GlcpN | D-Glucosamine | GlcN | GQ |
| D-GalpNAc | N-Acetylgalactopyranose | GalNAc | AN |
| D-GalpN | D-Galactosamine | GalN | AQ |
| D-Manp | D-Mannopyranose | Man | M |
| D-ManpNAc | D-NJ-Acetylmannopyranose | ManNAc | MN |
| D-Neup5Ac | N-Acetylneuraminic acid | NeuAc | NN |
| D-Neu5G | D-N-Glycolylneuraminic acid | NeuGc | NJ |
| D-Neup | Neuraminic acid | Neu | N |
| KDN* | 2-Keto-3-deoxynananic acid | KDN | K |
| Kdo | 3-deoxy-D-manno-2 | Kdo | W |
| | octulopyranosylono | | |
| D-GalpA | D-Galactoronic acid | GalA | L |
| D-Idop | D-Iodoronic acid | Ido | I |
| L-Rhap | L-Rhamnopyranose | Rha | H |
| L-Fucp | L-Fucopyranose | Fuc | F |
| D-Xylp | D-Xylopyranose | Xyl | X |
| D-Ribp | D-Ribopyranose | Rib | B |
| L-Araf | L-Arabinofuranose | Ara | R |
| D-GlcpA | D-Glucoronic acid | GlcA | U |
| D-Allp | D-Allopyranose | All | O |
| D-Apip | D-Apiopyranose | Api | P |
| D-Tagp | D-Tagopyranose | Tag | T |
| D-Abep | D-Abequopyranose | Abe | Q |
| D-Xulp | D-Xylulopyranose | Xul | D |
| D-Fruf | D-Fructofuranose | Fru | E |

*Another name for KDN is: 3-deoxy-D-glycero-K-galacto-nonulosonic acid.

The sugar units or other saccharide structures present in the glycans of the invention can be chemically modified in a variety of ways. A listing of some of the types of modifications and substituents that the sugar units in the glycans of the invention can possess, along with the abbreviations for these modifications/substituents is provided below in Table 2.

TABLE 2

| Modification type | Symbol | Modification type | Symbol |
|---|---|---|---|
| Acid | A | Acid | A |
| N-Methylcarbamoyl | ECO | deacetylated N-Acetyl | Q |
| | | (amine) | |
| pentyl | EE | Deoxy | Y |
| octyl | EH | Ethyl | ET |
| ethyl | ET | Hydroxyl | OH |
| inositol | IN | Inositol | IN |
| N-Glycolyl | J | Methyl | ME |
| methyl | ME | N-Acetyl | N |
| N-Acetyl | N | N-Glycolyl | J |
| hydroxyl | OH | N-Methylcarbamoyl | ECO |
| phosphate | P | N-Sulfate | QS |
| phosphocholine | PC | O-Acetyl | T |
| Phosphoethanolamine (2- | PE | Octyl | EH |
| aminoethylphosphate) | | Pentyl | EE |
| Pyrovat acetal | PYR* | Phosphate | P |
| Deacetylated N-Acetyl | Q | Phosphocholine | PC |
| (amine) | | | |
| N-Sulfate | QS | Phosphoethanolamine (2- | PE |
| sulfate | S or Su | aminoethylphosphate) | |
| O-Acetyl | T | Pyrovat acetal | PYR* |
| deoxy | Y | | |

*when 3 is present, it means 3,4, when 4 is present it means 4,6.

Bonds between sugar units are alpha (α) or beta (β) linkages, meaning that relative to the plane of the sugar ring, an alpha bond goes down whereas a beta bond goes up. In the shorthand notation sometimes used herein, the letter “a” is used to designate an alpha bond and the letter “b” is used to designate a beta bond.
Spacer or Linker of the Invention

The spacers of the invention are bi-functional spacers containing both an alkyl N,O-hydroxylamine moiety and an R₃ group such as an amine moiety. The amine moiety can be used for attachment onto the N-hydroxysuccinimide (NHS) activated glycan array platform developed previously by the inventors (see PCT Application Ser. No. PCT/US2005/007370, which is incorporated by reference herein).

Thus, a bi-functional spacer of the invention has Formula IA or IB:

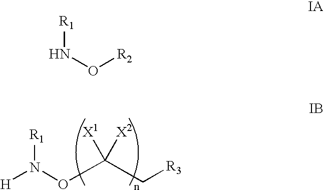

wherein:
R₁ is alkyl, acyl, aryl, lipid, amine, thiol, or hydroxy;
R₂ is alkyl, alkylamine, alkylthiol, polyalkylene glycol, peptide, lipid, alkylcarboxylate, alkylcarboxylate alkyl ester, alkylacyl, alkylketone, or alkylaldehyde that can be substituted with one or more amine groups;
R₃ is amine, alkene, alkyne, alkyl, alkylthiol, thiol, hydroxy, carboxylic acid, alkylcarboxylate, alkylcarboxylate alkyl ester, polyalkylene glycol, peptide, lipid, dye, label, acylalkyl, alkylketone, aldehyde, or alkylaldehyde that can be substituted with one or more amine groups;
n is an integer of from 0 to 50; and
X¹ and X² are each hydrogen or halo.

As shown above, the R₃ group can be a variety of substituents. However, the skilled artisan may choose to use spacer molecules where R₃ is amine. Thus, spacers of the invention can also have formula IC.

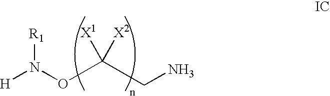

Similarly, in some embodiments the R₂ group is an alkylamine. The length of the bi-functional spacer can be modulated by employing alkyl or alkylenehalo of varying lengths as indicated in formulae IB and IC. Thus, the integer n can vary from 0 to 50. In some embodiments the R₂ group is a lower alkylamine, where n is 0 to 6. In other embodiments, longer spacers may be desirable, in which case longer alkyls may be used. Similarly, the length of the spacer chains of formula IA can be modulated by employing shorter or longer alkyl, alkylamine, alkylthiol, polyalkylene glycol, peptide, lipid, alkylcarboxylate, alkylcarboxylate alkyl ester, alkylacyl, alkylketone, or alkylaldehyde chains. Thus, one of skill in the art may choose a variety of lengths for the spacer, and modulate the spacer size to accommodate the needs of the skilled artisan.

The X¹ and X² groups can independently be hydrogen or halo. In some embodiments, the X¹ and/or X² groups are fluoro or hydrogen. In other embodiments, the X¹ and X² groups are both hydrogen.

As indicated above, the R₁ can be a variety of substituents. However, in some embodiments, R₁ is alkyl, and preferably lower alkyl. Thus, one of skill in the art may choose to use methyl, ethyl, propyl, butyl, pentyl, or hexyl for R₁. As illustrated herein, a spacer of formula ID, where R₁ is methyl is useful in some embodiments.

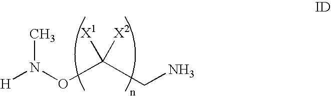

In other embodiments, the R₃ group is an alkene or alkyne. For example, spacer of formula IE or IF, where R₃ is ethylene or ethylyne is useful in some embodiments.

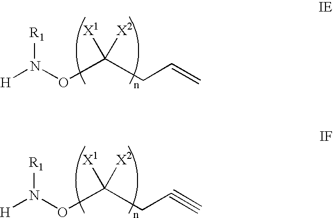

In some embodiments, the spacers of the invention also have a dye or label. Such a dye or label can be attached to a convenient site on the spacer. For example, a spacer with a dye or label can have structure of the following formula (IG): 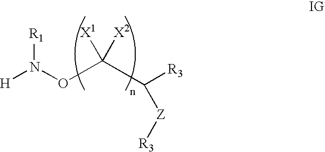
wherein Z is sulfur atom (S) or oxygen atom (O), and the other substituents are as defined herein. Examples of compounds of formula IG can have the following structures:

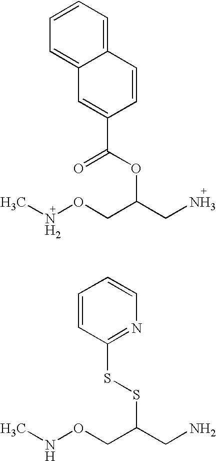

A dye or label is any molecule or composition that is detectable by, for instance, spectroscopic, photochemical, biochemical, immunochemical, electrical, optical, or chemical means. Examples of dyes or labels that can be attached to or used with the ligands of the invention include radioactive isotopes, enzyme substrates, co-factors, ligands, chemiluminescent or fluorescent agents, haptens, enzymes, colloidal gold particles, colored latex particles, and epitope tags. Many of these dyes and labels have been disclosed previously and are known to those of ordinary skill (see, for instance, U.S. Pat. Nos. 4,275,149; 4,313,734; 4,373,932; and 4,954,452). In some embodiments, the dye or label is a fluorescent dye.

The spacers of the invention can be made by procedures available in the art. Alternatively, the spacers can be made by the methods of the invention. According to the present invention, an N-Boc-protected alkyl N,O-hydroxylamine can readily be reacted with N-Boc-protected 2-aminoalkyl bromide to yield, after deprotection with trifluoroacetic acid, the bi-functional spacer. Yields up to 87% can be achieved and the purity of the resulting spacer molecule is typically greater than 90%, and usually greater than 95%, as detected by ¹H NMR.

Thus, for example, a hydroxyalkylamine is reacted with di-tert-butyl ester of a dicarbonic acid in the presence of the triethylamine for a time sufficient to form a compound having a protected amine. Then, the hydroxyl group is replaced with a halo group by reaction with lithium halide (e.g. lithium bromide) after treatment with mesyl chloride and triethylamine. Compound 1022, a N-Boc-protected 2-aminoalkylhalide (where Y is halide), is formed with the structure shown below. 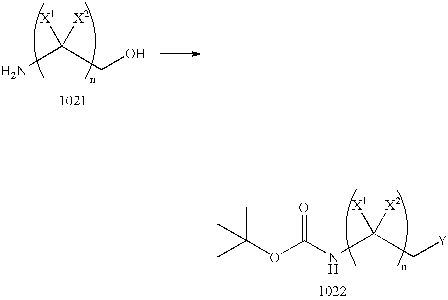
The X¹ and X² groups are as defined hereinabove, and the Y group is halo (F, Br, Cl or I). In some embodiments, Y is Br.

To form an N-Boc-protected methyl N,O-hydroxylamine (1004), N-methyl-hydroxylamine can be reacted with dicarbonic acid di-tert-butyl ester in the presence of the triethylamine. 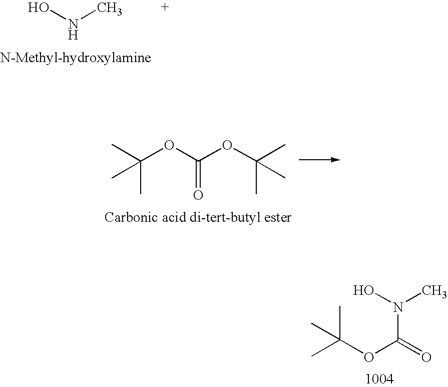
If desired, an alkyl can be used in place of the methyl group on compound 1004, for example, by using N-alkyl-hydroxylamine instead of N-methyl-hydroxylamine in this reaction.

To form the complete spacer molecule IB, the N-Boc-protected alkyl N,O-hydroxylamine (e.g., 1004) is treated with sodium hydride in dimethylformamide at room temperature. The reaction mixture is then cooled to 0° C. and the N-Boc-protected 2-aminoalkylhalide (1022) is added. The mixture is stirred while on ice for several hours. A protected spacer molecule 1005 is formed, which can be separated from reactants and impurities using a silica column. Trifluoroacetic acid is used to remove the Boc group. 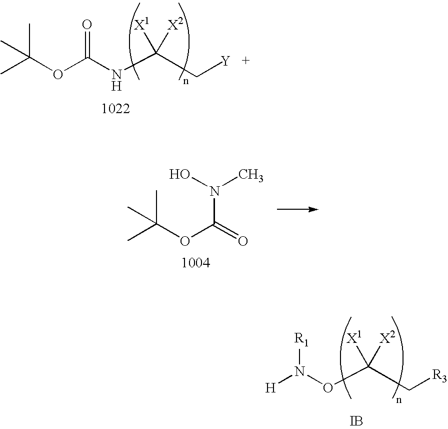
Glycans

The invention provides compositions, libraries and arrays of glycans that have the present spacers and are useful for analysis of glycan binding reactions, epitope identification, detecting, treating and preventing disease, as well as antibody preparation. These spacer-derivatized glycans include numerous different types of carbohydrates and oligosaccharides.

In general, the major structural attributes and composition of the separate glycans in the present libraries and arrays have been identified. In some embodiments, the libraries, compositions and glycan arrays consist of separate, substantially pure pools of glycans, carbohydrates and/or oligosaccharides. In other embodiments, glycans are used whose source is defined but whose structures may not be known with certainty. In many embodiments, the glycans used in the invention are pure or substantially pure. However, some of the glycans may be a mixture of similarly structured glycans, glycan isomers or be a mixture of glycans from the same source. The glycans of the libraries described herein can be used to make the glycan arrays of the invention.

Glycans that can be linked to the spacers of the invention include straight chain and branched oligosaccharides as well as naturally occurring and synthetic glycans. For example, the glycan can be a glycoamino acid, a glycopeptide, a glycolipid, a glycoaminoglycan (GAG), a glycoprotein, a whole cell, a cellular component, a glycoconjugate, a glycomimetic, a glycophospholipid anchor (GPI), glycosyl phosphatidylinositol (GPI)-linked glycoconjugates, bacterial lipopolysaccharides and endotoxins. The glycans can also include N-glycans, O-glycans, glycolipids and glycoproteins.

The spacer-derivatized glycans of the invention include 2 or more sugar units. Any type of sugar unit can be present in the glycans of the invention, including, for example, allose, altrose, arabinose, glucose, galactose, gulose, fucose, fructose, idose, lyxose, mannose, ribose, talose, xylose, or other sugar units. The tables provided herein list other examples of sugar units that can be used in the glycans of the invention. Such sugar units can have a variety of modifications and substituents. Some examples of the types of modifications and substituents contemplated are provided in the tables herein. For example, sugar units can have a variety of substituents in place of the hydrogen (H), hydroxy (—OH), carboxylate (—COO⁻), and methylenehydroxy (—CH₂—OH) substituents. Thus, lower alkyl moieties can replace any of the hydrogen atoms from the hydroxy (—OH), carboxylic acid (—COOH) and methylenehydroxy (—CH₂—OH) substituents of the sugar units in the glycans of the invention. For example, amino acetyl (—NH—CO—CH₃) can replace any of the hydrogen atoms from the hydroxy (—OH), carboxylic acid (—COOH) and methylenehydroxy (—CH₂—OH) substituents of the sugar units in the glycans of the invention. N-acetylneuraminic acid can replace any of the hydrogen atoms from the hydroxy (—OH), carboxylic acid (—COOH) and methylenehydroxy (—CH₂—OH) substituents of the sugar units in the glycans of the invention. Sialic acid can replace any of the hydrogen atoms from the hydroxy (—OH), carboxylic acid (—COOH) and methylenehydroxy (—CH₂—OH) substituents of the sugar units in the glycans of the invention. Amino or lower alkyl amino groups can replace any of the OH groups on the hydroxy (—OH), carboxylic acid (—COOH) and methylenehydroxy (—CH₂—OH) substituents of the sugar units in the glycans of the invention. Sulfate (—SO₄⁻) or phosphate (—PO₄⁻) can replace any of the OH groups on the hydroxy (—OH), carboxylic acid (—COOH) and methylenehydroxy (—CH₂—OH) substituents of the sugar units in the glycans of the invention. Hence, substituents that can be present instead of, or in addition to, the substituents typically present on the sugar units include N-acetyl, N-acetylneuraminic acid, oxy (═O), sialic acid, sulfate (—SO₄⁻), phosphate (—PO₄⁻), lower alkoxy, lower alkanoyloxy, lower acyl, and/or lower alkanoylaminoalkyl.

It will be appreciated by those skilled in the art that the glycans of the invention having one or more chiral centers may exist in and be isolated in optically active and racemic forms. Some compounds may exhibit polymorphism. It is to be understood that the present invention encompasses any racemic, optically-active, polymorphic, or stereoisomeric form, or mixtures thereof, of a glycan of the invention. Procedures available in the art can be used to prepare optically active forms (for example, by resolution of the racemic form by recrystallization techniques, by synthesis from optically-active starting materials, by chiral synthesis, or by chromatographic separation using a chiral stationary phase).

Specific and preferred values listed below for substituents and ranges, are for illustration only; they do not exclude other defined values or other values within defined ranges or for the substituents.

The spacer-derivatized libraries, arrays and compositions of the invention are particularly useful because diverse glycan structures are difficult to manipulate, analyze and use for determining what molecules interact with those glycans. Moreover, glycans have a plethora of hydroxyl (—OH) groups and each of those hydroxyl groups is substantially of equal chemical reactivity. Thus, manipulation of a single selected hydroxyl group is difficult. Blocking one hydroxyl group and leaving one free is not trivial and requires a carefully designed series of reactions to obtain the desired regioselectivity and stereoselectivity. Moreover, the number of manipulations required increases with the size of the oligosaccharide. Hence, while synthesis of a disaccharide may require 5 to 12 steps, as many as 40 chemical steps can be involved in synthesis of a typical tetrasaccharide. In the past, chemical synthesis of oligosaccharides was therefore fraught with purification problems, low yields and high costs. However the invention has solved these problems by providing libraries and arrays of numerous structurally distinct glycans. Moreover, the present invention provides spacer molecules that are specifically reactive with the terminal saccharide residues, rather than the saccharides found in the middle of the glycan.

The glycans of the invention can be obtained by a variety of procedures. For example, some of the chemical approaches developed to prepare N-acetyllactosamines by glycosylation between derivatives of galactose and N-acetylglucosamine are described in Aly, M. R. E.; Ibrahim, E.-S. I.; El-Ashry, E.-S. H. E. and Schmidt, R. R., Carbohydr. Res. 1999, 316, 121-132; Ding, Y.; Fukuda, M. and Hindsgaul, O., Bioorg. Med. Chem. Lett. 1998, 8, 1903-1908; Kretzschmar, G. and Stahl, W., Tetrahedr. 1998, 54, 6341-6358. These procedures can be used to make the glycans of the present invention, but because there are multiple tedious protection/deprotection steps involved in such chemical syntheses, the amounts of products obtained in these methods can be low, for example, in milligram quantities.

One way to avoid protection-deprotection steps typically required during glycan synthesis is to mimic nature's way of synthesizing oligosaccharides by using regiospecific and stereospecific enzymes, called glycosyltransferases, for coupling reactions between the monosaccharides. These enzymes catalyze the transfer of a monosaccharide from a glycosyl donor (usually a sugar nucleotide) to a glycosyl acceptor with high efficiency. Most enzymes operate at room temperature in aqueous solutions (pH 6-8), which makes it possible to combine several enzymes in one pot for multi-step reactions. The high regioselectivity, stereoselectivity and catalytic efficiency make enzymes especially useful for practical synthesis of oligosaccharides and glycoconjugates. See Koeller, K. M. and Wong, C.-H., Nature 2001, 409, 232-240; Wymer, N. and Toone, E. J., Curr. Opin. Chem. Biol. 2000, 4, 110-119; Gijsen, H. J. M.; Qiao, L.; Fitz, W. and Wong, C.-H., Chem. Rev. 1996, 96, 443-473.

Recent advances in isolating and cloning glycosyltransferases from mammalian and non-mammalian sources such as bacteria facilitate production of various oligosaccharides. DeAngelis, P. L., Glycobiol. 2002, 12, 9R-16R; Endo, T. and Koizumi, S., Curr. Opin. Struct. Biol. 2000, 10, 536-541; Johnson, K. F., Glycoconj. J. 1999, 16, 141-146. In general, bacterial glycosyltransferases are more relaxed regarding donor and acceptor specificities than mammalian glycosyltransferases. Moreover, bacterial enzymes are well expressed in bacterial expression systems such as E. coli that can easily be scaled up for over expression of the enzymes. Bacterial expression systems lack the post-translational modification machinery that is required for correct folding and activity of the mammalian enzymes whereas the enzymes from the bacterial sources are compatible with this system. Thus, in many embodiments, bacterial enzymes are used as synthetic tools for generating glycans, rather than enzymes from the mammalian sources.

For example, the repeating Galβ(1-4)GlcNAc-unit can be enzymatically synthesized by the concerted action of β4-galactosyltransferase (β4GalT) and β3-N-acetyllactosamninyltransferase (β3GlcNAcT). Fukuda, M., Biochim. Biophys. Acta. 1984, 780:2, 119-150; Van den Eijnden, D. H.; Koenderman, A. H. L. and Schiphorst, W. E. C. M., J. Biol. Chem. 1988, 263, 12461-12471. The inventors have previously cloned and characterized the bacterial N. meningitides enzymes β4GalT-GalE and β3GlcNAcT and demonstrated their utility in preparative synthesis of various galactosides. Blixt, O.; Brown, J.; Schur, M.; Wakarchuk, W. and Paulson, J. C., J. Org. Chem. 2001, 66, 2442-2448; Blixt, O.; van Die, I.; Norberg, T. and van den Eijnden, D. H., Glycobiol 1999, 9, 1061-1071. β4GalT-GalE is a fusion protein constructed from β4GalT and the uridine-5′-diphospho-galactose-4′-epimerase (GalE) for in situ conversion of inexpensive UDP-glucose to UDP-galactose providing a cost efficient strategy. Further examples of procedures used to generate the glycans, libraries and arrays of the invention are provided in the Examples.

In most cases, the structures of the glycans used in the compositions, libraries and arrays of the invention are described herein. However, in some cases a source of the glycan, rather than the precise structure of the glycan is given. Hence, a glycan from any available natural source can be used in the arrays and libraries of the invention. For example, known glycoproteins are a useful source of glycans. The glycans from such glycoproteins can be isolated using available procedures or, for example, procedures provided herein. Such glycan preparations can then be linked to the present spacers and used in the compositions, libraries and arrays of the invention.

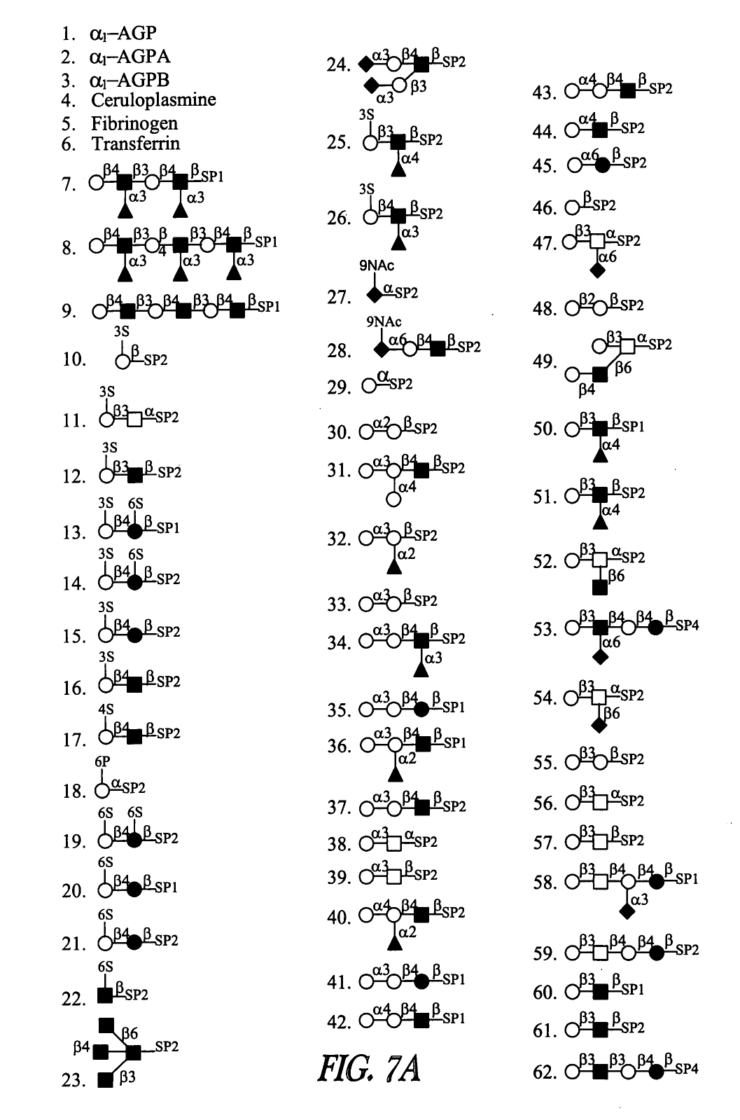

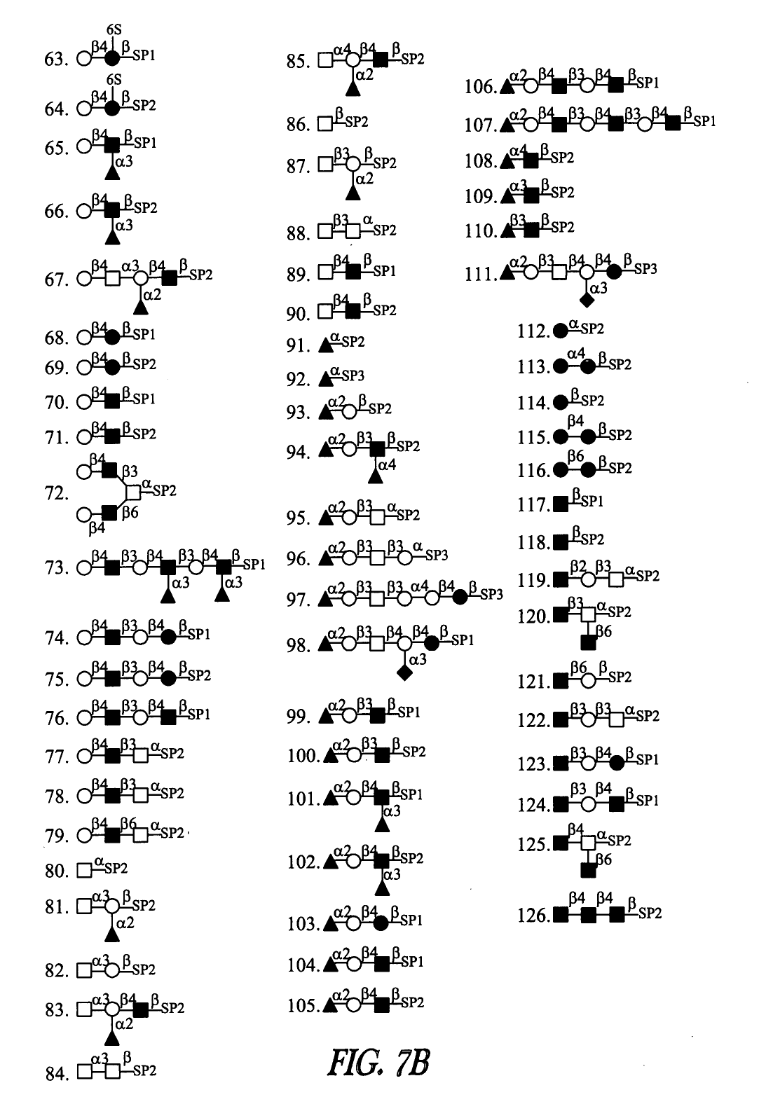

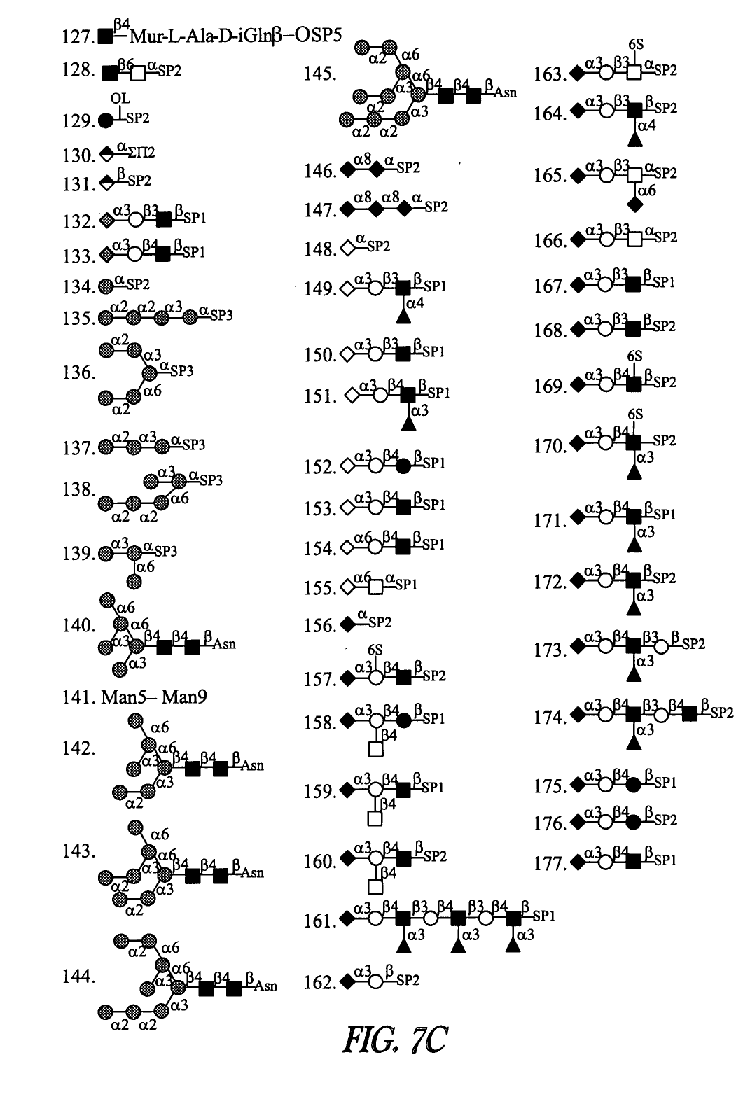

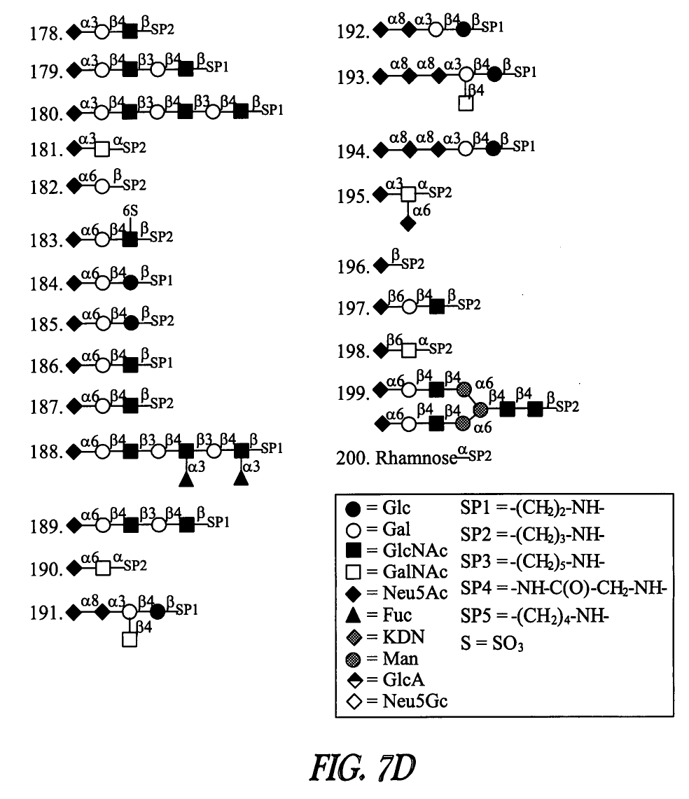

Examples of glycans provided in the libraries and on the arrays of the invention are provided in Table 3. Glycans 1-200 in Table 3 correspond to glycans 1-200 shown in FIG. 7.

TABLE 3

| | |
|---|---|
| 1 | AGP (acid glycoprotein) mixture of bi and tri- and tetra-antenary N-glyclans |
| 2 | AGP-A (acid glycoprotein A) mixture of bi and tri-antenary N-glycans |
| 3 | AGP-B (acid glycoprotein B) mixture of bi and tri-antenary N-glycans |
| 4 | Ceruloplasmine mixture of bi and tri- and tetra-antenary N-glycans |
| 5 | Fibrinogen mixture of biantenary-N-glycans |
| 6 | Transferrin mixture of bi and tri- and tetra-antenary N-glycans |
| 7 | Galβ1-4(Fuc1-3)GlcNAcβ1-4Galβ1-4(Fuc1-3)GlcNAcβSp |
| 8 | Galβ1-4(Fucα1-3)GlcNAcβ1-4Galβ1-4(Fucα1-3)GlcNAcβ1-4Galβ1- |
| | 4(Fucα1-3)GlcNAcβSp |
| 9 | Galβ1-4GlcNAcβ1-4Galβ1-4GlcNAcβ1-4Galβ1-4GlcNAcβSp |
| 10 | Gal[3S]βSp |
| 11 | Gal[3S]β1-3GalNAcαSp |
| 12 | Gal[3S]β1-3GlcNAcβSp |
| 13 | Gal[3S]β1-4Glc[6S]βSp |
| 14 | Gal[3S]β1-4Glc[6S]βSp |
| 15 | Gal[3S]β1-4GlcβSp |
| 16 | Gal[3S]β1-4GlcNAcβSp |
| 17 | Gal[4S]β1-4GlcNAcβSp |
| 18 | Man[6P]αSp |
| 19 | Gal[6S]β1-4Glc[6S]βSp |
| 20 | Gal[6S]β1-4GlcβSp |
| 21 | Gal[6S]β1-4GlcβSp |
| 22 | GlcNAc[6S]βSp |
| 23 | (GlcNAcβ1-3(GlcNAcβ1-6)GlcNAcβ1-4)GalNAcaSp |
| 24 | NeuAcα2-3Galβ1-3(NeuAcα2-3Galβ1-4)GlcNAcβSp |
| 25 | Gal[3S]β1-3(Fucα1-4)GlcNAcβSp |
| 26 | Gal[3S]β1-4(Fucα1-3)GlcNAcβSp |
| 27 | 9[NAc]NeuAcαSp |
| 28 | 9[NAc]NeuAcα2-6Galβ1-4GlcNAcβSp |
| 29 | GalαSp |
| 30 | Galα1-2Galβ-Sp |
| 31 | Galα1-3(Galα1-4)Galβ1-4GlcNAcβSp |
| 32 | Galα1-3(Fucα1-2)Galβ-Sp |
| 33 | Galα1-3GalβSp |
| 34 | Galα1-3Galβ1-4(Fucα1-3)GlcNAcβSp |
| 35 | Galα1-3Galβ1-4GlcβSp |
| 36 | Galα1-3(Fucα1-2)Galβ1-4GlcNAcβSp |
| 37 | Galα1-3Galβ1-4GlcNAcβSp |
| 38 | Galα1-3GalNAcαSp |
| 39 | Galα1-3GalNAcβSp |
| 40 | Galα1-4(Fucα1-2)Galβ1-4GlcNAcβSp |
| 41 | Galα1-4Galβ1-4GlcβSp |
| 42 | Galα1-4Galβ1-4GlcNAcβSp |
| 43 | Galα1-4Galβ1-4GlcNAcβSp |
| 44 | Galβ1-4GlcNAcβSp |
| 45 | Galα1-6GlcβSp |
| 46 | GalβSp |
| 47 | Galβ1-3(NeuAcα2-6)GalNAcαSp |
| 48 | Galβ1-2GalβSp |
| 49 | Galβ1-3(Galβ1-4GlcNAcβ1-6)GalNAcαSp |
| 50 | Galβ1-3(Fucα1-4)GlcNAcβSp |
| 51 | Galβ1-3(Fucα1-4)GlcNAcβSp |
| 52 | Galβ1-3(GlcNAcβ1-6)GalNAcαSp |
| 53 | Galβ1-3(NeuAcα2-6)GlcNAcβ1-4Galβ1-4GlcβSp |
| 54 | Galβ1-3(NeuAcβ2-6)GalNAcαSp |
| 55 | Galβ1-3GalβSp |
| 56 | Galβ1-3GalNAcαSp |
| 57 | Galβ1-3GlcNAcβSp |
| 58 | Galβ1-3GalNAcβ1-4(NeuAcα2-3)Galβ1-4GlcβSp |
| 59 | Galβ1-3GalNAcβ1-4Galβ1-4GlcβSp |
| 60 | Galβ1-3GlcNAcαSp |
| 61 | Galβ1-3GlcNAcβSp |
| 62 | Galβ1-3GlcNAcβ1-3Galβ1-4GlcβSp |
| 63 | Galβ1-4Glc[6S]βSp |
| 64 | Galβ1-4Glc[6S]βSp |
| 65 | Galβ1-4(Fucα1-3)GlcNAcβSp |
| 66 | Galβ1-4(Fucα1-3)GlcNAcβSp |
| 67 | Galβ1-4GalNAcα1-3(Fucα1-2)Galβ1-4GlcNAcβSp |
| 68 | Galβ1-4GlcβSp |
| 69 | Galβ1-4GlcβSp |
| 70 | Galβ1-4GlcNAcβSp |
| 71 | Galβ1-4GlcNAcβSp |
| 72 | Galβ1-4GlcNAcβ1-3(Galβ1-4GlcNAcβ1-6)GalNAcαSp |
| 73 | Galβ1-4GlcNAcβ1-3Galβ1-4(Fucα1-3)GlcNAcβ1-3Galβ1-4(Fucα1-3)GlcNAcβSp |
| 74 | Galβ1-4GlcNAcβ1-3Galβ1-4GlcβSp |
| 75 | Galβ1-4GlcNAcβ1-3Galβ1-4GlcβSp |
| 76 | Galβ1-4GlcNAcβ1-3Galβ1-4GlcNAcβSp |
| 77 | Galβ1-4GlcNAcβ1-3GalNAcαSp |
| 78 | Galβ1-4GlcNAcβ1-3GalNAcαSp |
| 79 | Galβ1-4GlcNAcβ1-6GalNAcαSp |
| 80 | GalNAcαSp |
| 81 | GalNAcα1-3(Fucα1-2)GalβSp |
| 82 | GalNAcα1-3GalββSp |
| 83 | GalNAcα1-3(Fuca1-2)Galβ1-4GlcNAcβSp |
| 84 | GalNAcα1-3GalNAcβSp |
| 85 | GalNAcα1-4(Fucα1-2)Galβ1-4GlcNAcβSp |
| 86 | GalNAcβSp |
| 87 | GalNAcβ1-3(Fucα1-2)GalβSp |
| 88 | GalNAcβ1-3GalNAcαSp |
| 89 | GalNAcβ1-4GlcNAcβSp |
| 90 | GalNAcβ1-4GlcNAcβSp |
| 91 | FucαSp |
| 92 | FucαSp |
| 93 | Fucα1-2GalβSp |
| 94 | Fucα1-2Galβ1-3(Fucα1-4)GlcNAcβ-Sp |
| 95 | Fucα1-2Galβ1-3GalNAcβ-Sp |
| 96 | Fucα1-2Galβ1-3GalNAcβ1-3GalαSp |
| 97 | Fucα1-2Galβ1-3GalNAcβ1-3Galβ1-4Galβ1-4GlcβSp |
| 98 | Fucα1-2Galβ1-3GalNAcβ1-4(NeuAcα2-3)Galβ1-4GlcβSp |
| 99 | Fucα1-2Galβ1-3GlcNAcβSp |
| 100 | Fucα1-2Galβ1-3GlcNAcβSp |
| 101 | Fucα1-2Galβ1-4(Fucα1-3)GlcNAcβSp |
| 102 | Fucα1-2Galβ1-4(Fucα1-3)GlcNAcβSp |
| 103 | Fucα1-2Galβ1-4GlcβSp |
| 104 | Fucα1-2Galβ1-4GlcNAcβSp |
| 105 | Fucα1-2Galβ1-4GlcNAcβSp |
| 106 | Fucα1-2Galβ1-4GlcNAcβ1-3Galβ1-4GlcNAcβSp |
| 107 | Fucα1-2Galβ1-4GlcNAcβ1-3Galβ1-4GlcNAcβ1-3Galβ1-4GlcNAcβSp |
| 108 | Fucα1-2GlcNAcβSp |
| 109 | Fucα1-3GlcNAcβSp |
| 110 | Fucβ1-3GlcNAcβSp |
| 111 | Fucα1-2Galβ1-3GalNAcβ1-4(NeuAcα1-3)Galβ1-4GlcβSp |
| 112 | GlcαSp |
| 113 | Glcβ1-4GlcβSp |
| 114 | GlcβSp |
| 115 | Glcβ1-4GlcβSp |
| 116 | Glcβ1-6GlcβSp |
| 117 | GlcNAcβSp |
| 118 | GlcNAcβSp |
| 119 | GlcNAcβ1-2Galβ1-3GalNAcαSp |
| 120 | GlcNAcβ1-3(GlcNAcβ1-6)GalNAcαSp |
| 121 | GlcNAcβ1-3GalβSp |
| 122 | GlcNAcβ1-3Galβ1-3GalNAcαSp |
| 123 | GlcNAcβ1-3Galβ1-4GlcβSp |
| 124 | GlcNAcβ1-3Galβ1-4GlcNAcβSp |
| 125 | GlcNAcβ1-4(GlcNAcβ1-6)GalNAcαSp |
| 126 | GlcNAcβ1-4GlcNAcβ1-4GlcNAcβSp |
| 127 | GlcNAcβ1-4Mur-L-Ala-D-GlnβSp |
| 128 | GlcNAcβ1-6GalNAcαSp |
| 129 | Glc-ol-amine |
| 130 | GlcAαSp |
| 131 | GlcAβSp |
| 132 | KDNα2-3Galβ1-3GlcNAcβSp |
| 133 | KDNα2-3Galβ1-4GlcNAcβSp |
| 134 | ManαSp |
| 135 | Manα1-2Manα1-2Manα1-3ManαSp |
| 136 | Manα1-2Manα1-3(Manα1-2Manα1-6)ManαSp |
| 137 | Manα1-2Manα1-3ManαSp |
| 138 | Manα1-3(Manα1-2Manα1-2Manα1-6)ManαSp |
| 139 | Manα1-3(Manα1-6)ManαSp |
| 140 | Manα1-3Manα1-6(Manα1-2Manα1-3)Manβ1-4GlcNAcβ1-4GlcNAcβSp |
| 141 | Man5-Man9βSp-mixture (mixture is of glycans 140, 142-145) |
| 142 | Manα1-6(Manα1-3)Manα1-6(Manα1-2Manα1-3)Manβ1-4GlcNAcβ1- |
| | 4GlcNAcβSp |
| 143 | Manα1-6(Manα1-2Manα1-3)Manα1-6(Manα1-2Manα1-3)Manβ1- |
| | 4GlcNAcβ1-4GlcNAcβSp |
| 144 | Manα1-2Manα1-6(Manα1-3)Manα1-6(Manα1-2Manα1-3)Manβ1- |
| | 4GlcNAcβ1-4GlcNAcβSp |
| 145 | Manα1-2Manα1-2Manα1-3(Manα1-2Manα1-3(Manα1-2Manα1- |
| | 6)Manα1-6)Manβ1-4GlcNAcβ1-4GlcNAcβSp |
| 146 | NeuAcα2-8NeuAcαSp |
| 147 | NeuAcα2-8NeuAcα2-8NeuAcαSp |
| 148 | NeuGcαSp |
| 149 | NeuGcα2-3Galβ1-3(Fucα1-4)GlcNAcβSp |
| 150 | NeuGcα2-3Galβ1-3GlcNAcβSp |
| 151 | NeuGcα2-3Galβ1-4(Fucα1-3)GlcNAcβSp |
| 152 | NeuGcα2-3Galβ1-4GlcβSp |
| 153 | NeuGcα2-3Galβ1-4GlcNAcβSp |
| 154 | NeuGcα2-6Galβ1-4GlcNAcαSp |
| 155 | NeuGcα2-6GalNAcαSp |
| 156 | NeuAcαSp |
| 157 | NeuAcα2-3(6S)Galβ1-4GlcNAcβSp |
| 158 | NeuAcα2-3(GalNAcβ1-4)Galβ1-4GlcβSp |
| 159 | NeuAcα2-3(Galβ1-3GalNAcβ1-4)Galβ1-4GlcNAcβSp |
| 160 | NeuAcα2-3(GalNAcβ1-4)Galβ1-4GlcNAcβSp |
| 161 | NeuAcα2-3Galβ1-4(Fucα1-3)GlcNAcβ1-4Galβ1-4(Fucα1-3)GlcNAcβ1- |
| | 4Galβ1-4(Fucα1-3)GlcNAcβSp |
| 162 | NeuAcα2-3GalβSp |
| 163 | NeuAcα2-3Galβ1-3GalNAc[6S]αSp |
| 164 | NeuAcα2-3(GalNAcβ1-4)Galβ1-4GlcβSp |
| 165 | NeuAcα2-3Galβ1-3(NeuAcα2-6)GalNAcαSp |
| 166 | NeuAcα2-3Galβ1-3GalNAcαSp |
| 167 | NeuAcα2-3Galβ1-4GlcNAc[6S]βSp |
| 168 | NeuAcα2-3Galβ1-4(Fucα1-3) GlcNAc[6S]βSp |
| 169 | NeuAcα2-3Galβ1-4GlcNAc[6S]βSp |
| 170 | NeuAcα2-3Galβ1-4(Fucα1-3)GlcNAc[6S]βSp |
| 171 | NeuAcα2-3Galβ1-4(Fucα1-3)GlcNAcβSp |
| 172 | NeuAcα2-3Galβ1-4(Fucα1-3)GlcNAcβSp |
| 173 | NeuAcα2-3Galβ1-4(Fucα1-3)GlcNAcβ1-3GalβSp |
| 174 | NeuAcα2-3Galβ1-4(Fucα1-3)GlcNAcβ1-3Galβ1-4GlcNAcβSp |
| 175 | NeuAcα2-3Galβ1-4GlcβSp |
| 176 | NeuAcα2-3Galβ1-4GlcβSp |
| 177 | NeuAcα2-3Galβ1-4GlcNAcβSp |
| 178 | NeuAcα2-3Galβ1-4GlcNAcβSp |
| 179 | NeuAcα2-3Galβ1-4GlcNAcβ1-3Galβ1-4GlcNAcβSp |
| 180 | NeuAcα2-3Galβ1-4GlcNAcβ1-3Galβ1-4GlcNAcβ1-3Galβ1- |
| | 4GlcNAcβSp |
| 181 | NeuAcα2-6GalNAcαSp |
| 182 | NeuAcα2-6GalβSp |
| 183 | NeuAcα2-6Galβ1-4GlcNAc[6S]βSp |
| 184 | NeuAcα2-6Galβ1-4GlcβSp |
| 185 | NeuAcα2-6Galβ1-4GlcβSp |
| 186 | NeuGcα2-6Galβ1-4GlcNAcαSp |
| 187 | NeuGcα2-6Galβ1-4GlcNAcαSp |
| 188 | NeuAcα2-6Galβ1-4GlcNAcβ1-3Galβ1-4(Fucα1-3)GlcNAcβ1-3Galβ1- |
| | 4(Fucα1-3)GlcNAcβSp |
| 189 | NeuAcα2-6Galβ1-4GlcNAcβ1-3Galβ1-4GlcNAcβSp |
| 190 | NeuAcβ2-6GalNAcαSp |
| 191 | NeuAcα2-8NeuAcα2-3(GalNAcβ1-4)Galβ1-4GlcβSp |
| 192 | NeuAcα2-8NeuAcα2-3Galβ1-4GlcβSp |
| 193 | NeuAcα2-8NeuAcα2-8NeuAcα2-3(GalNAcβ1-4)Galβ1-4GlcβSp |
| 194 | NeuAcα2-8NeuAcα8NeuAcα2-3Galβ1-4GlcβSp |
| 195 | NeuAcα2-3(NeuAcα2-6)GalNAcαSp |
| 196 | NeuAcβSp |
| 197 | NeuAcβ2-6Galβ1-4GlcNAcβSp |
| 198 | NeuAcβ2-6GalNAcαSp |
| 199 | NeuAcα2-6Galβ1-4GlcNAcβ1-2Manα1-3(NeuAcα2-6Galβ1- |
| | 4GlcNAcβ1-2Manα1-6)Manβ1-4GlcNAcβ1-4GlcNAcβSp |
| 200 | RhaαSp |
| 201 | ManβSp |
| 202 | ±(NeuAcα2-6)Galβ1-4GlcNAcα1-2Manα1-6(±(NeuAcα2-6)Galβ1- |
| | 4GlcNAcα1-2Manα1-3)Manβ1-4GlcNAcβ1-4GlcNAcβSp |
| 203 | GalNAc[3S]βSp |
| 204 | GalNAc[6S]βSp |
| 205 | Galβ1-4GlcNAcβ1-2Manα1-3(Galβ1-4GlcNAcβ1-2Manα1-6)Manβ1- |
| | 4GlcNAcβ1-4GlcNAcβSp |
| 206 | Fucα1-2Galβ1-3GlcNAcβ1-3Galβ1-4GlcβSp |
| 207 | Fucα1-2Galβ1-4(Fucα1-3)GlcNAcβ1-4Galβ1-4(Fucα1-3)GlcNAcβSp |
| 208 | Fucα1-4GlcNAcβSp |
| 209 | Galα1-3(Fucα1-2)Galβ1-4GlcβSp |
| 210 | GalNAcα1-3(Fucα1-2)Galβ1-4GlcβSp |
| 211 | GalNAcβ1-4(Fucα1-2)GlcNAcβ1-4Manα1-3(GalNAcβ1-4(Fucα1- |
| | 2)GlcNAcβ1-4Manα1-6)Manβ1-4GlcNAcα1-4(Fucα1-2)GlcNAcβSp |
| 212 | GalNAcβ1-4(Fucα1-3)GlcNAcβSp |
| 213 | GalNAcβ1-4GlcNAcβ1-4Manα1-6(GalNAcβ1-4GlcNAcβ1-4Manα1- |
| | 3)Manβ1-4GlcNAcβ1-4GlcNAcβSp |
| 214 | Galα1-4(Fucα1-2)Galβ1-4GlcNAcβSp |
| 215 | Galβ1-3(Galβ1-3Galβ1-4GlcNAcβ1-6)GalNAcαSp |
| 216 | Galβ1-3(Galβ1-4(Fucα1-3)GlcNAcβ1-6)GalNAcαSp |
| 217 | Galβ1-3(NeuAcα2-3Galβ1-4(Fucα1-3)GlcNAcβ1-6)GalNAcαSp |
| 218 | Galβ1-3(NeuAcα2-3Galβ1-4GlcNAcβ1-6)GalNAcαSp |
| 219 | Galβ1-4GlcNAc[6S]βSp |
| 220 | Galβ1-4(Fucα1-3)GlcNAcβ1-4Manα1-6(Galβ1-4(Fucα1-3)GlcNAcβ1- |
| | 4Manα1-6)Manβ1-4GlcNAcβ1-4GlcNAcβSp |
| 221 | Galβ1-4GlcNAcβ1-3Galβ1-4GlcNAcβ1-3Galβ1-4GlcNAcβSp |
| 222 | Galβ1-4GlcNAcβ1-4Manα1-3(Galβ1-4GlcNAcβ1-4Manα1-6)Manβ1- |
| | 4GlcNAcβ1-4GlcNAcβSp |
| 223 | Galβ1-4GlcNAcβ1-6(Galβ1-3)GalNAcαSp |
| 224 | GlcNAcβ1-2Manα1-3(GlcNAcβ1-2Manα1-6)Manβ1-4GlcNAcβ1- |
| | 4(Fucα1-6)GlcNAcβSp |
| 225 | GlcNAcβ1-3GalNAcαSp |
| 226 | GlcNAcβ1-4GlcNAcβ1-4GlcNAcβ1-4GlcNAcβSp |
| 227 | GlcNAcβ1-4GlcNAcβSp |
| 228 | GlcNAcβ1-4GlcNAcβSp |
| 229 | GlcNAcβ1-6(Galβ1-3)GalNAcαSp |
| 230 | Manα1-2Manα1-3(Manα1-6)Manβ1-4GlcNAcβ1-4(Fucα1- |
| | 3)GlcNAβSp |
| 231 | Manα1-3(Xylβ1-2)(Manα1-6)Manβ1-4GlcNAcβ1-4GlcNAcβSp |
| 232 | Manα1-2Manα1-6(Manα1-3)Manα1-6(Manα2Manα2Manα1-3)Manβ1- |
| | 4GlcNAcβ1-4GlcNAcβSp |
| 233 | Manα1-3(Manα1-6)Manβ1-4GlcNAcβ1-4GlcNAcβSp |
| 234 | Manα1-6(Manα1-3)Manα1-6(GlcNAcβ1-4)(GlcNAcβ1-2Manα1- |
| | 3)Manβ1-4GlcNAcβ1-4GlcNAcβSp |
| 235 | Manα1-6(Manα1-3)Manβ1-4GlcNAcβ1-4(Fucα1-2)GlcNAcβSp |
| 236 | Manα1-6(Manα1-3)Manα1-6(Manα1-3)Manβ1-4GlcNAcβ1-4GlcNAcβSp |
| 237 | Manα1-6Manα1-3(Manα1-6Manα1-3)Manβ1-4GlcNAcβ1-4GlcNAcβSp |
| 238 | mixed biantennary glycansβSp |
| 239 | mixed N-glycansβSp |
| 240 | NeuAcα2-3(Galβ1-3GlcNAcβ1-4)Galβ1-4GlcβSp |
| 241 | NeuAcα2-3Galβ1-3(Galβ1-3Galβ1-4GlcNAcβ1-6)GalNAcαSp |
| 242 | NeuAcα2-3Galβ1-3(Galβ1-4GlcNAcβ1-6)GalNAcαSp |
| 243 | NeuAcα2-3Galβ1-3(GlcNAcβ1-6)GalNAcαSp |
| 244 | NeuAcα2-3Gal[6S]β1-4(Fucα1-3)GlcNAcβSp |
| 245 | NeuAcα2-3(GalNAcβ1-4)Galβ1-4GlcβSp |
| 246 | NeuAcα2-3GalNAcαSp |
| 247 | NeuAcα2-3Galβ1-3(Galβ1-4(Fucα1-3)GlcNAcβ1-6)GalNAcαSp |
| 248 | NeuAcα2-3Galβ1-3(NeuAcα2-3Galβ1-4)GlcNAcβSp |
| 249 | NeuAcα2-3Galβ1-3(NeuAcα2-3Galβ1-4(Fucα1-3)GlcNAcβ1- |
| | 6)GalNAcαSp |
| 250 | NeuAcα2-3Galβ1-3(NeuAcα2-3Galβ1-4GlcNAcβ1-6)GalNAcαSp |
| 251 | NeuAcα2-3Galβ1-4(Fucα1-3)GlcNAcβ1-3Galβ1-4(Fucα1-3)GlcNAcβ1- |
| | 3Galβ1-4(Fucα1-3)GlcNAcβSp |
| 252 | NeuAcα2-3Galβ1-4GlcNAcβ1-3Galβ1-4GlcNAcβSp |
| 253 | NeuAcα2-3Galβ1-4GlcNAcβSp |
| 254 | NeuAcα2-6(Galβ1-3)GalNAcαSp |
| 255 | NeuAcα2-6Galβ1-4GlcNAcβ1-2Manα1-6((NeuAcα2-6Galβ1- |
| | 4GlcNAcβ1-2Manα1-6)Manβ1-4GlcNAcβ1-4GlcNAcβSp |
| 256 | NeuAcα2-6Galβ1-4GlcNAcβ1-4Galβ1-4GlcNAcβSp |
| 257 | NeuAcα2-8NeuAcα2-3Galβ1-4GlcβSp |
| 258 | NeuAcα2-8NeuAcα2-8NeuAcαSp |
| 259 | NeuAcβ2-6(Galβ1-3)GalNAcβSp |
| 260 | NeuGcα2-3Galβ1-3(Fucα1-4)GlcNAcβSp |
| 261 | NeuGcα2-3Galβ1-3GlcNAcβSp |
| 262 | NeuGcα2-3Galβ1-4(Fucα1-3)GlcNAcβSp |
| 263 | NeuGcβSp |
| 264 | NeuAcα2-6Galβ1-4GlcNAcβ1-2Manα1-3(Galβ1-4GlcNAcβ1-2Manα1- |
| | 6)Manβ1-4GlcNAcβ1-4(Fucα1-6)GlcNAcβSp |
| 265 | NeuAcα2-6Galβ1-4GlcNAcβ1-2Manα1-3(NeuAcα2-6Galβ1- |
| | 4GlcNAcβ1-2Manα1-6)Manβ1-4GlcNAcβ1-4(Fuc1α1-6)GlcNAcβSp |
| 266 | NeuAcα2-8NeuAcα2-(3-6)Galβ1-4GlcNAcβ1-2Manα1-3(NeuAcα2- |
| | 6Galβ1-4GlcNAcβ1-2Manα1-6)Manβ1-4GlcNAcβ1-4(Fucα1-6)GlcNAcβSp |
| 267 | NeuAcα2-8NeuAcα2-8NeuAcα2-(3-6)Galβ1-4GlcNAcβ1-2Manα1- |
| | 3(NeuAcα2-6Galβ1-4GlcNAcβ1-2Manα1-6)Manβ1-4GlcNAcβ1- |
| | 4(Fucα1-6)GlcNAcβSp |
| 269 | GlcNAcβ1-3(GlcNAcβ1-4)Galβ1-4GlcNAcβSp |
| 270 | GlcNAcβ1-3Galβ1-4GlcNAcβSp |
| 271 | GlcAβ1-3GalβSp |
| 272 | GlcNAcβ1-4GlcNAcβ1-4GlcNAcβ1-4GlcANAcβ1-4GlcNAcβSp |
| 273 | GlcNAcβ1-6Galβ1-4GlcNAcβSp |
| 274 | Glcα1-4Glc1-4αSp |
| 275 | Glcα1-6Glc,6αGlcαSp |
| 276 | GlcNAcβ1-4Galβ1-4GlcNAcβSp |
| 277 | Galβ1-4GlcNAc[6S]βSp |
| 278 | GlcNAcβ1-4GlcNAcβ1-4GlcNAcβ1-4GlcNAcβ1-4GlcANAcβ1- |
| | 4GlcNAcβSp |
| 279 | GlcNGcβSp |
| 280 | Manβ1-4GlcNAcβSp |
| 281 | Gal[6S]β1-4GlcNAcβSp |
| 282 | Galβ1-4GlcNAcβ1-2Manα1-3(Galβ1-4GlcNAcβ1-2Manα1-6)Manβ1- |
| | 4GlcNAcβ1-4GlcNAcβSp |
| 283 | GlcNAcβ1-2Manα1-3(GlcNAcβ1-2Manα1-6)Manβ1-4GlcNAcβ1- |
| | 4GlcNAcβSp |
| 284 | Manα1,3(Manα1-6)Manβ1-4GlcNAcβ1-4GlcNAcβSp |
| 285 | Galα1-3(Fucα1-2)Galβ1-3GlcNAcβSp |
| 286 | GalNAcα1-3(Fucα1-2)Galβ1-3GlcNAcβSp |
| 287 | GalNAcα1-3(Fucα1-2)Galβ1-4(Fucα1-3)GlcNAcβSp |
| 288 | Galα1-3(Fucα1-2)Galβ1-4(Fucα1-3)GlcNAcβSp |
| 289 | Fucα1-2Galβ1-4(Fucα1-3)GlcNAcβ1-3Galβ1-4(Fucα1-3)GlcNAcβ1- |
| | 3Galβ1-4(Fucα1-3)GlcNAcβSp |
| 290 | GalNAcα1-3(Fucα1-2)Galβ1-4GlcβSp |
| 291 | Galα1-3(Fucα1-2)Galβ1-4GlcβSp |
| 292 | NeuAcα2-3Galβ1-3GlcNAcβ1-3Galβ1-4GlcNAcβSp |
| 293 | NeuAcα2-6Galβ1-3GlcNAcβ1-3Galβ1-4GlcNAcβSp |
| 294 | GalNAcβ1-4(Fucα1-3)GlcNAcβSp |
| 295 | Galβ1-3GlcNAcβ1-3Galβ1-4GlcβSp |
| 296 | GalNAcβ1-3Galα1-4Galβ1-4GlcβSp |
| 297 | Galβ1-3GalNAcβ1-3Galα1-4Galβ1-4GlcβSp |
| 298 | NeuAcα2-3Galβ1-3GalNAcβ1-3Galα1-4Galβ1-4GlcβSp |
| 299 | Fucα1-2Galβ1-3GalNAcβ1-3Galα1-4Galβ1-4GlcβSp |
| 300 | Fucα1-2Galβ1-3(Fucα1-4)GlcNAcβ1-3Galβ1-4(Fucα1-3)GlcNAcβSp |
| 301 | NeuAcα2-3Galβ1-3(Fucα1-4)GlcNAcβ1-3Galβ1-4GlcNAcβSp |
| 302 | NeuAcα2-3Galβ1-3(Fucα1-4)GlcNAcβ1-3Galβ1-4(Fucα1- |
| | 3)GlcNAcβSp |
| 203 | NeuAcα2-8NeuAcα2-3(Galβ1-3GalNAcβ1-4)Galβ1-4GlcβSp |
| 304 | NeuAcα2-8NeuAcα2-3(NeuAcα2-3Galβ1-3GalNAcβ1-4)Galβ1- |
| | 4GlcβSp |
| 305 | NeuAcα2-3(Galβ1-3GalNAcβ1-4)Galβ1-4GlcβSp |
| 306 | NeuAcα2-3(NeuAcα2-3Galβ1-3GalNAcβ1-4)Galβ1-4GlcβSp |
| 307 | NeuAcα2-8NeuAcα2-8-NeuAcα2-3(Galβ1-3GalNAcβ1-4)Galβ1- |
| | 4GlcβSp |
| 308 | NeuAcα2-8NeuAcα2-8-NeuAcα2-3(NeuAcα2-3Galβ1-3GalNAcβ1- |
| | 4)Galβ1-4GlcβSp |
| 309 | NeuAcα2-8NeuAcα2-8NeuAcα2-8-NeuAcα2-3(Galβ1-3GalNAcβ1- |
| | 4)Galβ1-4GlcβSp |
| 310 | NeuAcα2-8NeuAcα2-8NeuAcα2-8NeuAcα1-3(NeuAcα2-3Galβ1- |
| | 3GalNAcβ1-4)Galβ1-4GlcβSp |
| 311 | NeuAcα2-8NeuAcα2-8NeuAcα2-8-NeuAcα2-3(GalNAcβ1-4)Galβ1- |
| | 4GlcβSp |
| 312 | Galβ1-4GlcNAcβ1-2(Galβ1-4GlcNAcβ1-4)Manα1-3[Galβ1-4GlcNAcβ1-3(Galβ1- |
| | 4GlcNAcβ1-6)Manα1-6]Manβ1-4GlcNAcβ1-4GlcNAcβSp |

Many of the abbreviations employed in the table are defined herein or at the website functionalglycomics.org. In particular, the following abbreviations were used: Sp means “spacer.”

The glycans listed in Table 3 sometimes have alkylamine moieties such as —OCH₂CH₂NH₂ (called Sp1), or —OCH₂CH₂CH₂NH₂ (called Sp2 or Sp3), or NH—(CO)(CH₂)₂—NH— (called Sp4), or CH₂)₄—NH (called Sp5) that have been used as linking moieties and/or linkers in some experiments.

Glycan Arrays

The arrays of the invention employ a library of characterized and/or defined glycan structures attached to the surface of the array by a spacer molecule of the invention. Use of the glycans in an array has been validated with a diverse set of carbohydrate binding proteins such as plant lectins and C-type lectins, Siglecs, Galectins, Influenza Hemagglutinins and anti-carbohydrate antibodies (from crude sera, purified serum fractions and purified monoclonal antibody preparations).

The inventive libraries, arrays and methods have several advantages. One particular advantage of the invention is that the arrays and methods of the invention provide highly reproducible results.

Another advantage is that the libraries and arrays of the invention permit screening of multiple glycans in one reaction. Thus, the libraries and arrays of the invention provide large numbers and varieties of glycans. For example, the libraries and arrays of the invention have at least two glycans, at least three glycans, at least ten glycans, at least 30 glycans, at least 40 glycans, at least 50 glycans, at least 100 glycans, at least 150 glycans, at least 175 glycans, at least 200 glycans, at least 250 glycans or at least 500 glycans. In some embodiments, the libraries and arrays of the invention have more than two glycans, more than three glycans, more than ten glycans, more than 40 glycans, more than 50 glycans, more than 100 glycans, more than 150 glycans, more than 175 glycans, more than 200 glycans, more than 250 glycans or more than 500 glycans. In other embodiments, the libraries and arrays of the invention have about 2 to about 100,000, or about 2 to about 10,000, or about 2 to about 7500, or about 2 to about 1,000, or about 2 to about 500, or about 2 to about 200, or about 2 to 100 different glycans per library or array. In other embodiments, the libraries and arrays of the invention have about 50 to about 100,000, or about 50 to about 10,000, or about 50 to about 7500, or about 50 to about 1,000, or about 50 to about 500, or about 50 to about 200 different glycans per library or array. Such large numbers of glycans permit simultaneous assay of a multitude of glycan types.

Moreover, as described herein, the present arrays have been used for successfully screening a variety of glycan binding proteins. The glycan arrays of the invention are reusable after stripping with acidic, basic aqueous or organic washing steps. Experiments demonstrate that little degradation of the glycan occurs and only small amounts of glycan binding proteins are consumed during a screening assay. Hence, the arrays of the invention can be used for more than one assay.

The arrays and methods of the invention provide high signal to noise ratios. The screening methods provided by the invention are fast and easy because they involve only one or a few steps. No surface modifications or blocking procedures are typically required during the assay procedures of the invention.

The composition of glycans on the arrays of the invention can be varied as needed by one of skill in the art. Many different glycans that are linked to a spacer of the invention can be incorporated into the arrays of the invention including, for example, purified glycans, naturally occurring or synthetic glycans, glycoproteins, glycopeptides, glycolipids, bacterial and plant cell wall glycans and the like. Immobilization procedures for attaching different glycans to the arrays of the invention are readily controlled to easily permit array construction.

Unique libraries of different glycans are attached to defined regions on the solid support of the array surface by any available procedure. In general, the arrays are made by obtaining a library of glycan molecules, attaching the present spacer molecules to the glycans in the library, obtaining a solid support that has a surface derivatized to react with the specific R₃ linking moiety of the spacer (e.g. an amine), and attaching the spacer-derivatized glycan molecules to the solid support by forming a covalent linkage between the R₃ linking moieties and the derivatized surface of the solid support.

The derivatization reagent can be attached to the solid substrate via carbon-carbon bonds using, or example, substrates having (poly)trifluorochloroethylene surfaces, or more preferably, by siloxane bonds (using, for example, glass or silicon oxide as the solid substrate). Siloxane bonds with the surface of the substrate are formed in one embodiment via reactions of derivatization reagents bearing trichlorosilyl or trialkoxysilyl groups.

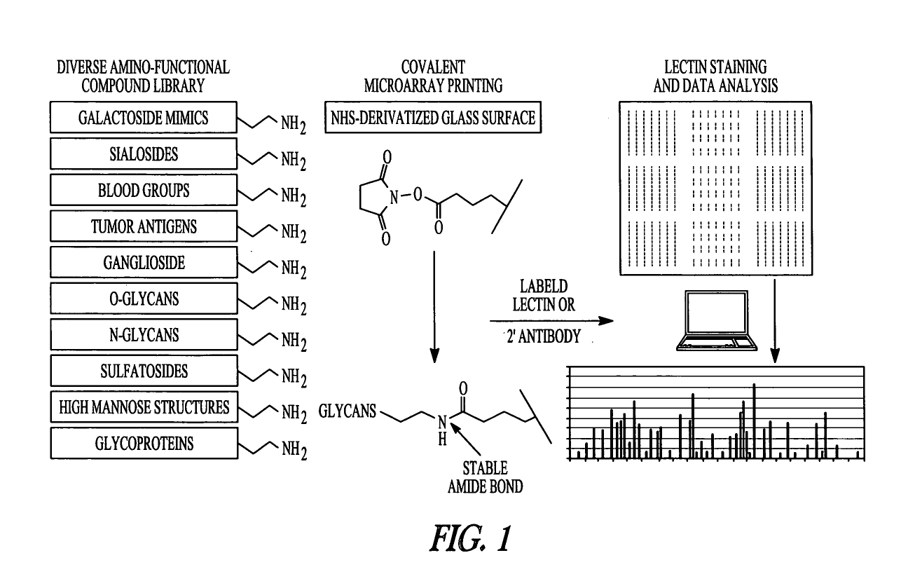

For example, the R₃ linking moiety of the spacer of the invention can react with an N-hydroxy succinimide (NHS)-derivatized surface of the solid support. Such NHS-derivatized solid supports are commercially available. Thus, NHS-activated glass slides are available from Accelr8 Technology Corporation, Denver, Colo. (now Schott Nexterion, Germany). After attachment of all the desired glycans, slides can further be incubated with ethanolamine buffer to deactivate remaining NHS functional groups on the solid support. The array can be used without any further modification of the surface. No blocking procedures to prevent unspecific binding are typically needed. FIG. 1 provides a schematic diagram of such a method for making arrays of glycan molecules.

Each type of glycan is contacted or printed onto to the solid support at a defined glycan probe location. Suitable printing methods include piezo or pin printing techniques. A microarray gene printer can be used for applying the various glycans to defined glycan probe locations. The printing process is shown diagrammatically in FIG. 1. Printing in the X direction gives rise “columns” of glycans and printing in the direction orthogonal to the X direction gives rise to “rows.” During printing, the inkjet is generally stationary, and a stepping stage moves the glass slide or other solid surface over the head in the X direction. As the wafer passes over the head, it prints the appropriate glycan to each glycan probe location. Several nozzles simultaneously dispense a selected amount of glycan solution.

For example, about 0.1 nL to about 10 nL, or about 0.5 nL of spacer-derivatized glycan solution can be applied per defined glycan probe location. Various concentrations of the spacer-derivatized glycan solutions can be contacted or printed onto the solid support. For example, a spacer-derivatized glycan solution of about 0.1 to about 1000 μM glycan or about 1.0 to about 500 μM glycan or about 10 to about 100 μM glycan can be employed. In general, it may be advisable to apply each concentration to a replicate of several (for example, three to six) defined glycan probe locations. Such replicates provide internal controls that confirm whether or not a binding reaction between a glycan and a test molecule is an actual binding interaction.

Methods of Detecting Glycan Binding

It is contemplated that the arrays of this invention will be useful for screening chemical and molecular biological libraries for new therapeutic agents, for identifying ligands for known biological receptors and new receptors for known ligands, for identifying epitopes, characterizing antibodies, genotyping human populations for diagnostic and therapeutic purposes, and many other uses. Any such ligands, receptors, lectins galectins, antibodies, proteins and like can be potential glycan binding entities that can be detected using the arrays and methods provided herein.

The arrays of the invention are intended for use in a molecular recognition-based assay, in which a sample that may contain a glycan binding entity is brought into contact with an array of glycans of known source or structure, that are located at predetermined spatial positions (glycan probe locations) on the support surface of the array. Binding is recognized by detection of a label at a specific glycan probe location on the array, where the label is directly or indirectly associated with a glycan binding entity. Binding of a glycan binding entity is of sufficiently high affinity to permit the entity to be retained by the glycan array during washing and until detection of the associated label has been accomplished.

In using an array of the invention, the identity of a lectin, antibody, protein, molecule, or chemical moiety bound to a glycan at any particular location in the array can be determined by detecting the location of the label associated with the bound entity and linking this with the array's tagged file. The tagged file is a file of information wherein the identity and position of each glycan in the array pertaining to the file is stored. There are various methods of linking this tagged file with the physical array. For example, the tagged file can be physically encoded on the array or its housing by means of a silicon chip, magnetic strip or bar code. Alternatively, the information identifying the array to a particular tagged file might be included on an array or its housing, with the actual file stored in the data analysis device or in a computer in communication with the device. The linking of the tagged file with the physical array would take place at the time of data analysis. Yet another way of doing this would be to store the tagged file in a device such as a disc or card that could be inserted into the data analysis device by the array user at the time the array was used in the assay.

The label can be directly associated with the glycan binding entity, for example, by covalent linkage between the label and a purified glycan binding entity. Alternatively, the label can be indirectly associated with the glycan binding entity. For example, the label can be covalently attached to a secondary antibody that binds to a known glycan binding entity.

The bound label can be observed using any available detection method. For example, an array scanner can be employed to detect fluorescently labeled molecules that are bound to array. In experiments illustrated herein a ScanArray 5000 (GSI Lumonics, Watertown, Mass.) confocal scanner was used. The data from such an array scanner can be analyzed by methods available in the art, for example, by using ImaGene image analysis software (BioDiscovery Inc., El Segundo, Calif.).

Methods of Detecting Disease

According to the invention, antibodies from bodily fluids of patients can be detected using the spacer-derivatized glycan libraries and arrays of the invention. The particular glycan epitopes recognized by those antibodies are indicative of a particular disease type. Healthy persons who do not have the disease in question have much lower levels of such antibodies, or substantially no antibodies that react with those glycans. Antibodies associated with diseases such as cancer, bacterial infection, viral infection, inflammation, transplant rejection, autoimmune diseases and the like can be detected using the glycan arrays of the invention.

For detecting disease, a test sample is obtained from a patient. The patient may or may not have a disease. Thus, the methods of the invention are used to diagnose or detect whether the patient has a disease or has a propensity for developing a disease. Alternatively, the methods of the invention can be used with patients that are known to have an identified disease. In this case, the prognosis of the disease can be monitored.

The test sample obtained from the patient can be any tissue, bodily fluid sample or pathology sample. For example, the test sample can be a blood sample, a serum sample, a plasma sample, a urine sample, a breast milk sample, an ascites fluid sample or a tissue sample. In many embodiments, the sample is a serum sample. The test sample may or may not contain a glycan binding entity—the methods provided herein permit detection of whether such a glycan binding entity is present in the test sample.

In some embodiments, the presence of a particular glycan binding entity is indicative of a particular disease, condition or disease state. Hence, for example, as illustrated herein, detection of increased glycan binding by antibodies in a patient's serum is an indicator that the patient may have disease. Comparison of the levels of glycan binding over time provides an indication of whether the disease is progressing or whether the patient is recovering from the disease or the disease is in remission. Hence, the invention provides methods for detecting disease as well as monitoring the progression of disease in a patient.

A few examples of methods for detecting specific diseases or the potential to develop disease are provided for illustrative purposes.

Breast Cancer: Breast cancer usually begins in the cells lining a breast duct and in the terminal ductal lobular unit, with the first stage thought to be excessive proliferation of individual cell(s) leading to “ductal hyperplasia.” Some of the hyperplastic cells may then become atypical, with a significant risk of the atypical hyperplastic cells becoming neoplastic or cancerous. Initially, the cancerous cells remain in the breast ducts, and the condition is referred to as ductal carcinoma in situ (DCIS). After a time, however, these breast cancer cells are able to invade tissues outside of the ductal environment, presenting the risk of metastases which can be fatal to the patient. Breast cancer proceeds through discrete premalignant and malignant cellular stages: normal ductal epithelium, atypical ductal hyperplasia, ductal carcinoma in situ (DCIS), and finally invasive ductal carcinoma. The first three stages are confined within the ductal system and, therefore, if diagnosed and treated, lead to the greatest probability of cure.

While breast cancer through the DCIS phase is in theory quite treatable, effective treatment requires both early diagnosis and an effective treatment modality. At present, mammography is the state-of-the-art diagnostic tool for detecting breast cancer. Often, however, mammography is only able to detect tumors that have reached a size in the range from 0.1 cm to 1 cm. Such a tumor mass may be reached as long as from 8 to 10 years following initiation of the disease process. Detection of breast cancer at such a late stage is often too late to permit effective treatment.

Thus, in one embodiment, the invention provides fast, reliable and non-invasive methods for detecting and diagnosing breast cancer in a patient. The method involves contacting a test sample from a patient with a library or array of glycans and observing whether antibodies in the test sample bind to selected glycans. The test sample can be any bodily fluid or tissue test sample, however, serum is readily obtained and contains antibodies that can easily be detected using the present methods. Glycans to which antibodies in a serum test sample may bind include ceruloplasmin, Neu5Gc(2-6)GalNAc, GM1, Sulfo-T, Globo-H, and LNT-2. As a control, the pattern of glycans bound by antibodies from breast cancer patients can be compared to the pattern of glycans bound by antibodies in serum samples from healthy, non-cancerous patients.

Viral Detection: As illustrated herein, and as further described in U.S. Provisional Application Ser. No. 60/550,667 (filed Mar. 5, 2004), an anti-HIV neutralizing antibody (2G12) binds preferentially to Man8 glycans. Of all the natural high mannose type structures tested, 2G12 antibodies showed a surprising and unexpectedly strong preference for binding only the Man8 glycan. This glycan has been reported to be present in HIV gp120 to the extent of 20% of the total N-linked glycans (Scanlan et al. (2002) J Virol 76, 7306-7321). In comparison, the Man9 glycan previously studied in the crystallographic work was relatively weakly bound by 2G12, and the Man5, Man6 and Man7 glycans did not support binding at all.

The glycosylation of viral proteins is generally performed by host cell, rather than viral, enzymes. Given that many viral genomes are so mutable, the glycosylation of viral proteins by host enzymes likely gives rise to antigenic epitopes that are more stable than the epitopes generated by translation of easily mutated viral nucleic acids. Hence, virally-associated glycans may form the basis of improved compositions, including vaccines, for inhibiting and treating viral infection.

Also as shown herein, influenza virus hemagglutinin binds to Neu5Acα2-3-linked to galactosides (24, 162-169, 176-180, see FIG. 7), but not to any Neu5Acα2-6- or Neu5Acα2-8-linked sialosides. Intact influenza viruses, such as A/Puerto Rico/8/34 (H1N1), were also strongly bound to the array. The overall affinities are consistent with previous findings and show specificity for both α2-3 and α2-6 sialosides. Rogers, G. N. & Paulson, J. C. (1983) Virol 127, 361-73. Influenza viruses also bound to Neu5Acα2-3- and Neu5Acα2-6-linked to galactosides (24, 151, 157, 161-180, 182-190, 199, see FIG. 7), as well as certain O-linked sialosides.

Hence, the invention provides methods of detecting viral infection, for example, HIV or influenza infection. The method involves contacting a test sample from a patient with a library or array of glycans and observing whether antibodies reactive with the virus, viral antigens or the virus itself are present in the test sample. The presence of such antibodies, viral antigens and viral particles can be detected by detecting their binding to glycans that have been determined to previously bind those antibodies, viral antigens and viral particles. Hence, the glycans to which the antibodies, viral antigens or viruses bind indicate whether an infection is present. Such glycans can be viral-specific glycan epitopes or viral binding sites that are present on host cells. For example, one type of viral-specific glycan epitope is the Man8 glycan(s) to which the anti-HIV 2G12 antibodies bind. Detection of antibodies that bind Man8 glycans is one indicator or HIV infection or of progression towards development of AIDS. One of skill in the art can readily prepare glycan arrays for screening for viral infection using the teachings provided herein.

Detection of Glycosylation Levels: The glycan arrays of the invention can also be used to detect whether various glycoproteins are appropriately glycosylated. Various diseases are characterized by inappropriate levels (e.g. lack of glycosylation) or inappropriate types of glycosylation. For example, carbohydrate-deficient glycoprotein syndromes (CDGS) are related to under glycosylation of proteins. The most common initial test for CDGS is to analyze the glycosylation pattern on the glycoprotein transferrin using isoelectric focusing. According to the invention, glycans can be isolated from transferrin samples of patients, printed on the solid surfaces described herein and quantified. Quantification can be performed using antibodies or lectins that bind to specific glycans. Alcoholism can also be diagnosed through glycosylation changes of transferrin.

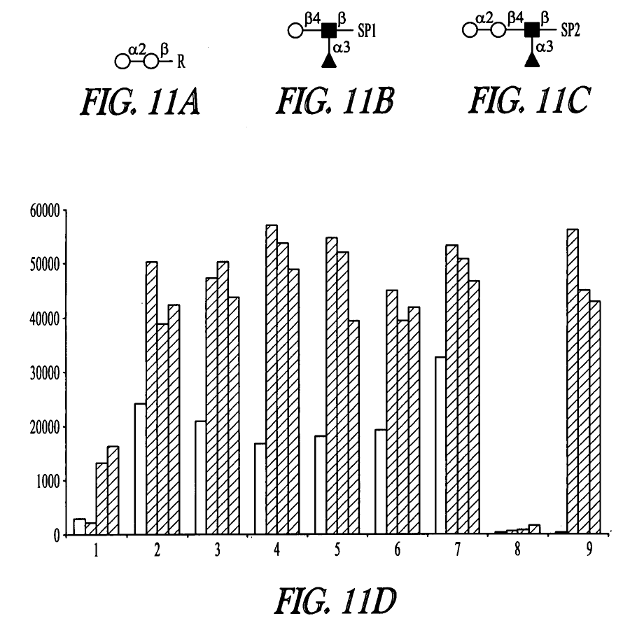

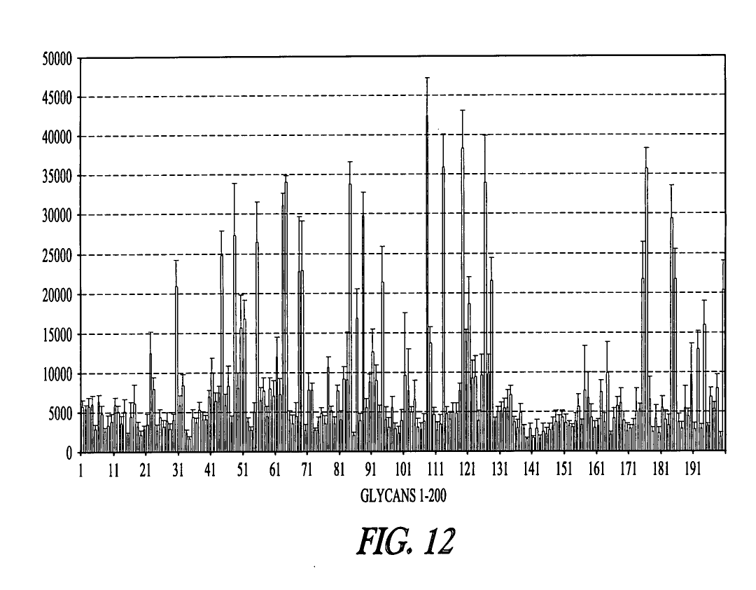

Detection of Transplant Rejection: As illustrated herein, immune responses directed against transplanted tissues were detected using the arrays and methods of the invention. In particular, several diabetic patients received transplanted porcine fetal pancreas islet-like cell clusters. Serum was taken from these patients before transplantation and at 1 month after (t=1), 6 months after (t=2) and 12 months after (t=3) transplantation. As described and illustrated herein, significantly greater amounts of antibodies reactive with alpha-Gal-3 glycan epitopes were detected after transplantation (see FIG. 11). For example, antibodies in transplant recipients bound to the following glycan epitopes: Gal-alpha3-Gal-beta (structure 33), Gal-alpha3-Gal-beta4-GlcNAc[alpha3-Fucose]-beta (structure 34), Gal-alpha3-Gal-beta4-Glc-beta (structure 35), Gal-alpha3-Gal[alpha2-Fucose]-beta4-GlcNAc-beta (structure 36), Gal-alpha3-Gal-beta4-GalAc-beta (structure 37), Gal-alpha3-GalAc-alpha (structure 38), and Gal-alpha3-Gal-beta (structure 39).

In particular, antibodies were detected that bound to alpha-Gal-LeX (structure 34 in FIG. 7, also shown in FIG. 11C). This alpha-Gal-LeX glycan is not found in humans, but has been reported to be present on porcine kidney cells. See Bouhors D. et al., Gala1-3-LeX expressed on iso-neolacto ceramides in porcine kidney GLYCOCONJ. J. 10: 1001-16 (1998). However, patients who received transplantation of porcine fetal pancreas islet-like cell clusters clearly exhibited an immune response (antibody production) against the alpha-Gal-LeX glycan epitopes.

Thus, the arrays and methods of the invention are useful for detecting, monitoring, evaluating and treating graft rejection after transplantation and/or xenotransplantation.

Antibodies of the Invention

The invention provides antibodies that bind to glycans that react with circulating antibodies present in patients with a variety of diseases. Such antibodies are useful for the diagnosis and treatment of the disease. For example, as is illustrated herein, different patients may have produced different amounts and somewhat different types of antibodies against breast-cancer associated glycan epitopes. Hence, administration of antibodies that are known to have good affinity for the breast-cancer associated glycan epitopes of the invention will be beneficial even though the patient has begun to produce some antibodies reactive with breast cancer epitopes. Similarly, as illustrated herein, certain glycan molecules are excellent antigenic epitopes that are recognized by anti-HIV neutralizing antibodies. Antibodies that have slightly different (e.g., improved) affinities for known HIV epitopes are useful for treating and detecting HIV. Thus, the invention provides antibody preparations that can bind any of the glycan epitopes described herein.

Antibodies can be prepared using a selected glycan, class of glycans or mixture of glycans as the immunizing antigen. The glycan or glycan mixture is coupled to a carrier protein by a spacer of the invention. Commonly used carrier proteins which can be chemically coupled to epitopes include keyhole limpet hemocyanin (KLH), thyroglobulin, bovine serum albumin (BSA), and tetanus toxin. A coupled protein can be used to immunize the animal (e.g., a mouse, a rat, or a rabbit).

If desired, polyclonal or monoclonal antibodies can be further purified, for example, by binding to and elution from a matrix to which the glycan or mixture of glycans to which the antibodies were raised is bound. Those of skill in the art will know of various techniques common in the immunology arts for purification and/or concentration of polyclonal antibodies, as well as monoclonal antibodies (Coligan, et al., Unit 9, Current Protocols in Immunology, Wiley Interscience, 1991, incorporated by reference).

It is also possible to use the anti-idiotype technology to produce monoclonal antibodies which mimic an epitope. For example, an anti-idiotypic monoclonal antibody made to a first monoclonal antibody will have a binding domain in the hypervariable region which is the “image” of the epitope bound by the first monoclonal antibody.

An antibody suitable for binding to a glycan is specific for at least one portion or region of the glycan. For example, one of skill in the art can use a whole glycan or fragment of glycan to generate appropriate antibodies of the invention. Antibodies of the invention include polyclonal antibodies, monoclonal antibodies, and fragments of polyclonal and monoclonal antibodies.

The preparation of polyclonal antibodies is well-known to those skilled in the art (Green et al., Production of Polyclonal Antisera, in Immunochemical Protocols (Manson, ed.), pages 1-5 (Humana Press 1992); Coligan et al., Production of Polyclonal Antisera in Rabbits, Rats, Mice and Hamsters, in Current Protocols in Immunology, section 2.4.1 (1992), which are hereby incorporated by reference). For example, a glycan or glycan mixture is injected into an animal host, preferably according to a predetermined schedule incorporating one or more booster immunizations, and the animal is bled periodically. Polyclonal antibodies specific for a glycan or glycan fragment may then be purified from such antisera by, for example, affinity chromatography using the glycan coupled to a suitable solid support.

The preparation of monoclonal antibodies likewise is conventional (Kohler & Milstein, Nature, 256:495 (1975); Coligan et al., sections 2.5.1-2.6.7; and Harlow et al., Antibodies: A Laboratory Manual, page 726 (Cold Spring Harbor Pub. 1988)), which are hereby incorporated by reference. Briefly, monoclonal antibodies can be obtained by injecting mice with a composition comprising an antigen (glycan), verifying the presence of antibody production by removing a serum sample, removing the spleen to obtain B lymphocytes, fusing the B lymphocytes with myeloma cells to produce hybridomas, cloning the hybridomas, selecting positive clones that produce antibodies to the antigen, and isolating the antibodies from the hybridoma cultures. Monoclonal antibodies can be isolated and purified from hybridoma cultures by a variety of well-established techniques. Such isolation techniques include affinity chromatography with Protein-A Sepharose, size-exclusion chromatography, and ion-exchange chromatography (Coligan et al., sections 2.7.1-2.7.12 and sections 2.9.1-2.9.3; Barnes et al., Purification of Immunoglobulin G (IgG), in Methods in Molecular Biology, Vol. 10, pages 79-104 (Humana Press 1992)). Methods of in vitro and in vivo multiplication of monoclonal antibodies are available to those skilled in the art. Multiplication in vitro may be carried out in suitable culture media such as Dulbecco's Modified Eagle Medium or RPMI 1640 medium, optionally replenished by a mammalian serum such as fetal calf serum or trace elements and growth-sustaining supplements such as normal mouse peritoneal exudate cells, spleen cells, bone marrow macrophages. Production in vitro provides relatively pure antibody preparations and allows scale-up to yield large amounts of the desired antibodies. Large scale hybridoma cultivation can be carried out by homogenous suspension culture in an air reactor, in a continuous stirrer reactor, or immobilized or entrapped cell culture. Multiplication in vivo may be carried out by injecting cell clones into mammals histocompatible with the parent cells, e.g., osyngeneic mice, to cause growth of antibody-producing tumors. Optionally, the animals are primed with a hydrocarbon, especially oils such as pristine tetramethylpentadecane prior to injection. After one to three weeks, the desired monoclonal antibody is recovered from the body fluid of the animal.

Antibodies can also be prepared through use of phage display techniques. In one example, an organism is immunized with an antigen, such as a glycan or mixture of glycans of the invention. Lymphocytes are isolated from the spleen of the immunized organism. Total RNA is isolated from the splenocytes and mRNA contained within the total RNA is reverse transcribed into complementary deoxyribonucleic acid (cDNA). The cDNA encoding the variable regions of the light and heavy chains of the immunoglobulin is amplified by polymerase chain reaction (PCR). To generate a single chain fragment variable (scFv) antibody, the light and heavy chain amplification products may be linked by splice overlap extension PCR to generate a complete sequence and ligated into a suitable vector. E. coli are then transformed with the vector encoding the scFv, and are infected with helper phage, to produce phage particles that display the antibody on their surface. Alternatively, to generate a complete antigen binding fragment (Fab), the heavy chain amplification product can be fused with a nucleic acid sequence encoding a phage coat protein, and the light chain amplification product can be cloned into a suitable vector. E. coli expressing the heavy chain fused to a phage coat protein are transformed with the vector encoding the light chain amplification product. The disulfide linkage between the light and heavy chains is established in the periplasm of E. coli. The result of this procedure is to produce an antibody library with up to 10⁹ clones. The size of the library can be increased to 10¹⁸ phage by later addition of the immune responses of additional immunized organisms that may be from the same or different hosts. Antibodies that recognize a specific antigen can be selected through panning. Briefly, an entire antibody library can be exposed to an immobilized antigen against which antibodies are desired. Phage that do not express an antibody that binds to the antigen are washed away. Phage that express the desired antibodies are immobilized on the antigen. These phage are then eluted and again amplified in E. coli. This process can be repeated to enrich the population of phage that express antibodies that specifically bind to the antigen. After phage are isolated that express an antibody that binds to an antigen, a vector containing the coding sequences for the antibody can be isolated from the phage particles and the coding sequences can be recloned into a suitable vector to produce an antibody in soluble form. In another example, a human phage library can be used to select for antibodies, such as monoclonal antibodies, that bind to specific glycan epitopes. Briefly, splenocytes may be isolated from a human that has a disease (e.g. cancer, bacterial infection, viral infection, inflammation, transplant rejection, autoimmune diseases and the like) and used to create a human phage library according to methods described herein and available in the art. These methods may be used to obtain human monoclonal antibodies that bind to specific glycan epitopes. Phage display methods to isolate antigens and antibodies are known in the art and have been described (Gram et al., Proc. Natl. Acad. Sci., 89:3576 (1992); Kay et al., Phage display of peptides and proteins: A laboratory manual. San Diego: Academic Press (1996); Kermani et al., Hybrid, 14:323 (1995); Schmitz et al., Placenta, 21 Suppl. A:S106 (2000); Sanna et al., Proc. Natl. Acad. Sci., 92:6439 (1995)).

An antibody of the invention may be derived from a “humanized” monoclonal antibody. Humanized monoclonal antibodies are produced by transferring mouse complementarity determining regions from heavy and light variable chains of the mouse immunoglobulin into a human variable domain, and then substituting human residues in the framework regions of the murine counterparts. The use of antibody components derived from humanized monoclonal antibodies obviates potential problems associated with the immunogenicity of murine constant regions. General techniques for cloning murine immunoglobulin variable domains are described (Orlandi et al., Proc. Nat'l Acad. Sci. USA, 86:3833 (1989) which is hereby incorporated in its entirety by reference). Techniques for producing humanized monoclonal antibodies are described (Jones et al., Nature, 321:522 (1986); Riechmann et al., Nature, 332:323 (1988); Verhoeyen et al, Science, 239:1534 (1988); Carter et al., Proc. Nat'l Acad. Sci. USA, 89:4285 (1992); Sandhu, Crit. Rev. Biotech., 12:437 (1992); and Singer et al., J. Immunol., 150:2844 (1993), which are hereby incorporated by reference).

In addition, antibodies of the present invention may be derived from a human monoclonal antibody. Such antibodies are obtained from transgenic mice that have been “engineered” to produce specific human antibodies in response to antigenic challenge. In this technique, elements of the human heavy and light chain loci are introduced into strains of mice derived from embryonic stem cell lines that contain targeted disruptions of the endogenous heavy and light chain loci. The transgenic mice can synthesize human antibodies specific for human antigens (e.g. the glycans described herein), and the mice can be used to produce human antibody-secreting hybridomas. Methods for obtaining human antibodies from transgenic mice are described (Green et al., Nature Genet., 7:13 (1994); Lonberg et al., Nature, 368:856 (1994); and Taylor et al., Int. Immunol., 6:579 (1994), which are hereby incorporated by reference).

Antibody fragments of the invention can be prepared by proteolytic hydrolysis of the antibody or by expression in E. coli of DNA encoding the fragment. Antibody fragments can be obtained by pepsin or papain digestion of whole antibodies by conventional methods. For example, antibody fragments can be produced by enzymatic cleavage of antibodies with pepsin to provide a 5S fragment denoted F(ab′)₂. This fragment can be further cleaved using a thiol reducing agent, and optionally a blocking group for the sulfhydryl groups resulting from cleavage of disulfide linkages, to produce 3.5S Fab′ monovalent fragments. Alternatively, an enzymatic cleavage using pepsin produces two monovalent Fab′ fragments and an Fc fragment directly. These methods are described (U.S. Pat. Nos. 4,036,945; 4,331,647; and 6,342,221, and references contained therein; Porter, Biochem. J., 73:119 (1959); Edelman et al., Methods in Enzymology, Vol. 1, page 422 (Academic Press 1967); and Coligan et al. at sections 2.8.1-2.8.10 and 2.10.1-2.10.4).

Other methods of cleaving antibodies, such as separation of heavy chains to form monovalent light-heavy chain fragments, further cleavage of fragments, or other enzymatic, chemical, or genetic techniques may also be used, so long as the fragments bind to the antigen that is recognized by the intact antibody.

For example, Fv fragments include an association of V_{H} and V_{L} chains. This association may be noncovalent (Inbar et al., Proc. Nat'l Acad. Sci. USA, 69:2659 (1972)). Alternatively, the variable chains can be linked by an intermolecular disulfide bond or cross-linked by chemicals such as glutaraldehyde (Sandhu, Crit. Rev. Biotech., 12:437 (1992)). Preferably, the Fv fragments comprise V_{H} and V_{L} chains connected by a peptide linker. These single-chain antigen binding proteins (sFv) are prepared by constructing a structural gene comprising DNA sequences encoding the V_{H} and V_{L} domains connected by an oligonucleotide. The structural gene is inserted into an expression vector, which is subsequently introduced into a host cell such as E. coli. The recombinant host cells synthesize a single polypeptide chain with a linker peptide bridging the two V domains. Methods for producing sFvs are described (Whitlow et al., Methods: A Companion to Methods in Enzymology, Vol. 2, page 97 (1991); Bird et al., Science, 242:423 (1988), Ladner et al., U.S. Pat. No. 4,946,778; Pack et al., Bio/Technology, 11:1271 (1993); and Sandhu, Crit. Rev. Biotech., 12:437 (1992)).

Another form of an antibody fragment is a peptide that forms a single complementarity-determining region (CDR). CDR peptides (“minimal recognition units”) can be obtained by constructing genes encoding the CDR of an antibody of interest. Such genes are prepared, for example, by using the polymerase chain reaction to synthesize the variable region from RNA of antibody-producing cells (Larrick et al., Methods: A Companion to Methods in Enzymology, Vol. 2, page 106 (1991)).

An antibody of the invention may be coupled to a toxin, for example, by using the spacers of the invention. Such antibodies may be used to treat animals, including humans that suffer from diseases such as cancer, bacterial infection, viral infection, and the like. For example, an antibody that binds to a glycan that is etiologically linked to development of breast cancer may be coupled to a tetanus toxin and administered to a patient suffering from breast cancer. Similarly, an antibody that binds to a viral-specific glycan epitope may be coupled to a tetanus toxin and administered to a patient suffering from viral infection. The toxin-coupled antibody can bind to a breast cancer cell or virus and kill it.

An antibody of the invention may be coupled to a detectable tag, for example, by using a spacer of the invention. Such antibodies may be used within diagnostic assays to determine if an animal, such as a human, has a disease or infection. Examples of detectable tags include, fluorescent proteins (i.e., green fluorescent protein, red fluorescent protein, yellow fluorescent protein), fluorescent markers (i.e., fluorescein isothiocyanate, rhodamine, texas red), radiolabels (i.e., ³H, ³²P, ¹²⁵I), enzymes (i.e., β-galactosidase, horseradish peroxidase, β-glucuronidase, alkaline phosphatase), or an affinity tag (i.e., avidin, biotin, streptavidin). Methods to couple antibodies to a detectable tag are known in the art. Harlow et al., Antibodies: A Laboratory Manual, page 319 (Cold Spring Harbor Pub. 1988).

Kits

Another aspect of the invention is a kit containing a spacer-derivatized library of glycans as well as reagents and instructions for linking the spacer-derivatized glycans to another agent or to a solid support. The kit can also contain a solid support useful for immobilizing the spacer-derivatized glycans.

The present invention further pertains to a packaged pharmaceutical composition such as a kit or other container for detecting, controlling, preventing or treating a disease. The kits of the invention can be designed for detecting, controlling, preventing or treating diseases such as cancer, bacterial infection, viral infection, inflammation, transplant rejection, autoimmune diseases and the like. In one embodiment, the kit or container holds an array or library of spacer-derivatized glycans for detecting disease and instructions for using the array or library of spacer-derivatized glycans for detecting the disease. The array includes at least one spacer-derivatized glycan that is bound by antibodies present in serum samples of persons with the disease.

In a further embodiment, the kit comprises a container containing an antibody that specifically binds to a glycan that is associated with a disease, where the antibody is attached to therapeutic agent by a spacer of the invention. The antibody can also be provided in liquid form, powder form or other form permitting ready administration to a patient. The kit can also comprise containers with tools useful for administering the compositions of the invention. Such tools include syringes, swabs, catheters, antiseptic solutions and the like.

The following examples are for illustration of certain aspects of the invention and is not intended to be limiting thereof.

### EXAMPLE 1

### Synthesis of Bi-Functional Spacers

This Example describes methods for making a specific bi-functional spacer of the invention. For example, the bi-functional spacer molecules can be made as illustrated and described below.

### Synthesis of N-(2-Bromo-ethyl)-2,2-dimethyl-propionamide (1002)

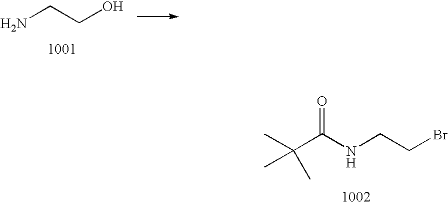 Ethanolamine (1001) (40 mmol) and di-tertbutyl dicarbonate (32 mmol) were dissolved in CH₂Cl₂. Triethylamine (TEA) (40 mmol) was added and the mixture was stirred for 4 h at room temperature (RT), under N₂. The mixture was washed with 0.1 M Na₂SO₄ (3×200 mL) and brine (2×200 mL). The organic layer was dried with anhydrous MgSO₄ and filtered. The solvent was removed by rotary evaporation, to yield the protected amine (1.3 g, 28%). The alcohol was dissolved in CH₂Cl₂ (45 mL) followed by adding MsCl (13.8 mmol) and TEA (17.9 mmol) and the reaction mixture was stirred at room temperature for 45 minutes, under N₂. LiBr (138 mmol) in acetone (45 mL) were added and the mixture was stirred for an additional 17 h. The solvents were removed by rotary evaporation and the remaining residue was dissolved in EtOAc (125 mL) and washed with H₂O (2×75 mL), saturated NaCO₃ (75 mL) and brine (75 mL). The solution was dried with anhydrous MgSO₄, filtered and concentrated by rotary evaporation. The product mixture was purified on a silica column (3×25 cm) and eluted with hexanes:EtOAc (80:20). Appropriate fractions were collected and concentrated to give 1002 (1.2 g, 64%) and used without further purifications.

### Synthesis of N-Boc-Protected Methyl N,O-hydroxylamine (1004)

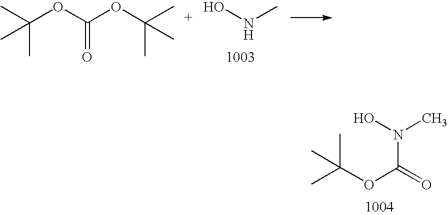 Methyl N,O-hydroxylamine (1003) (40 mmol) and di-tertbutyl dicarbonate (32 mmol) were dissolved in CH₂Cl₂. TEA (40 mmol) was added and the mixture was stirred for 4 h at RT, under N₂. The mixture was washed with 0.1 M Na₂SO₄ (3×200 mL) and brine (2×200 mL) and the organic layer was dried with anhydrous MgSO₄ and filtered. The solvent was removed by rotary evaporation, to give 1004 (3.0 g, 72%) and used without further purification.

### Formation of O-(2-amino-ethyl)-N-methyl-hydroxylamine (1005)

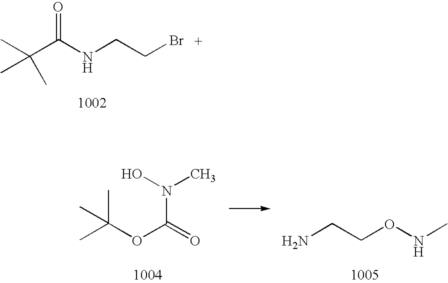 Compound 1004 (7.2 mmol) was dissolved in DMF (4.75 mL) and NaH (6.92 mmol) was added. The reaction mixture was stirred for 1 hour at RT, under N₂. The mixture was cooled to 0° C. and compound 1002 (5.8 mmol) dissolved in DMF (5 mL) was added. The mixture was stirred for 3 h on ice and followed by purification on a silica column (3×25 cm), and eluted with hexane:EtOAc (70:30). The appropriate fractions were collected and evaporated to give protected 1005 (0.8 g, 54%). An aliquot of protected 1005 (1.94 mmol) was dissolved in CH₂Cl₂ (2.5 mL) and TFA (9.68 mmol) was added. The reaction mixture was stirred at room temperature, under N₂ for 30 minutes. TLC confirmed quantitative deprotection to amine. Dowex 1×8×400 mesh (OH) was added (˜10 equiv.) to neutralize the TFA. The product solution was lyophilized, re-constituted in water and any precipitate was removed by centrifugation. The supernatant was lyophilized to yield 5 (0.15 g, 87%) as a white solid. ESI-TOF high-accuracy MS m/z calculated for (M+Na), 475.1653; found, 475.1643.

O-(2-amino-ethyl)-N-methyl-hydroxylamine (1005) is one example of a bi-functional spacer of the invention.

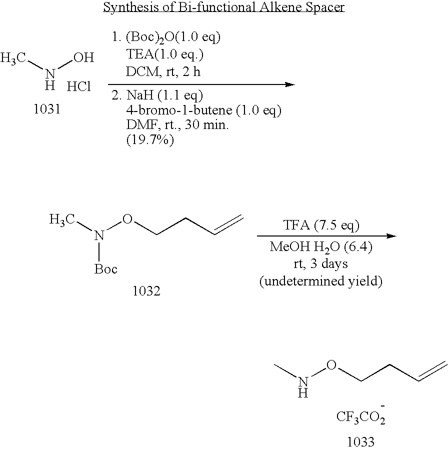

Synthesis of tert-butyl but-3-enyloxy(methyl)carbamate (1032): Boc-anhydride (50.0 g, 0.229 mole) and N-methylhydroxylamine hydrochloride (27.4 g, 0.229 mole) were dissolved in dichloromethane (150 mL), and stirred at room temperature. Added triethylamine (32 mL, 0.229 mol). Bubbles evolved and a milky-white solution formed. TLC on 60 Â silica gel (8 hexane: 2 ethyl acetate, visualization by ninhydrin (0.05M in DMSO) gives a spot at R_{f}=0.23. Added DI H₂O (200 mL) and extracted with Dichloromethane (3×200 mL). Washed combined organic layers with brine (1×200 mL). Dried over anhydrous magnesium sulfate for 30 minutes, then filtered through Celite 545. Removed solvent under vacuum. Reddish oil remains (weight 32.2 g).

To the Boc-protected N-methylhydroxylamine generated was added 60% NaH (6.20 g, 0.258 mole). Bubbles evolved and a foam was formed. The foam was swirled for 30 minutes to ensure its breakup and a more thorough deprotonation by NaH. Dropwise, added 4-bromo-1-butene (23.3 mL, 0.229 mole). Addition of this reagent resulted in disappearance of the foam and formation of a yellow-brown mixture. Let stir over night. TLC (8 hexane: 2 ethyl acetate, visualization by ninhydrin (0.05 M in DMSO)) gives a new spot at R_{f}=0.63). Added DI H₂O (200-mL) and extracted with ethyl acetate (3×200 mL). Washed the combined organic layers with Brine (1×200 mL). Dried organic layer over anhydrous magnesium sulfate for 30 minutes, then filtered through Celite 545. Removed solvent under vacuum. Purified by silica-gel column chromatography. Isolated 9.1 grams (19.7% yield).

¹H NMR (500 MHz, CDCl₃): δ (ppm)=5.82 (m, 1H), 5.12 (d, 1H, J=15 Hz), 5.05 (d, 1H, J=10 Hz), 3.88 (t, 2H, J=6.5 Hz), 3.08 (s, 3H), 2.36 (td, 2H, J=6.5 Hz), 1.48 (s, 9H).

Boc-deprotection and formation of compound 1033: Tert-butyl but-3-enyloxy(methyl)carbamate (1032) (504.4 mg, 2.51 mmole) was dissolved in MeOH (6 mL) and D₁-H₂O (4 mL). Trifluoracetic acid (1.44 mL, 18.69 mmol) was added slowly. Solution became very clear. Stirred for 3 days. The salt is too volatile for solvent removal under vacuum. Instead, neutralized with NaOH (2N) (pKₐ₁=4.8) and extracted free base amine into diethyl ether for use in bonding to carbohydrates (OB1-98).

¹H NMR (300 MHz, D₂O): δ (ppm)=5.86 (m, 1H), 5.19 (td, 2H), 4.17 (t, 2H, J=17.9 Hz), 3.01 (s, 3H), 2.42 (qt, 2H, J=32.8 Hz).

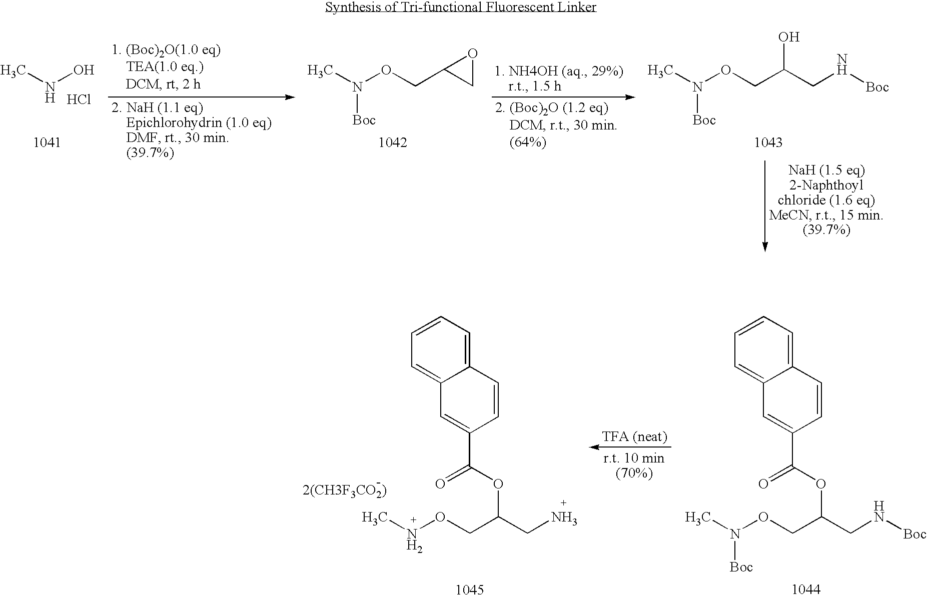

Synthesis of tert-butyl methyl(oxiran-2-ylmethoxy)carbamate (1042): In a 1-liter round bottom flask, Boc-anhydride (50.0 g, 0.229 mol) was dissolved in dichloromethane (200 mL). While stirring, N-methylhydroxylamine hydrochloride (27.4 g, 0.229 mol) was added, followed by triethylamine (32 mL, 0.229 mol). Bubbles evolved and a milky-white solution formed. The mixture was stirred for 2 hours. Thin layer chromatography performed using a 60 Å silica gel (7 hexane: 3 ethyl acetate, with visualization by ninhydrin (0.05 M in DMSO)), yielded a spot at R_{f}=0.5. Distilled deionized water was added to the solution followed by extraction with dichloromethane (3×100 mL). The combined organic layers were washed with sodium chloride brine (1×200 mL) and dried over anhydrous magnesium sulfate for 20 minutes. The organic layers were then filtered through Celite 545 and the solvent was removed under a vacuum. A light-red clear oil remained (29 grams).

This oil was dissolved in N,N′-dimethylformamide (200 mL) and sodium hydride (6.20 g, 0.258 mol) was added. The solution became a thick yellow foam and swirling for about 30 minutes was required to bring down the foaming. Epichlorohydrin (20-mL, 0.256 mol) was added and the mixture was swirled vigorously for 30 minutes. The foam became an avocado-green solution, then a brown solution. Stirring was continued at room temperature over night. Distilled deionized water (200 mL) was added and the mixture was extracted with ethyl acetate (3×200 mL). The combined organic layers were washed with sodium chloride brine (1×200 mL). The organic layer was dried over anhydrous magnesium sulfate for 20 minutes, then filtered through Celite-545. Thin layer chromatography (solvent 8 hexane: 2 Ethyl acetate), visualized using ninhydrin (0.05 M in DMSO), identified the product (1042) at R_{f}−0.2. Purification by column chromatography yielded 18.45 grams (39.7% yield) of 1042.

¹H NMR (300. MHz, CDCl₃): δ (ppm)=4.04 (dd, 1H J=3.6, 7.8 Hz), 3.77 (dd, 1H, J=6.3, 5.1 Hz), 3.23 (m, 1H), 3.12 (s, 3H), 2.83 (t, 1H, J=2.4 Hz), 2.59 (dd, 1H, J=2.4 Hz, 2.7 Hz).

Synthesis of compound 1043: To a 25-mL round bottom flask containing epoxide (1042) (134.5 mg, 0.66 mmol) was added 29% ammonium hydroxide in water (4 mL) and the mixture was stirred at room temperature for 1.5 hours. The resulting compounds were separated by thin layer chromatography (solvent 6 hexane:4 ethyl acetate), and visualized by ninhydrin (0.05 M in DMSO). The starting material had completely disappeared and the product remained at the baseline. The product was collected and solvent was removed using a vacuum. A clear light-yellow oil remained (mass=146 mg).

The yellow oil was dissolved in dichloromethane (3 mL) and Boc-anhydride (150 mg, 0.69 mmol) was added. Bubbles evolved from this solution, which was then stirred at room temperature for 30 minutes. Thin layer chromatography performed using 6 hexane: 4 ethyl acetate, with visualization by ninhydrin (0.05 M in DMSO)) showed that the starting materials were almost completely converted to di-Boc-protected product (new spot at R_{f}=0.37). The product (1043) was purified by chromatography on silica gel, yielding 135.4 mg yellow oil (64% yield).

¹H NMR (500 MHz, CDCl₃): δ (ppm)=5.08 (s, 1H, broad), 4.53 (s, 1H, broad), 3.88 (d, 2H, 3 Hz), 3.65 (t, 1H, 9.5 Hz), 3.33 (d, 1H, broad), 3.13 (t, 1H, 6 Hz), 3.09 (s, 3H), 1.69 (s, 9H), 1.49 (s, 9H).

Synthesis of compound 1044 by addition of 2-Naphthanoyl chloride fluorophore: Sodium hydride (64 mg, 1.6 mmol, 1.5 mol eq) was added to a 25-mL round bottom flask containing compound 1043 (338.3 mg, 1.06 mmol) in acetonitrile (3.5 mL). Bubbling was observed as the clear-colorless solution became a white suspension. The suspension was stirred for 5 minutes and 2-naphthoyl chloride (320 mg, 1.68 mmol, 1.6 mol eq) was added. The solution became very white. Thin layer chromatography using 6 hexane: 4 ethyl acetate, with visualization by UV light (λ=254 nm) and ninhydrin (0.05 M in DMSO)) showed that fluorescent-blue product (R_{f}=0.67) had formed. Water (8-mL) was added and the mixture was extracted with ethyl acetate (2×10 mL). The combined organic layers were washed with sodium chloride brine (1×10 mL) and then dried over anhydrous magnesium sulfate for 20 minutes. After filtration through Celite-545, the solvent was removed using a vacuum. The product (1044) was purified by chromatography over 60 Å silica gel and 174.5 mg yellow oil was isolated that fluoresced under UV light (34.7% yield).

¹H NMR (400 MHz, CDCl₃): δ (ppm)=8.61 (s, 1H), 8.06 (d, 1H, J=1.2 Hz), 7.93 (d, 1H, J=8 Hz), 7.84 (d, 2H, 8.4 Hz), 7.50 (m, 2H), 5.45 (m, 2H), 4.15 (m, 2H), 3.58 (m, 2H), 3.09 (s, 3H), 1.46 (s, 9H), 1.40 (s, 9H).

Boc-deprotection and generation of compound (1045): To a 5-mL conical vial containing compound 1044 (111.6 mg, 0.238 mmol) was added trifluoroacetic acid (2 mL) and the solution was stirred for 10 minutes. Thin layer chromatography using 6 hexane: 4 ethyl acetate, with visualization by UV light (λ=254 nm) and ninhydrin (0.05 M in DMSO), showed that the product was on the baseline. The trifluoroacetic acid was removed using a vacuum to yield a clear amber oil. The product was purified by preparative thin layer chromatography, yielding 45.9 mg (70% yield) of 1045.

¹H NMR (400 MHz, CD₃OD): δ (ppm)=8.71 (s, 1H), 8.09 (d, 1H, J=0.8 Hz), 8.00 (d, 1H, J=8 Hz), 7.93 (t, 2H, J=8 Hz), 7.60 (m, 2H), 5.56 (m, 1H), 4.00 (d, 2H, J=5.2 Hz), 3.42 (d, 2H, J=2 Hz). 2.66 (s, 3H).

Fluorescence spectrum maxima (CD₃OD solvent): λₑₓ=358 nm. λₑₘ=384 nm. Color of emitted light: blue-violet.

### EXAMPLE 2

### Attachment of a Bi-Functional Spacer to a Glycan

This Example shows how a glycan can be linked to a bi-functional spacer of the invention. 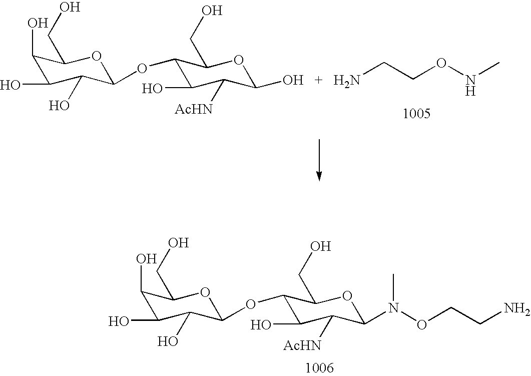
N-acetyllactosamine was reacted with 20 molar equivalents of the bi-functional spacer, O-(2-amino-ethyl)-N-methyl-hydroxylamine (1005) in the presence of acetate buffer, pH 4.5, at room temperature for 12-24 hours. The reaction yield of derivatized N-acetyllactosamine (1006) was 60-90%, with approximately 96% of the resulting derivatized glycan in the beta (β) configuration.

### EXAMPLE 3

### Attachment of Spacer-Derivatized Glycans to an Array

This Example illustrates the attachment or printing efficiency of the bi-functional spacers when linked to a variety of glycans.

Materials and Methods:

N-acetyllactosamine (LacNAc) was used as a model substrate for N-glycans where the penultimate monosaccharide is N-acetylglucosamine (GlcNAc). Similarly, N-acetylneuraminic acid (Neu5Ac) was used as a model compound for acid treated lipopolysaccharides (LPS) where the penultimate monosaccharide residue is 3-deoxy-manno-octulosonic acid (KDO). Thus, LacNAc and Neu5Ac were derivatized with the spacers described herein on a preparative scale. Other derivatized glycans were prepared in 0.1-1 mg scale and identified by high resolution mass spectrometry (HR-MS).

General methods: Spacer compound 1005 was made as described in the previous Examples. Compound 1008 (Blixt et al., Glycobiology 9:1061-1071 (1999)), 1009 (Blixt et al., Carbohydr Res 319:80-91 (1999)), 1010 (Xia et al., Nat Methods 2:845-850 (2005)) and 1012 (Kajihara et al., Curr Med Chem 12:527-550 (2005)) were prepared as previously described. The T-antigen disaccharide was from Toronto Research Chemicals (Canada), heparin oligosaccharide was from Dextra (Oxford, UK) and compound 1016 was a gift for Dr. U. Knirel, Moscow, Russia). Silica gel (60 Å, 40-63 μm) was from EM Science. All other chemical and solvents were from Sigma-Aldrich. The reactions were monitored by thin layer chromatography (TLC) performed on Silica Gel 60F pre-coated TLC plates (EMD Chemicals Inc., Gibbstown, N.J., USA). After development with appropriate eluants, the spots were visualized by UV light for nucleotides and/or dipping in 5% sulfuric acid in ethanol, followed by charring to detect sugars. Nuclear magnetic resonance (NMR) spectra were recorded on Bruker DRX-500 and DRX-600 MHz instruments at 25° C. and were referenced to acetone δ 2.225 (¹H in D₂O) and δ 29.9 (¹³C in D₂O). Mass spectrometry (MS) profiles were recorded with an LC MSD TOF (Agilent Technologies, Foster City, Calif., USA) using dihydroxybenzoic acid as matrix. Water was purified by NanoPure Infinity Ultrapure water system (Barnstead/Thermolyne, Dubuque, Iowa, USA) and degassed by vacuum treatment before use.

General Preparation of Compounds 1006, 1011, 1013-1016. Free reducing glycans (10-50 nmol) and spacer 1005 (0.2-1.0 umol) were dissolved in aqueous buffer, pH 4.5 (20-200 uL), and incubated at 37 C.° for 24-48 h. To remove any remaining spacer and to desalt the sample the reaction mixture was purified on: Method A (neutral and charged oligosaccharides and polysaccharides), a 0.5 mL Carbograph column (REF). Bound derivatized glycan was eluted with 25% acetonitrile. Appropriate fractions were lyophilized and the presence of synthesized product was proven by thin layer chromatography and mass spectrometry. Compounds were isolated in high purity (>90%) and when possible verified by HPLC (method C). Lyophilized structure was used for printing without further purifications. Method B, (neutral and charged mono-, di-saccharides) were isolated by preparative TLC. Bound glycans were eluted with ethylacetate:acetic acid:methanol; water (6:3:3:2, by volume), and appropriate spots were removed and re-suspended in water. The solid particles were removed by centrifugation and supernatant was passed through a 22 μm filter and lyophilized. The obtained compounds were used for printing without further purifications. Method C, the reaction mixture was loaded (100 μL injection volume, x mg/mL) onto an amino column (Altima) conditioned in acetonitrile. Elution gradient (water:acetonitrile, 0-20%:100-80% over 20 minutes followed by isocratic water:acetonitrile 20:80 for 20 minutes, gave spacered products in >95% purity. For charged compounds TFA (0.1%) was added to the gradient. Spectral data for compound 6: Selected 1H NMR (500 MHz, D2O), δ(ppm): 4.60 (d, 1H, J=8 Hz, GlcNAc H-1), 4.47 (d, 1H, J=8 Hz, Gal H-1), 3.92 (d, 1H, Gal H-4), 4.06-4.03 (2m, 2H, OCH2CH2N3), 3.99 (dd, 1H, GlCNA H-2), 3.83 (dd, 1H, GlcNAc H-3), 3.72 (dd, 1H, GlcNAc H-4), 3.67 (dd, 1H, GlcNAc H-3), 3.55 (dd, 1H, Gal H-2), 3.40-3.50 (2m, 2H, OCH2CH2N3), 2.038 (s, 3H, NHCOCH3). Selected 13C NMR (500 MHz, D2O), δ(ppm): 174.26, 102.53, 100.60, 78.11, 75.00, 74.46, 72.16, 72.13, 70.61, 68.39, 68.20, 60.67, 59.70, 54.67, 50.01, 21.92. ESI-TOF high-accuracy MS m/z calculated for (M+Na), 475.1653; found, 475.1643.

Printing of arrays. The glycan arrays were created by robotic contact printing of ˜0.6 mL of glycans linked to the different spacers in print buffer (300 mM phosphate, 0.005% Tween 20, pH 8.5) onto NHS-activated glass slides (see further Examples provided herein). Each spacer-derivatized glycan (1006-12) was printed at 10 different concentrations in two-fold dilutions (200 μM to 0.4 μM), and each dilution was deposited 10 times, creating a 10×10 subgrid for each spacer-derivatized glycan. Post-printing humidification of the slides followed array fabrication immediately at 80% humidity for 30 min. The remaining NHS groups were blocked by immersing the slides in blocking buffer (50 mM ethanolamine in 50 mM borate buffer, pH 9.2) for 1 h. Slides were rinsed in water, dried under a stream of nitrogen, and stored in desiccators at RT before use.

Lectin staining. The spacer test arrays were analyzed with plant lectins without any further surface modifications of the slides. Prior to incubation, the print area was bordered with a hydrophobic marker on the surface of the slides approximately 20 min before incubation. Then the slides were washed with PBS for 2 min. The incubations followed a two-step procedure, in which the bound biotinylated GBP was overlaid with Alexa Fuor488-conjugated streptavidin. The biotinylated GBPs RCA-I and SNA (10 μg/mL) were diluted in incubation buffer (PBS, 0.05% Tween 20). Alexa Fuor488-conjugated streptavidin (0.4 μg/mL in PBS, 0.05% Tween 20) was used for detection. The samples (1 ml) were applied directly onto the surface and spread out over the entire print area bordered by the hydrophobic marker. The slides were incubated in a humidification chamber on a shaker for 1 h for each incubation step. Finally and in-between incubations the slides were washed by dipping 4 times each in (i) PBS, 0.05% Tween 20, (ii) PBS, and (iii) deionized water. Laser scanner imaging immediately followed the nitrogen-stream drying step.

Results

The derivatization of glycans with spacer molecules was quantitative and the glycoconjugate was isolated via a one-step purification using a Carbograph column or size exclusion chromatography in high yields (80-95%). The excess spacer was completely removed by chromatography and via its volatile nature. Thus, for example, the HPLC chromatogram and ¹H-NMR of LacNAc derivative (1006) showed complete conversion of starting material to product with only one anomeric configuration (H-1β, J_{C-N}=9.6 Hz) with correct molecular weight (m/z calculated for M+Na, 478.2013; found 478.2013).

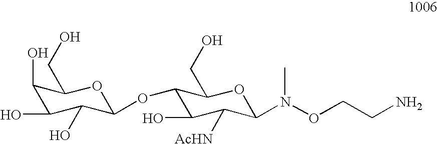

The reaction with Neu5Ac was also quantitative (m/z calculated for M+Na, 404.1645; found 404.1684) but the ¹H-NMR indicated a mixture of isomeric products (data not shown). However, these isomers were of minor importance for lectin recognition.

Small scale derivatization and isolation of a biantenary N-glycan, lactose, Galβ1-3GalNAc (T-antigen), heparin disaccharide, and mild acid treated lpt3 core oligosaccharide from Neisseria meningitidis gave compounds 1012 (m/z calculated for M+Na, 1971; found 2043), 1013, 1014 (m/z calculated for M+Na, 478.2013; found 478.2008), 1015, and 1016. The glycoconjugates were used for printing without further purifications and no degradation of conjugates was detected in print buffers (pH 8.5), blocking buffers containing ethanolamine (pH 9.5) or during storage of slides for at least 2 months (data not shown).

Thus, spacer-derivatized glycan compounds 1006-12, each containing a different amino moiety were synthesized. 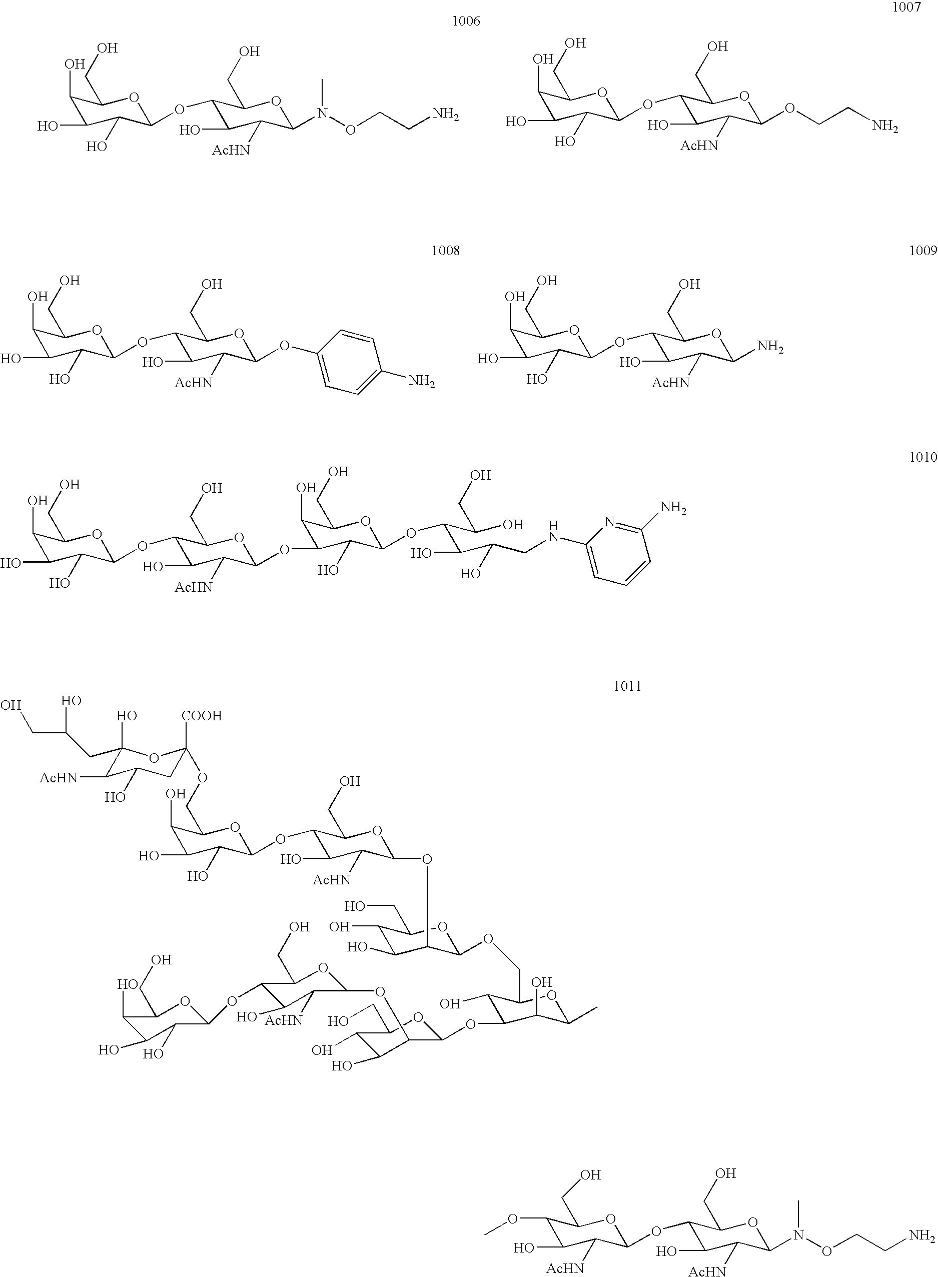 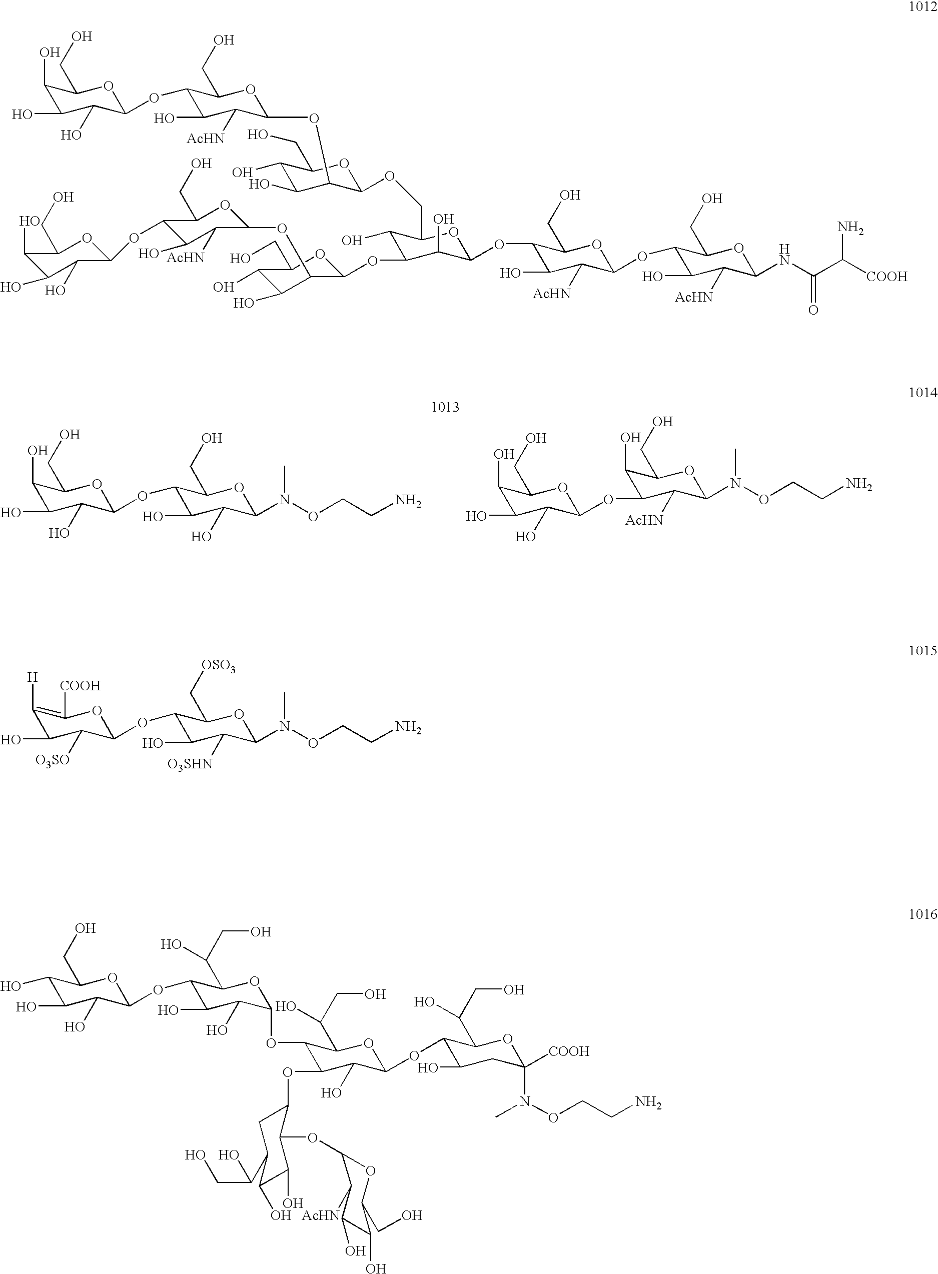
Glycans 1006-9 were derivatized LacNAc, glycans 1011-12 are derivatized N-glycans, glycan 1015 is derivatized heparin, glycans 1010 and 1013 are derivatized milk-oligosaccharides, glycan 1014 is a derivatized O-glycan, and glycan 1016 is a bacterial lipopolysaccharide.

The immobilization or “printing” efficiency of spacer-derivatized glycans with terminal LacNac (1006 and 1011) was compared to that of other commonly used amino derivatives such as 2-aminoethyl-(1007), 4-aminophenyl-(1008), glycosylamine (1009), 2,6-di-aminopyridylamine (1010). The solid supports employed were NHS-activated microglass slides and the conditions for printing were the same as described in this and in other Examples of this application as well as in Blixt et al. Proc Natl Acad Sci USA 101:17033-17038 (2004).

Each of the spacer-derivatized glycans were printed under the same conditions but at varying concentrations onto the NHS-activated microglass slides, using a 2-fold serial dilutions so that the spacer-derivatized glycan varied in concentration from 200 μM to 0.4 μM. Previous experiments had demonstrated that under these printing conditions, compound 1006 was incorporated in saturating amounts when a glycan concentration of greater than 50 μM was used as the printing concentration.

After printing, the slides were washed and the attached compounds were detected with biotinylated LacNAc specific Ricinus Communis Lectin I (RCA-I) and Sambucus Nigra Lectin (SNA) as described in the Examples herein and in Blixt et al. (2004).

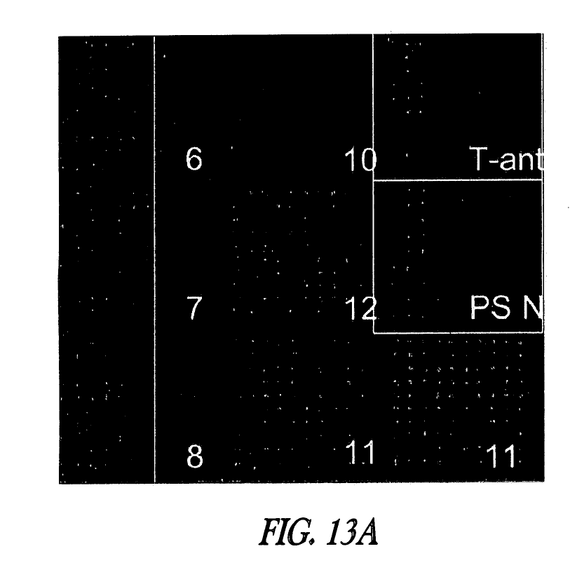

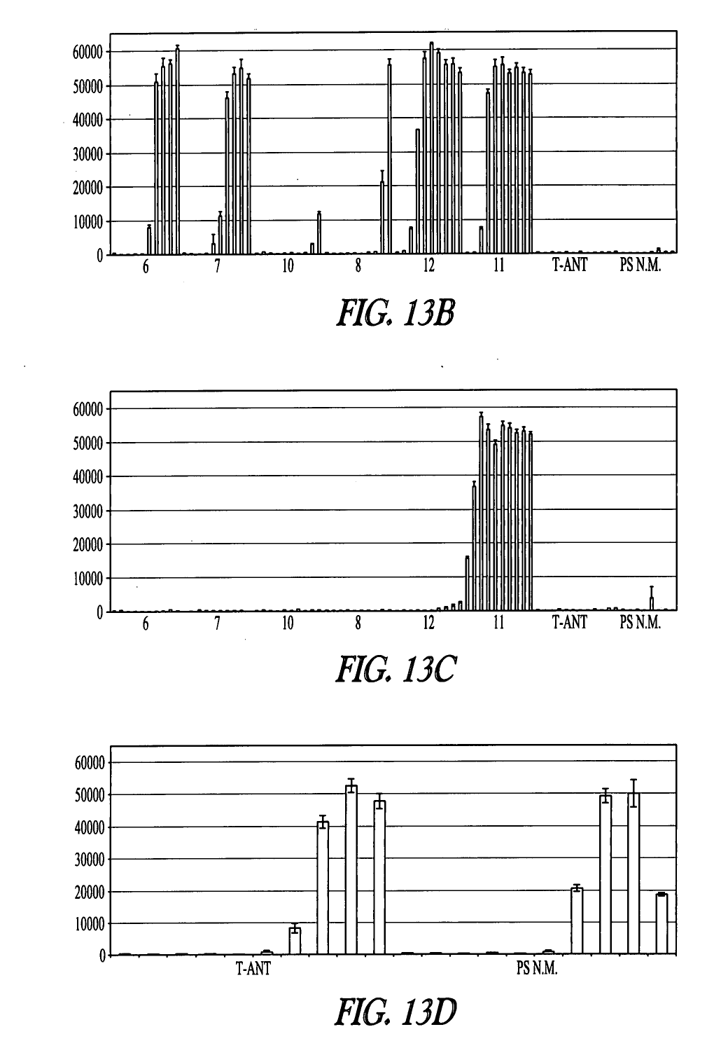

As shown in FIG. 13A-D, compounds with an amine on an alkyl chain or an amino acid (1006, 1007, 1011 and 1012) were printed with equal efficiency (FIGS. 13A and 13B). In contrast, a glycan with a bulky aryl group and a primary aromatic amine (1008) bound less well and, interestingly, the DAP derivative (1010) hardly bound at all, which is in sharp contrast to what was reported by Xia et al. (Nat Methods 2:845-850 (2005)). No detectable amounts of the glycosylamine (1009), with no alkyl or spacer arm, were bound to the array surface under the conditions employed (data not shown).

The printed LacNAc derivatives were also detected with the Neu5Acα2-6-LacNAc specific SNA lectin, which only binds to glycans containing the Neu5Acα2-6-LacNAc structures on one of their branches (FIG. 13A, section labeled 11A and FIG. 13C). Thus, the 1011 glycan, which contains Neu5Acα2-6-LacNAc structures was detected (11A section of FIG. 13A and FIG. 13C), showing that these Neu5Acα2-6-LacNAc structures were preserved during spacer attachment and array printing, and the conjugation conditions used here do not affect glycans with acid labile sialic acids.

In addition, the Galβ1-3GalNAc-specific BPL lectin (“T-ant”) and the lpt3 specific monoclonal antibody (“PS Nm”) were used to detect whether glycan 1016 was bound to the array. As shown in FIG. 13A (T-ant) as well as in FIG. 13D, the BPL lectin (T-ant) specifically bound to the Galβ1-3GalNAc structures of glycan 1016. Similarly, the PS N.m antibody, which was raised against glycans like the 1016 glycan, bound specifically to glycan 1016. These data show that bacterial liposaccharides such as glycan 1016 can readily be attached to the present spacer molecules and then immobilized on a solid surface (e.g. a glycan array) without affecting the structural integrity of the glycan.

In conclusion, the new bi-functional spacer and glycoconjugates containing such spacers have several important advantages. First, attachment of the spacer does not adversely affect glycan structure so that ring-closed spacer-derivatized glycans with preserved structural integrity are generated after reaction with the spacer and attachment onto solid surfaces. Second, after attachment of the spacer to a glycan, the spacer provides a reactive amine for efficient coupling onto amine reactive glass slide or other supports. Third, simple one-pot, one-step coupling procedures are used for spacer attachment to glycans and for immobilization of spacer-derivatized glycans onto solid surfaces (e.g. arrays). Fourth, the spacers of the invention are selectively reactive with various free reducing saccharides on the ends of glycans, rather than in the middle of glycan chains. Finally, the spacer-derivatized glycans are stable conjugates.

The derivatization procedure of the invention permits preparation and expansion of glycan libraries useful for making glycan arrays, for example, by attachment onto amino-reactive microglass slides. The present bi-functional spacers, in combination with recent developments of efficient isolation and purification of natural glycans along with increased availability of commercial glycans, will contribute significantly towards a goal of analyzing human, mammalian, viral, plant and bacterial glycomes.

### EXAMPLE 4

### Preparation and Use of Glycan Arrays

Materials. Natural glycoproteins, alpha1-acid glycoprotein (α₁-AGP), α₁-AGP glycoform A and B were prepared as described in Shiyan, S. D. & Bovin, N. V. (1997) Glycoconj. J. 14, 631-8. Ceruloplasmin, fibrinogen, and apo-transferrin were obtained from Sigma-Aldrich Chemical Company, MO. Synthetic glycan ligands 7-134, 146-200 (structures shown in FIG. 7) were from The Consortium for Functional Glycomics or prepared as described in Pazynina et al. (2003) Mendeleev Commun. 13, 245-248; Pazynina et al. (2002) Mendeleev Commun. 12, 183-184; Pazynina et al. (2002) Tet. Lett. 43, 8011-8013; Nifant'ev et al. (1996) J. Carbohydr. Chem. 15, 939-953; Zemlyanukhina et al. (1995) Carbohydr. Lett. 1, 277-284. Ligands 111, 135-139 (shown in FIG. 7) were obtained through one-pot chemical synthesis as described in Lee et al. (2004) Angew. Chem. Int. Ed. 43, 1000-1003. Ligands 140-145 (shown in FIG. 7) were isolated from ribonuclease as described herein.

NHS-activated glass slides (Slide-H) were employed that were from Schott Nexterion (Germany). These slides are coated with a hydrogel, which is composed of a multi-component coating matrix (thickness: 10-60 nm), which is cross-linked with the microarray glass substrate allowing stringent washing steps. Long, hydrophilic polymer spacers tether the functional groups (amine-reactive N-hydroxysuccinimide-esters) to the coating matrix, thereby ensuring that immobilized probes are highly accessible in a flexible, solution-like environment. The robotic printing arrayer employed was custom made by Robotic Labware Designs (Carlsbad, Calif.). Arrays were printed using CMP4B microarray spotting pins (TeleChem International, Inc).

Several glycan binding proteins (GBPs) were obtained from commercial sources (Con A and ECA from EY-laboratories Inc., San Mateo, Calif.; anti-CD15 from BD Biosciences, San Jose, Calif.). Other types of glycan binding proteins were obtained from various investigators including DC-SIGN (van Die et al. (2003) Glycobiology 13, 471-478), Influenza virus, A/Puerto Rico/8/34 (H1N1) (Gamblin et al. (2004) Science 303, 1838-42), 2G12 (Calarese et al. (2003) Science 300, 2065-71), Cyanovirin-N (Scanlan et al. (2002) J. Virol. 76, 7306-21), H3 HA (Stevens, Blixt and Wilson; manuscript in preparation).

Human serum was obtained from healthy volunteers at The General Clinical Research Center, Scripps Hospital, La Jolla. Human saliva was similarly obtained from a healthy volunteer. The samples were centrifuged for 30 min at 300 rpm and heat inactivated at 56° C. for 25 minutes. CD22 was expressed and purified as described in Blixt et al. (2003) J. Biol. Chem. 278, 31007-19. Recombinant human Galectin-4 was also prepared as described for rat Galectin-4 by Huflejt et al. (1997) J. Biol. Chem. 272, 14294-303. Galectin-4-AlexaFluor488 was made with AlexaFluor488 protein labeling Kit from Molecular Probes according to the manufacturer's instructions. Rabbit anti-CVN was obtained as described in Scanlan et al. (2002) J. Virol. 76, 7306-21. Monoclonal mouse anti-human-IgG-IgM-IgA-Biotin antibody and Streptavidin-FITC were from Pierce, Rockford, Ill. Rabbit anti-goat-IgG-FITC, goat anti-human-IgG-FITC, mouse anti-HisTag-IgG-Alexafluor-488 and anti-mouse-IgG-Alexafluor-488 were purchased from Vector Labs (Burlingame, Calif.). Rabbit anti-Influenza virus A/PR/8/34 was from the World Influenza Centre, Mill Hill, London, UK. Other reagents and consumables were from commercial sources with highest possible quality.

Pronase Digestion of Bovine Pancreatic Ribonuclease B. 540 mg of bovine pancreatic ribonuclease b (Sigma Lot 060K7650) was dissolved in 5 mls of 0.1M Tris+1 mM MgCl₂+1 mM CaCl₂ pH 8.0. 108 mg of pronase (Calbiochem Lot B 50874) was added to give a ratio by weight of five parts glycoprotein to one part pronase. This mixture was incubated at 60° C. for 3 hours. A second dose of 108 mg pronase was added and incubated at 37° C. for another 3 hours, after which it was boiled for 30 minutes, cooled and centrifuged. The sample was loaded onto 20 ml of freshly prepared ConA in 0.1M Tris, 1 mM MgCl₂, 1 mM CaCl₂, pH 8.0, washed and eluted with 200 ml 0.1M methyl-α-D-mannopyranoside (Calbiochem Lot B37526). The Con A eluted sample was purified on Carbograph solid-phase extraction column (Alltech 1000 mg, 15 ml) and eluted with 30% acetonitrile +0.06% TFA. The eluate was dried and reconstituted in 1 ml water. Mass analysis was done by MALDI and glycan quantification by phenol sulfuric acid assay.

Carbohydrates obtained from bovine pancreatic ribonuclease B were separated by DIONEX chromatography. 20 ul of the pronase digested ribonuclease b was injected on the DIONEX using a PA-100 column and eluted with the following gradient (solution A=0.1M NaOH, solution B=0.5M NaOAc in 0.1M NaOH): 0% B for 3 min, then a linear gradient from 0% B to 6.7% B for 34 min. The individual peak fractions were collected and purified on Carbograph solid-phase columns (Alltech 150 mg, 4 ml) by elution with 80% acetonitrile containing 0.1% TFA. The peak fractions were then dried and reconstituted in water. Final Mass analysis and glycan quantification were performed.

Glycan array fabrication. Microarrays were printed by robotic pin deposition of ˜0.6 nL of various concentrations (10-100 μM) of amine-containing glycans in print buffer (300 mM phosphate, pH 8.5 containing 0.005% Tween-20) onto NHS-activated glass slides. Each compound was printed at two concentrations (100 μM and 10 μM) and each concentration in a replicate of six. Printed slides were allowed to react in an atmosphere of 80% humidity for 30 mins followed by desiccation over night. Remaining NHS-groups were blocked by immersion in buffer (50 mM ethanolamine in 50 mM borate buffer, pH 9.2) for 1 hr. Slides were rinsed with water, dried and stored in desiccators at room temperature prior to use.

Glycan Binding Protein binding assay. Printed slides were analyzed without any further modification of the surface. Slides were incubated in either a one step procedure with labeled proteins, or a sandwich procedure in which the slide was first incubated with a sample that might contain a glycan binding protein (GBP) and then was overlaid with labeled secondary antibodies or GBP's pre-complexed with labeled antibodies. GBP's were added at a concentration of 5-50 μg/mL in buffer (usually PBS containing 0.005-0.5% Tween-20). Secondary antibodies (10 μg/mL in PBS) were overlaid on bound GBP. GBP-antibody pre-complexes were prepared in a molar ratio of 1:0.5:0.25 (5-50 μg/mL) for GBP:2° antibody:3° antibody, respectively (15 mins on ice). The samples (50-100 μL) were applied either directly onto the surface of a single slide and covered with a microscope cover slip, or applied between two parallel slides separated by thin tape and pressed together by paper clips (see Ting et al. (2003) BioTechniques 35, 808-810) and then incubated in a humidified chamber for 30-60 minutes. Slides were subsequently washed by successive rinses in (i) PBS-Tween (0.05%), (ii) PBS and (iii) de-ionized water, then immediately subjected to imaging. Serum samples were typically used at dilutions of 1:25 and 0.4-0.8 mL applied directly onto the slide surface without any cover glass. Saliva samples were similarly handled. The slides were gently rocked at room temperature for 90 min followed by detection with secondary antibodies (Table 4). Whole virus was applied (0.8 mL) at a concentration of 100 μg/mL in buffer (PBS containing 0.05% Tween-20) containing the neuraminidase inhibitor oseltamivir carboxylate (10 μM). The slides were gently rocked at room temperature for 90 min followed by detection with secondary antibodies also in presence of the neuraminidase inhibitor (Table 4).

TABLE 4
Valencies of Glycan Binding Proteins

| | | | Secondary | Tertiary | |
|---|---|---|---|---|---|
| Category | GBP | Valency | Antibody | Antibody^{a} | Final |
| Plant | Con A-FITC | 4 | | | 4 |
| Lectin | ECA-FITC | 2 | | | 2 |
| Plant | | | | | |
| Lectin | | | | | |
| Human C | DC-SIGN-Fc^{b} | 2 | | | 2 |
| Type | | | | | |
| Human | CD22-Fc | 2 | α-hlgG-F^{a} | α-glgG-F^{a} | 8 |
| Siglec | | | | | |
| Human | Galectin-4- | 2 | | | 2 |
| Galectin | AF488 | | | | |
| Human | Anti-CD15- | 2 | | | 2 |
| IgG | FITC | | | | |
| Human | 2G12 | 2 | α-hlgG-F^{d} | | 4 |
| IgG | | | | | |
| Human | Serum^{c} | 2 | | | 2 |
| IgG/A/M | | | | | |
| Bacterial | Cyanovirin^{d} | 2 | | | 2 |
| GBP | | | | | |
| Viral GBP | Influenza HA | 3 | α-HA-HF^{a} | α-migG- | 12 |
| | (H3) | | | AF^{a} | |
| Intact | Influenza | 500 | A-PR8 | α-rlgG- | 500 |
| Virus | (PR8)^{e} | | | AF^{a} | |

^{a}Abbreviations used: Ab = antibody; F = FITC; AF = AF488.
^{b}After binding of DC-SIGN, binding was detected by overlay with anti-human IgG-AF488.
^{c}After binding of serum diluted 1:25 with PBS, binding was detected by overlay with goat anti-human IgG/M/A-Biotin (1:100) (Pierce) followed by Streptavidin-FITC (1:100).
^{d}After binding of CVN, binding was detected by overlay with polyclonal rabbit anti-CVN IgG-AF488 followed by anti-rabbit IgG-FITC.
^{e}After binding of virus, binding was detected by overlay with rabbit anti-PR8 followed by goat anti-rabbit IgG-AF-488.

Image acquisition and signal processing. Fluorescence intensities were detected using a ScanArray 5000 (Perkin Elmer, Boston, Mass.) confocal scanner and image analyses were carried out using ImaGene image analysis software (BioDiscovery Inc, El Segundo, Calif.). Signal to background was typically greater than 50:1 and no background subtractions were performed. Data were plotted using MS Excel software.

Results

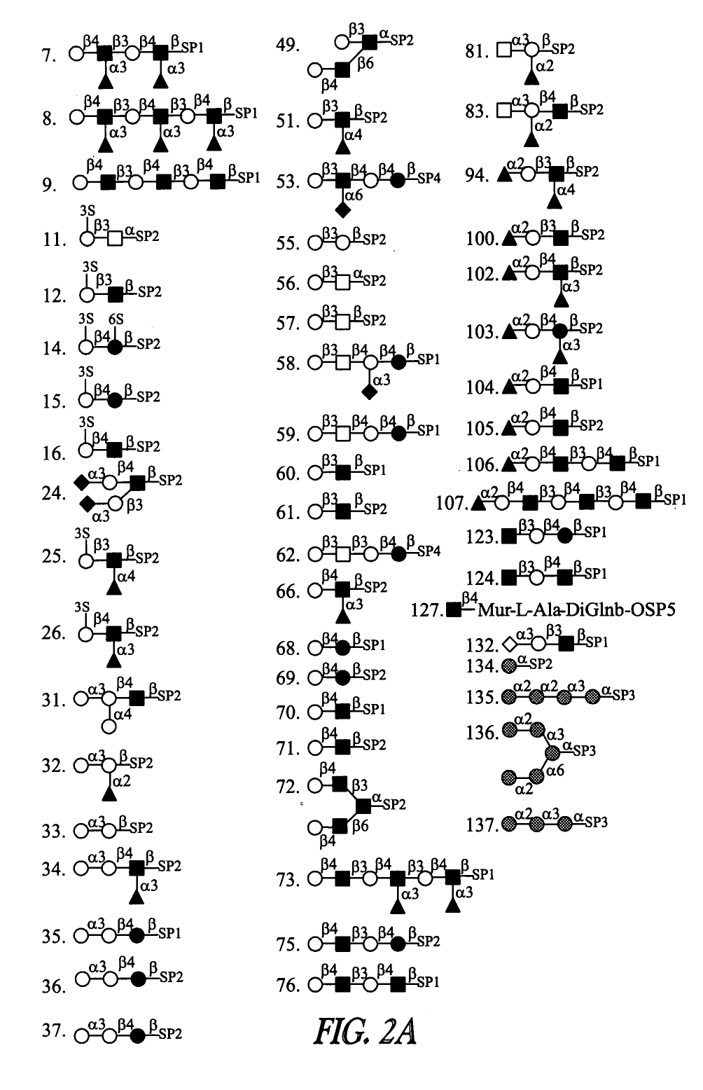

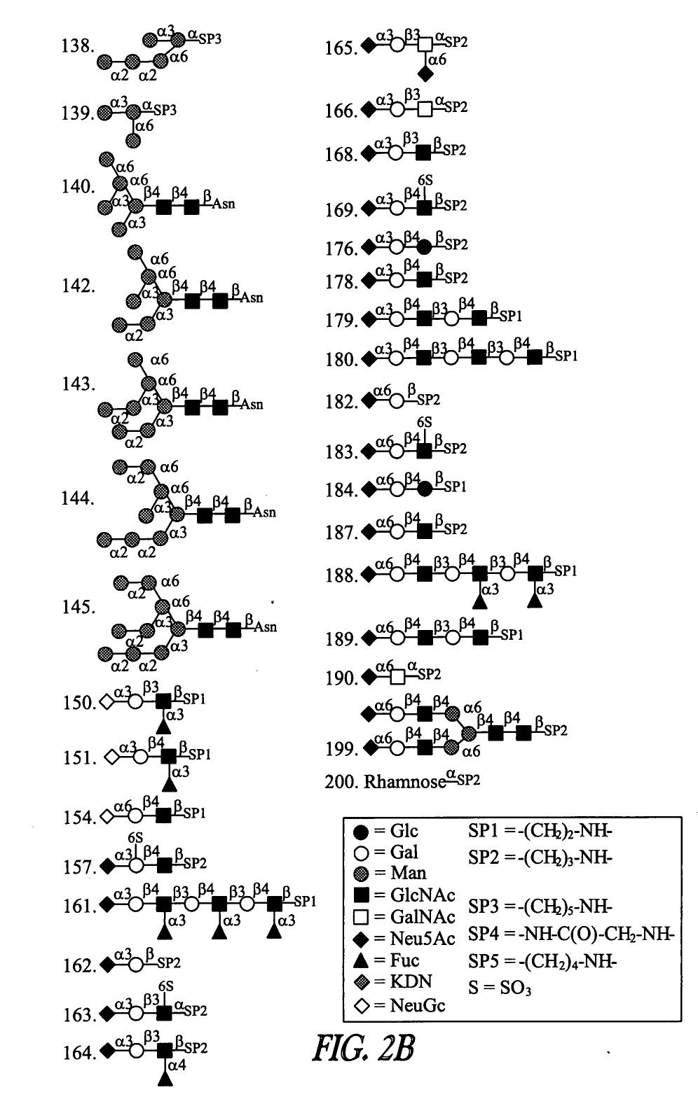

Glycan array design. The strategy adopted for covalently attaching a defined glycan library to micro-glass slides employed standard microarray printing technology was as illustrated in FIG. 1. The use of an amino-reactive NHS-activated micro-glass surface allows covalent attachment of glycans containing a terminal amine by forming an amide bond under aqueous conditions at room temperature. The compound library of 200 glycoconjugates comprises diverse and biologically relevant structures representing terminal sequences of glycoprotein and glycolipid glycans. Glycan structures detected by glycan binding proteins are listed in FIG. 2 and a more complete glycan listing is provided in FIG. 7, and Table 3. In addition, exemplary symbol structures summarizing the principal specificities of each glycan binding protein are depicted in each Figure.

Optimization of glycan printing. Length of time of the printing process was a concern because the moisture sensitive NHS-slides would be exposed to air during the procedure. Binding of fluorescein-labeled concanavalin A (con A) was used as a measure of ligand coupling. Maximal binding of con A to high mannose glycans, 134-138 (structures provided in FIG. 7 and Table 3), was obtained at concentrations >50 μM, with less than 10% variation in maximal binding observed with printing times up to 5 hours, as was observed for compound 136 (structure provided in FIG. 7). For the complete array, standard printing concentrations of 100 μM and 10 μM of each glycan were selected to represent saturating and sub-saturating levels, respectively, of the printed glycan. All samples were printed in replicates of six to generate an array of >2400 spotted ligands per glass slide, including controls.

General approach for profiling GBP specificity. In general, GBPs have low affinity for their ligands, and would not be expected to bind with sufficient avidity to withstand washing steps to remove unbound protein. For this reason, the approach routinely used was to create multivalency as necessary to mimic the multivalent interactions that occur in nature. Some of the glycan binding proteins evaluated in these experiments and the degree of multivalency used to achieve robust binding are summarized in Table 4. The valency required for binding ranged from 2 to 12. In several cases monovalent glycan binding proteins were evaluated as divalent recombinant Ig-Fc chimeras, and in other cases, higher valencies were achieved through the use of secondary antibodies. Binding was detected by including a fluorescent label either on the glycan binding protein or secondary antibody.

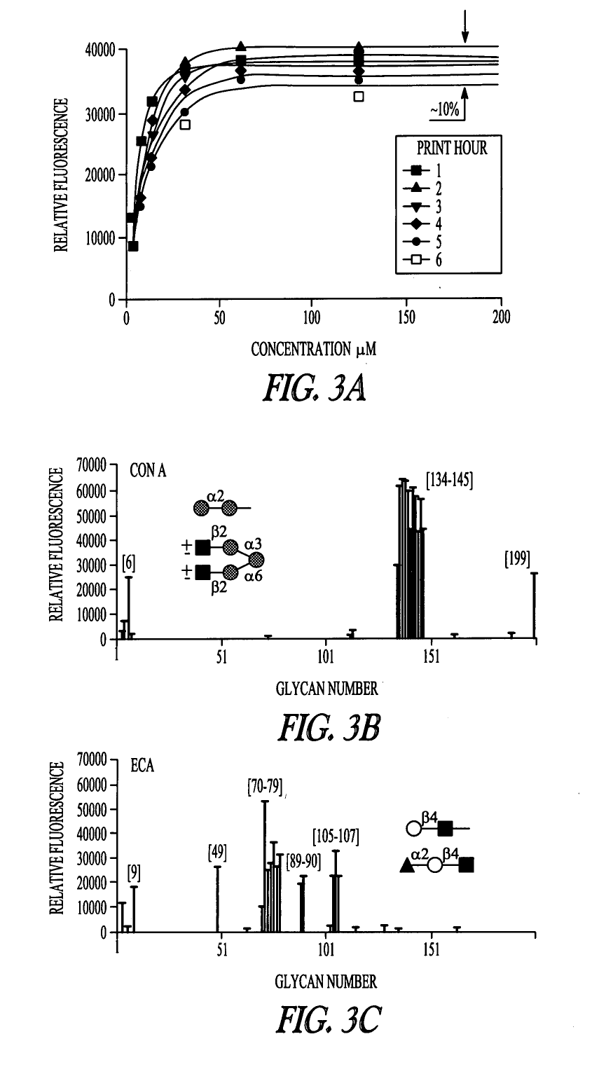

Specificity of plant lectins. As shown in FIG. 3, two lectins, Con A and Erythrina cristagalli lectin (ECA) exhibited binding to different subsets of glycans on the array, consistent with their reported specificities. Con A bound selectively to synthetic ligands consisting of one or more α-D-mannose (Manα1) residues as well as to isolated high-mannose N-glycans, and a bi-antennary N-linked glycan (134-145, 199, see FIG. 7). ECA bound exclusively to various terminal N-acetyllactosamine (LacNAc) structures, poly-LacNAc (9, 73, 76, see FIG. 7) and branched O-glycans (49, 72, see FIG. 7). ECA also tolerated terminal Fucα1-2Gal substitution (105-107, see FIG. 7). These specificities are consistent with those previously observed using other methodologies. See, e.g., Gupta et al. (1996) Eur. J. Biochem. 242, 320-326; Brewer et al. (1985) Biochem. Biophys. Res. Commun. 127, 1066-71; Lis et al. (1987) Meth. Enzymol. 138, 544-551; Iglesias et al. (1982) Eur. J. Biochem. 123, 247-252.

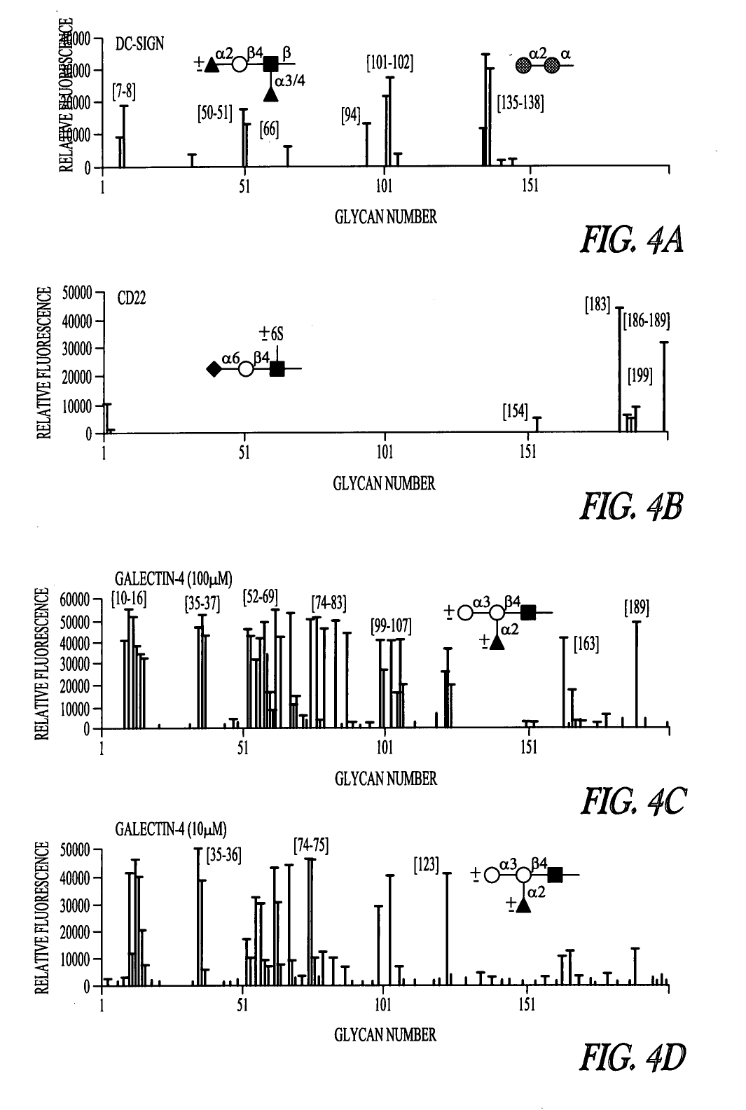

Analysis of specificities of human GBPs. Three major families of mammalian glycan binding proteins (GBPs) are involved in cell surface biology through recognition of glycan ligands—C-type lectins, siglecs and galectins. One exemplary member from each class was selected for analysis (FIG. 4).

DC-SIGN, a member of the group 2 subfamily of the C-type lectin family, is a dendritic cell protein implicated in innate immunity and the pathogenicity of human immunodeficiency virus-1 (HIV-1) (Kooyk, Y. & Geijtenbeek, T. B. (2002) Immunol. Rev. 186, 47-56). As shown in FIG. 4, a recombinant DC-SIGN-FC recognized two classes of glycans, various fucosylated oligosaccharides with the Fucα1-3GlcNAc and Fucα1-4GlcNAc oligosaccharides found as terminal sequences on N- and O-linked oligosaccharides (7, 8, 51, 66, 94, 102, see FIG. 7), and mannose containing oligosaccharides terminated with Manα1-2-residues (135-138, 144, 145, see FIG. 7), consistent with specificities found by other groups, for example, as described in Guo et al. (2004) Nat. Struct. Mol. Biol. 11, 591-8; van Die et al. (2003) Glycobiology 13, 471-478; and Adams et al. (2004) Chem. Biol. 11, 875-81.

CD22, a member of the immunoglobulin superfamily lectins (Siglecs), is a well-known negative regulator of B cell signaling and binds selectively to glycans with Siaα2-6Gal-sequences. Blixt et al. (2003) J. Biol. Chem. 278, 31007-19; Engel et al. (1993) J. Immunol. 150, 4719-4732; Kelm et al. (1994) Curr. Biol. 4, 965-72; Powell et al. (1993) J. Biol. Chem. 268, 7019-7027. As shown in FIG. 4B, CD22 bound exclusively to the seven structures containing the terminal Siaα2-6Galβ1-4GlcNAc-sequence including a bi-antennary N-linked glycan (154, 187-189 and 199, see FIG. 7). An additional 6-O-GlcNAc-sulfation (Neu5Acα2-6Galβ1-4[6Su]GlcNAc-183, see FIG. 7) appeared to enhance binding relative to the corresponding non-sulfated glycan, suggesting that this glycan could be a preferred ligand for human CD22.

Galectins are a family of β-galactoside binding lectins that bind terminal and internal galactose residues. See, Hirabayashi et al. (2002) Biochim. Biophys. Acta 1572, 232-54. Galectin-4 has been identified as a possible intracellular mediator with anti-apoptotic activity. Huflejt et al. (1997) J. Biol. Chem. 272, 14294-303; Huflejt, M. E. & Leffler, H. (2004) Glycoconjugate J. 20, 247-55. By comparing Galectin-4 binding to saturated glycans (printed at 100 μM concentration) with binding to sub-saturated glycans (printed at 10 μM concentration), preferred binding specificities were revealed. In particular, as shown in FIG. 4C, Galα1-3-linked to lactose (35-37), Fucα1-2-linked to lac(NAc) (100, 103, 105-107), or GlcNAcβ1-3-linked to lactose (123), as well as 3′-sulfation (11-16) substantially enhanced the affinity. This specificity profile is similar to that reported for a rat ortholog of Galectin-4. See Wu et al. (2004) Biochimie 86, 317-26; Oda et al. (1993) J. of Biol. Chem. 268, 5929-5939.

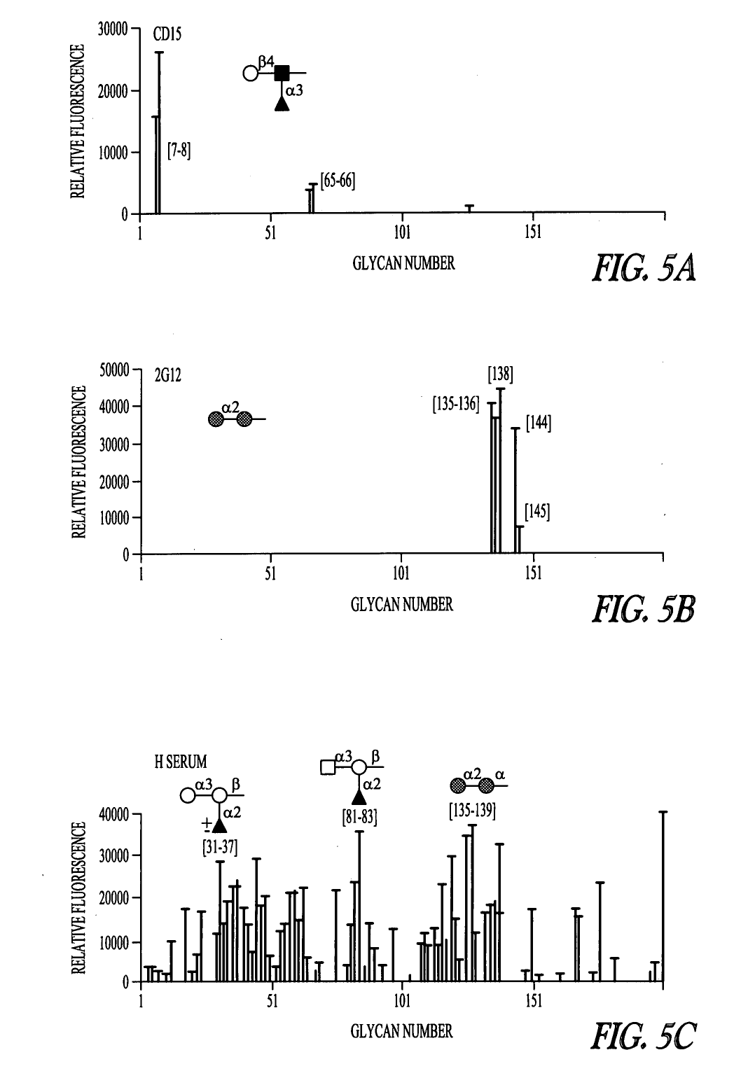

Glycan specific antibodies. Monoclonal and polyclonal anti-glycan antibodies from three different sources were also analyzed (FIG. 5). The commercial leukocyte differentiation antigen CD-15 has been documented to recognize a carbohydrate antigen, Lewis^{x} (Galβ1-4[Fucα1-3]GlcNAc). When evaluated on the array described herein this antibody was highly specific for Lewis^{x} structures (7, 8, 66, see FIG. 7), and did not recognize the same structure modified by additional sialylation (161), sulfation (26), fucosylation (102) or LacNAc extension (73)(see FIG. 7 for structures). FIG. 5A shows the specificity of an anti-CD15 antibody preparation for Lewis^{X} glycans.

One of the most studied human anti-HIV monoclonal antibodies is 2G12, which neutralizes a broad spectrum of natural HIV isolates via recognition of high mannose type N-linked glycans on the major envelope glycoprotein, gp120. Lee et al. (2004) Angew. Chem. Int. Ed. 43, 1000-1003; Calarese et al. (2003) Science 300, 2065-71; Scanlan et al., (2002) J. Virol. 76, 7306-21; Sanders (2002) J. Virol 76, 7293-305; Trkola et al. (1996) J. Virol. 70, 1100-8. The glycan array contains a variety of synthetic mannose fragments with the natural series of high mannose N-glycans (Man5-Man9) isolated from ribonuclease B.

As shown in FIG. 5B, recombinant 2G12 exhibited strong binding of synthetic Manα1-2-terminal mannose oligosaccharides (135, 136, 138). See also Bryan et al. (2004) J. Am. Chem. Soc. 126, 8640-41; Lee et al. (2004) Angew. Chem. Int. Ed. 43, 1000-1003; Adams et al. (2004) Chem.l Biol. 11, 875-81. In addition, of the series of natural high mannose type N-glycans, 2G12 exhibited preferred binding to Man8 glycans (144) relative to Man5, Man6, Man7 or Man9 glycans (140, 142, 143, 145) (see FIG. 7 for these structures).

In particular, the glycans to which the 2G12 antibodies bound had any the following Man-8 N-glycan structures, or were a combination thereof:

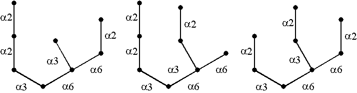

wherein each filled circle (●) represents a mannose residue.

A smaller level of binding was observed between the 2G12 antibodies and Man-9-N-glycans. As shown in Table 5, simpler synthetic glycans bind 2G12 as well as the Man8 glycans. However, the simpler compounds are more likely to elicit an immune response that will generate antibodies to the immunogen, but not the high mannose glycans of the gp120. The natural structure is also less likely to produce an unwanted immune response. Indeed, yeast mannan is a polymer of mannose and is a potent immunogen in humans, representing a major barrier to production of recombinant therapeutic glycoproteins in yeast.

TABLE 5
Summary of the binding of 2G12 to mannose containing glycans in the
glycan array shown in FIG. 7. Samples 1-6 are glycoproteins, samples
134-139 are synthetic high mannose glycans, samples 140-145 are
natural high mannose glycopeptides isolated from bovine ribonuclease,
and sample 199 is a bi-antennary complex type glycan terminated in
sialic acid. Relative binding activity: − = < 1000; + = 1000-6000;
++ 6000-25,000; and +++ > 25,000.

| No. | Mannose containing ligands | Rel. spec. |
|---|---|---|
| 1 | Alpha1-acid glycoprotein | − |
| 2 | Alpha1-acid glycoprotein A | − |
| 3 | Alpha1-acid glycoprotein B | − |
| 4 | Ceruloplasmin | − |
| 5 | Transferrin | − |
| 6 | Fibrinogen | − |
| 134 | Ma#sp3 | − |
| 135 | Ma2Ma2Ma3Ma#sp3 | +++ |
| 136 | Ma2Ma3[Ma2Ma6]Ma#sp3 | +++ |
| 137 | Ma2Ma3Ma#sp3 | − |
| 138 | Ma3[Ma2Ma2Ma6]Ma#sp3 | +++ |
| 139 | Ma3[Ma6]Ma#sp3 | − |
| 140 | Man-5#aa | − |
| 142 | Man-6#aa | − |
| 143 | Man-7#aa | − |
| 144 | Man-8#aa | +++ |
| 145 | Man-9#aa | + |
| 199 | OS-11 | − |

These results indicate that glycans with eight mannose residues are superior antigens for binding the 2G12 anti-HIV neutralizing antibodies.

To test the array against more complex samples, anti-glycan antibodies present in human serum and saliva were investigated. Following incubation with serum or saliva, bound IgG, IgA and IgM were detected on the glycan array using labeled anti-human IgG/A/M antibody.

A surprising diversity of antibody specificities was observed in both serum and saliva. The binding results observed for serum samples from ten individuals are shown in FIG. 5C. This profile of human anti-glycan antibodies detects the ABO blood group fragments (variously represented in different individuals) (32, 81, 83), mannose fragments (135-139), α-Gal-(31-37) and ganglioside-epitopes (55-59, 132, 168), as well as fragments of the gram negative bacterial cell wall peptidoglycan (127) and rhamnose (200)(see FIG. 7 for these structures). Notably, glycans containing the Galβ1-3GlcNAc sub-structure were consistently detected (12, 61, 62, 132, 150, 168) except when fucosylated (25, 51, 94, 100) thus generating the human blood group antigens H, Lewis^{a} or Lewis^{b} (see FIG. 7 for structures). All of these structures can be identified as either blood group antigens or fragments of microorganisms (e.g. bacteria, yeast etc.) to which humans are exposed.

A variety of glycan binding proteins are also detected in saliva, as shown in FIG. 12.

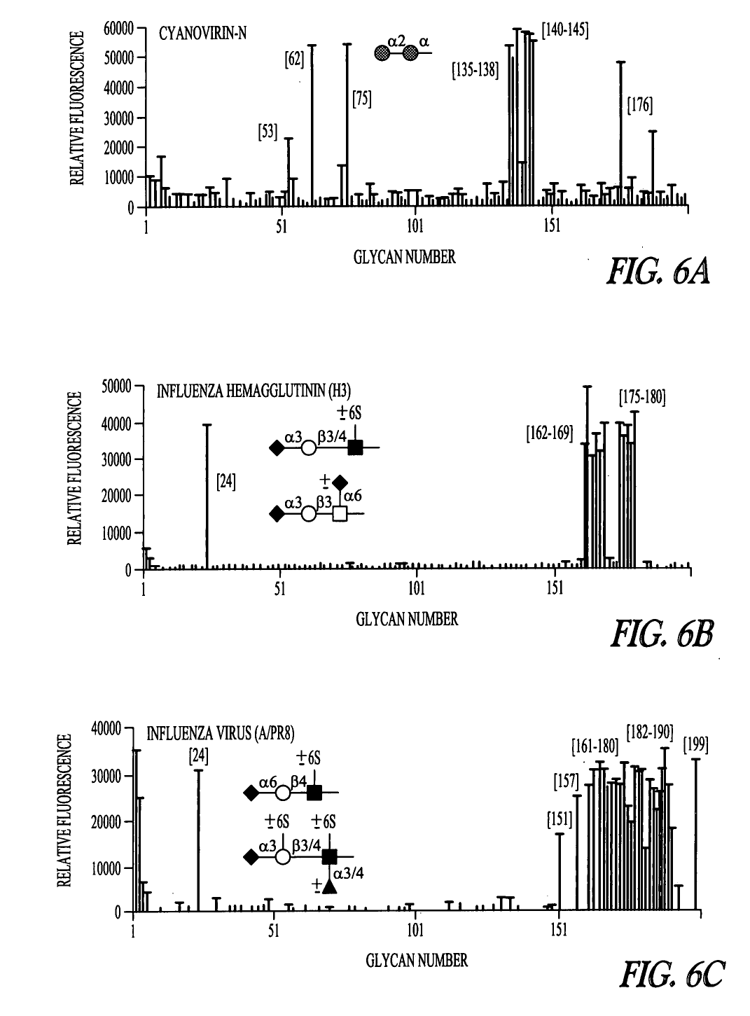

Analysis of bacterial and viral GBPs. Cyanovirin-N (CVN) is a cyanobacterial protein that can block the initial step of HIV-1 infection by binding to high mannose groups on the envelope glycoprotein gp120. Adams et al. (2004) Chem. Biol. 11, 875-81; Bewely, C. A. & Otero-Quintero, S. (2001) J. Am. Chem. Soc. 123, 3892-3902. On the array, CVN specifically recognized the synthetic fragments bearing terminal Manα1-2-residues (135-138), as well as high mannose glycans with one or more Manα1-2-termini (140-145), in keeping with its reported specificity (FIGS. 6 and 7). In addition, CVN bound to several lacto- and neolacto-structures (53, 62, 75, 176, see FIGS. 6 and 7).

Influenza viruses exhibit specificity in their ability to recognize sialosides as cell surface receptor determinants through the viral binding protein, the hemagglutinin. Depending on the species of origin, the hemagglutinin has specificity for sialosides with sialic acid in the NeuAcα2-3Gal or NeuAcα2-6Gal linkage. Connor et al. (1994) Virol. 205, 17-23; Rogers, G. N. & D'Souza, B. L. (1989) Virol. 173, 317-22; Rogers et al. (1983) Nature 304, 76-8. While the intrinsic affinity of sialosides for the hemagglutinin is weak (Kd≈2 mM), binding is strengthened through polyvalent interactions at the cell surface. Sauter et al. (1989) Biochem. 28, 8388-96.

Results shown in FIG. 6B reveal the binding of a recombinant avian H3 hemagglutinin (Duck/Ukraine/1/63) bound to Neu5Acα2-3-linked to galactosides (24, 162-169, 176-180, see FIG. 7), but not to any Neu5Acα2-6- or Neu5Acα2-8-linked sialosides. Intact influenza viruses, such as A/Puerto Rico/8/34 (H1N1), were also strongly bound to the array (FIG. 6C). The overall affinities are consistent with previous findings and show specificity for both α2-3 and α2-6 sialosides. Rogers, G. N. & Paulson, J. C. (1983) Virol. 127, 361-73.

Detailed fine specificities were also revealed such as binding to Neu5Acα2-3- and Neu5Acα2-6-linked to galactosides (24, 151, 157, 161-180, 182-190, 199, see FIG. 7), as well as certain O-linked sialosides.

Thus, the glycan microarrays described herein can be used to detect a variety of glycan binding entities. The microarrays can be made by robotic printing, and binding to the microarrays can be detected by scanning and image analysis software used for DNA microarrays. The combination of using amine-functionalized glycans with the NHS-activated glass surface results in robust and reproducible covalent attachment of glycans with no modifications of standard DNA printing protocols. The array can be used with no further preparation of the surface for assessing the specificity of a wide variety of glycan binding proteins, yielding uniformly low backgrounds regardless of the labeled protein used for detection. Moreover, only 0.1-2 μg of glycan binding protein is needed for optimal signal, over 100-fold less than required for an ELISA based array that uses predominately the same glycan library. Fazio et al. (2002) J. Am. Chem. Soc. 124, 14397-14402. The arrays performed well for a wide variety of glycan binding proteins, confirming primary specificities documented by other means, and revealing novel aspects of fine specificity that had not previously been recognized.

### EXAMPLE 5

### Diagnosis of Neoplasia Using Glycan Arrays

This Example illustrates that antibodies present in breast cancer patients can be detected using the glycan arrays of the invention. Only a small sample volume of human serum was needed for detecting antibodies that bound to specific types of glycans. Thus, the invention provides non-invasive screening procedures for detecting breast neoplasia.

Materials and Methods:

Individual (not pooled) sera were collected from 9 patients who were diagnosed with metastatic breast cancer (MBC). Blood samples were collected before treatment, so that therapeutic intervention would not interfere with patient immune responses. One patient with breast cancer but with good prognosis (IDC, Stage 1) was also included in the study. As control, or “healthy” sera, sera from ten healthy individuals, 5 female and 5 male, with no known malignancies was collected.

Sera were diluted 1:25 with PBS containing 3% BSA, and placed on the glycan array slide in humidified chamber at room temperature for 90 min. The glycan array slide was then rinsed gently with PBS/0.05% Tween, incubated with biotinylated goat antibody against human IgG, IgM and IgA, rinsed in PBS/0.05% Tween, and incubated with streptavidin-Alexa488 fluorescent dye. Following rinses in PBS/0.05% Tween and H₂O, glycan array slides were dried and scanned using the commercial DNA array scanner. The images were analyzed and intensity of fluorescence in spots corresponding to the antibodies bound to the individual glycans was quantified using a ScanArray 5000 (Perkin Elmer, Boston, Mass.) confocal scanner and image analyses were carried out using ImaGene image analysis software (BioDiscovery Inc, El Segundo, Calif.). Signal to background was typically greater 50:1 and no background subtractions were performed. Data were plotted using MS Excel software.

Results

The results of these experiments are provided in FIGS. 8-10. A profile of the relative fluorescence intensity of labeled antibodies bound to specific glycans on the array is provided in FIG. 8. As illustrated in FIG. 8, there are significant differences between the reactivity of sera from controls and from patients with metastatic breast cancer. In particular, the levels of certain anti-carbohydrate antibodies are much higher in patients with metastatic breast cancer. Glycans to which sera from metastatic cancer patients bind include ceruloplasmin, Neu5Gc(2-6)GalNAc, GM1, Sulfo-T, Globo-H, and LNT-2.

GM1 has the following structure: Gal-beta3-GalNAc-beta4-[Neu5Ac-alpha3]-Gal-beta4-Glc-beta.

The sulfo-T antigens are T-antigens with sulfate residues. In general, T antigens have the structure Galβ3GalNAc and can have various modifications. LNT-2 is a ligand for tumor-promoting Galectin-4. See Huflejt & Leffler (2004) Glycoconjugate J, 20: 247-255). The structure of LNT-2 includes the following glycan: GlcNAc-beta3-Gal-beta4-Glc-beta.

Globo-H has the following structure: Fucose-alpha2-Gal-beta3-GalNAc-beta3-Gal-alpha-4-Gal-beta4-Glc.

The antibodies that bind to these glycans therefore react with a series of glycan types. The clusters of glycans reactive with these antibodies define the neoplasia status more precisely then would detection of an individual antibody alone. Moreover, the levels of the antibodies reactive with individual glycan clusters can be quantified and converted into score values used for mathematical and statistical serum sample analysis that would allow diagnostic assignment of the neoplasia risk for the individual patient, when compared with the value range characteristic of the individuals with no known neoplasia.

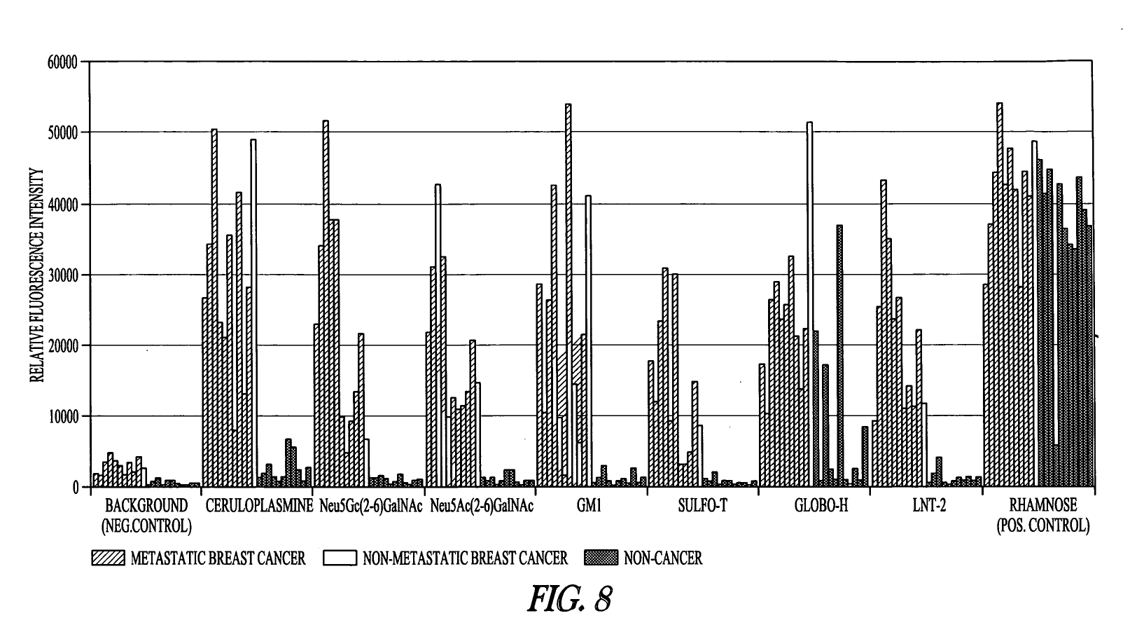

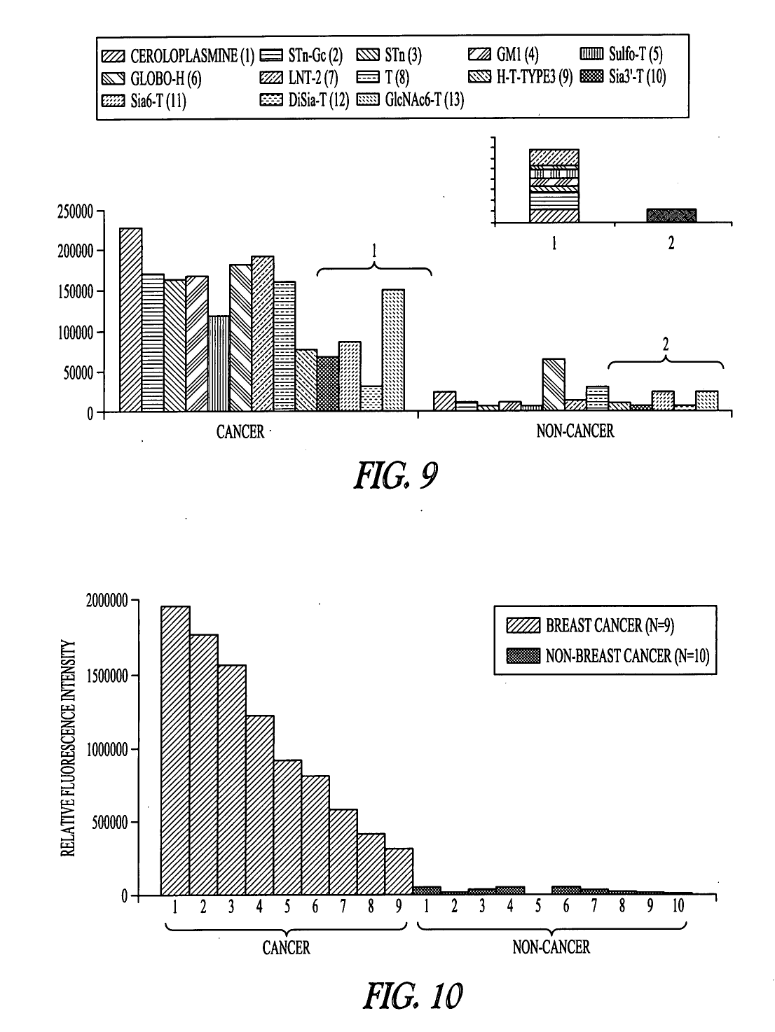

Specifically, antibodies against ceruloplasmin (FIG. 8, compound no. 2) and against cancer specific carbohydrate antigen Neu5Acα2-6GalNAcα- (STn-, FIG. 8, compound no. 3 and 4) appear at significantly higher levels in all MBC patients as compared to “healthy” individuals. There are also antibodies against other specific glycans that are present in metastatic breast cancer patients at the levels higher than in the healthy individuals. These specific glycan categories include: a group of T-antigens carrying various modifications (see FIG. 9, compounds no. 5, 8-13), LNT-2 (a known ligand for tumor-promoting Galectin-4, Huflejt and Leffler, 2004), Globo-H-, and GM1-antigens.

As shown in FIG. 10, combining the relative fluorescence intensities corresponding to the levels of serum antibodies listed in FIG. 9 for each patient allows generation of the antibody signal range that provides a clear distinction between cancer and non-cancer population. There fore, this test can provide an additional tool for appropriate correlation between specific glycoprotein profiles and various stages of disease to allow for identification of appropriate therapeutic targets.

These findings suggest that more than one glycan is present as a naturally occurring epitope during malignant transformation in breast cancer patients and these epitopes elicit immune response in each of the so far examined (breast) cancer patients. Moreover, these results indicate that clusters of different antibodies reactive against tumor-associated glycans can be detected simultaneously in the individual patient sera. Such detection of several antibody types provides much better diagnostic information than information about the presence of a single type of antibody reactive with a single type of glycan.

These combined tumor-associated glycans will be the preferred immunogen for a vaccine composition to elicit an immune response that results in production of antibodies neutralizing antibodies activities of tumor-promoting glycans. Such compositions will likely include multivalent glycans to mimic the clustered N-linked glycan epitopes on cellular surfaces of cancer, stromal, and endothelial cells.

### EXAMPLE 6

### Antibodies Against Alpha-Gal-3 Glycan Epitopes Were Detected in Sera of Patients Receiving Xenotransplants

This Example illustrates that several here-to-fore unidentified glycan structures contribute to acute organ rejection after transplantation of pig tissues into humans.

As is generally known by one of skill in the art, humans exhibit an immune response to alpha-Gal-3 glycan epitopes because these glycans are abundant on pig cell surfaces. Hence, an immune response against these alpha-Gal-3 epitopes has been a major problem that must be overcome to permit xenotransplantation of tissues. However, as illustrated in this Example other glycan structures contribute to acute organ rejection. These transplant-associated glycan structures are identified and described in this Example.

Materials and Methods

In 1991-1994, several diabetic (I) patients received transplantation of porcine fetal pancreas islet-like cell clusters (ICC). See, Groth, C. G. et al. Transplantation of porcine fetal pancreas to diabetic patients, The Lancet 344: 1402-4 (1994). The inventor analyzed serum from three of these patients before transplant (t=0), 1 months after (t=1), 6 months after (t=2) and 12 months after (t=3) transplant.

Sera were diluted as needed with PBS containing 3% BSA, and placed on the glycan array slide in humidified chamber at room temperature for 90 min. The glycan array slide was then rinsed gently with PBS/0.05% Tween, incubated with biotinylated goat antibody against human IgG, IgM and IgA, rinsed in PBS/0.05% Tween, and incubated with streptavidin-Alexa488 fluorescent dye. Following rinses in PBS/0.05% Tween and H₂O, glycan array slides were dried and scanned using the commercial DNA array scanner. The images were analyzed and intensity of fluorescence in spots corresponding to the antibodies bound to the individual glycans was quantified using a ScanArray 5000 (Perkin Elmer, Boston, Mass.) confocal scanner and image analyses were carried out using ImaGene image analysis software (BioDiscovery Inc, El Segundo, Calif.). Signal to background was typically greater 50:1 and no background subtractions were performed. Data were plotted using MS Excel software.

Results

FIG. 11 provides representative results from one patient. Similar results were seen for all patients analyzed. Glycans 33-39 (structures shown in FIG. 7) are identified as glycans 1-7 in FIG. 11D. While glycans 33-39 do not have identical structures, each of them terminate with alpha-Gal. Compared with the reactivity of serum taken at t=0 (lighter, blue bars), serum taken at 1 month after (t=1), 6 months after (t=2) and 12 months after (t=3) transplantation have significantly greater amounts of anti-glycan antibodies. Compound 8 is LeX (Gal-beta4-GlcNAc[alpha3-Fucose]-beta, structure 65 in FIG. 7) and humans do not have antibodies to this glycan structure because it is on human cells. The last structure 9, is alpha-Gal-LeX (Gal-alpha3-Gal-beta4-GlcNAc[alpha3-Fucose]-beta (structure 34 in FIG. 7), also shown in FIG. 11C), is not found in humans, but has been reported to be present on porcine kidney cells. See Bouhors D. et al., Gala1-3-LeX expressed on iso-neolacto ceramides in porcine kidney GLYCOCONJ. J. (10) 1001-16 (1998). However, patients who received transplantation of porcine fetal pancreas islet-like cell clusters clearly exhibit an immune response (antibody production) against structure 9 (alpha-Gal-LeX).

Thus, as shown in FIG. 11, the glycan arrays and methods of the invention for testing whether antibodies were present in serum of transplant recipients, illustrate that distinct differences exist in antibody responses before and after receiving tissue transplantation. The arrays and methods of the invention are therefore useful for monitoring and evaluating graft rejection after transplantation and/or xenotransplantation.

### REFERENCES

1. Hakomori, S.-I. (2001) in The Molecular Immunology of Complex Carbohydrates-2, ed. Wu, A. M. (Kluwer Academic/Plenum, publishers, pp. 369-402.
2. Taylor, M. E. & Drickamer, K. (2003) Introduction to Glycobiology (Oxford University Press, Oxford).
3. Mrksich, M. (2004) Chem. Biol. 11, 739-40.
4. Feizi, T., Fazio, F., Wengang, C. & Wong, C.-H. (2003) Curr. Opin. Struct. Biol. 13, 637-645.
5. Drickamer, K. & Taylor, M. E. (2002) Genomebiology 3, 1034.1-4.
6. Love, K. R. & Seeberger, P. H. (2002) Angew. Chem. Int. Ed. 41, 3583-3586.
7. Galanina, O. E., Mecklenburg, M., Nifantiev, N. E., Pazynina, G. V. & Bovin, N. V. (2004) Lab Chip 3, 260-5.
8. Guo, Y., Feinberg, H., Conroy, E., Mitchell, D. A., Alvarez, R., Blixt, O., Taylor, M. E., Weis, W. I. & Drickamer, K. (2004) Nat. Struct. Mol. Biol. 11, 591-8.
9. Wang, D., Liu, S., Trummer, B. J., Deng, C. & Wang, A. (2002) Nat. Biotech. 20, 275-281.
10. Fukui, S., Feizi, T., Galustian, C., Lawson, A. M. & Chai, W. (2002) Nat. Biotech. 20, 1011-1017.
11. Willats, W. G. T., Rasmussen, S. E., Kristensen, T., Mikkelsen, J. D. & Knox, J. P. (2002) Proteomics 2, 1666-1671.
12. Fazio, F., Bryan, M. C., Blixt, O., Paulson, J. C. & Wong, C.-H. (2002) J. Am. Chem. Soc. 124, 14397-14402.
13. Nimrichter, L., Gargir, A., Gortler, M., Alstock, R. T., Shtevi, A., Weisshaus, O., Fire, E., Dotan, N. & Schnaar, R. L. (2004) Glycobiology 14, 197-203.
14. Bryan, M. C., Fazio, F., Lee, H. K., Huang, C. Y., Chang, A. Y., Best, M. D., Calarese, D. A., Blixt, O., Paulson, J. C., Burton, D. R., Wilson, I. A. & Wong, C.-H. (2004) J. Am. Chem. Soc. 126, 8640-41.
15. Park, S., Lee, M. R., Pyo, S. J. & Shin, I. (2004) J. Am. Chem. Soc. 126, 4812-9.
16. Ratner, D. M., Adams, E. W., Su, J., O'Keefe, B. R., Mrksich, M. & Seeberger, P. H. (2004) Chembiochem 5, 379-82.
17. Schwarz, M., Spector, L., Gargir, A., Shtevi, A., Gortler, M., Alstock, R. T., Dukler, A. A. & Dotan, N. (2003) Glycobiology 13, 749-754.
18. Houseman, B. T. & Mrksich, M. (2002) Chem. Biol. 9, 443-454.
19. Park, S. & Shin, I. (2002) Angew. Chem. Int. Ed. 41, 3180-3182.
20. Bergh, A., Magnusson, B. G., Ohlsson, J., Wellmar, U. & Nilsson, U. J. (2001) Glycoconj. J. 18, 615-21.
21. Shiyan, S. D. & Bovin, N. V. (1997) Glycoconj. J 14, 631-8.
22. Pazynina, G. V., Sablina, M. A., Tuzikov, A. B., Chinarev, A. A. & Bovin, N. V. (2003) Mendeleev Commun. 13, 245-248.
23. Pazynina, G. V., Tyrtysh, T. V. & Bovin, N. V. (2002) Mendeleev Commun. 12, 183-184.
24. Pazynina, G. V., Tuzikov, A. B., Chinarev, A. A., Obukhova, P. & Bovin, N. V. (2002) Tet. Lett. 43, 8011-8013.
25. Nifant'ev, N. E., Tsvetkov, Y. E., Shashkov, A. S., Kononov, L. O., Menshov, V. M., Tuzikov, A. B. & Bovin, N. V. (1996) J. Carbohydr. Chem. 15, 939-953.
26. Zemlyanukhina, T. V., Nifant'ev, N. E., Shashkov, A. S., Tsvetkov, Y. E. & Bovin, N. V. (1995) Carbohydr. Lett. 1, 277-284.
27. Lee, H. K., Scanlan, C. N., Huang, C. Y., Chang, A. Y., Calarese, D. A., Dwek, R. A., Rudd, P. M., Burton, D. R., Wilson, I. A. & Wong, C. H. (2004) Angew. Chem. Int. Ed. 43, 1000-1003.
28. van Die, I., van Vliet, S. J., Nyame, A. K., Cummings, R. D., Bank, C. M. C., Appelmelk, B. J., Geijtenbeek, T. B. & Kooyk, Y. (2003) Glycobiology 13, 471-478.
29. Gamblin, S. J., Haire, L. F., Russell, R. J., Stevens, D. J., Xiao, B., Ha, Y., Vasisht, N., Steinhauer, D. A., Daniels, R. S., Elliot, A., Wiley, D.C. & Skehel, J. J. (2004) Science 303, 1838-42.
30. Calarese, D. A., Scanlan, C. N., Zwick, M. B., Deechongkit, S., Mimura, Y., Kunert, R., Zhu, P., Wormald, M. R., Stanfield, R. L., Roux, K. H., Kelly, J. W., Rudd, P. M., Dwek, R. A., Katinger, H., Burton, D. R. & Wilson, I. A. (2003) Science 300, 2065-71.
31. Scanlan, C. N., Pantophlet, R., Wormald, M. R., Ollmann Saphire, E., Stanfield, R., Wilson, I. A., Katinger, H., Dwek, R. A., Rudd, P. M. & Burton, D. R. (2002) J. Virol. 76, 7306-21.
32. Blixt, O., Collins, B. E., van den Nieuwenhof, I. M., Crocker, P. R. & Paulson, J. C. (2003) J. Biol. Chem. 278, 31007-19.
33. Huflejt, M. E., Jordan, E. T., Gitt, M. A., Barondes, S. H. & Leffler, H. (1997) J. Biol. Chem. 272, 14294-303.
34. Ting, C. A., Lee, S.-F. & Wang, K. (2003) BioTechniques 35, 808-810.
35. Blixt, O. & Razi, N. (2004) in Synthesis of Carbohydrates through Biotechnology, eds. Wang, P. G. & Ichikawa, Y. (American Chemical Society, Washington D.C.), Vol. 873, pp. 93-112.
36. Collins, B. E. & Paulson, J. C. (2004) Curr. Opin. Chem. Biol. in press.
37. Gupta, D., Oscarson, S., Raju, T. S., Stanely, P., Toone, E. J. & Brewer, C. F. (1996) Eur. J. Biochem. 242, 320-326.
38. Brewer, F., Bhattacharyya, L., Brown, R. D. & Koenig, S. H. (1985) Biochem. Biophys. Res. Commun. 127, 1066-71.
39. Lis, H. & Sharon, N. (1987) Meth. Enzymol. 138, 544-551.
40. Iglesias, J. L., L is, H. & Sharon, N. (1982) Eur. J. Biochem. 123, 247-252.
41. Kooyk, Y. & Geijtenbeek, T. B. (2002) Immunol. Rev. 186, 47-56.
42. Adams, E. W., Ratner, D. M., Bokesch, H. R., McMahon, J. B., O'Keefe, B. R. & Seeberger, P. H. (2004) Chem.l Biol. 11, 875-81.
43. Engel, P., Nojima, Y., Rothstein, D., Zhou, L. J., Wilson, G. L., Kehrl, J. H. & Tedder, T. F. (1993) J. Immunol. 150, 4719-4732.
44. Kelm, S., Pelz, A., Schauer, R., Filbin, M. T., Tang, S., de Bellard, M. E., Schnaar, R. L., Mahoney, J. A., Hartnell, A., Bradfield, P. & Crocker, P. R. (1994) Curr. Biol. 4, 965-72.
45. Powell, L. D., Sgroi, D., Sjoberg, E. R., Stamenkovic, I. & Varki, A. (1993) J. Biol. Chem. 268, 7019-7027.
46. Hirabayashi, J., Hashidate, T., Arata, Y., Nishi, N., Nakamura, T., Hirashima, M., Urashima, T., Oka, T., Futai, M., Muller, W. E., Yagi, F. & Kasai, K. (2002) Biochim. Biophys. Acta 1572, 232-54.
47. Huflejt, M. E. & Leffler, H. (2004) Glycoconjugate J. 20, 247-55.
48. Wu, A. M., Wu, J. H., Liu, J. H., Singh, T., Andre, S., Kaltner, H. & Gabius, H. J. (2004) Biochimie 86, 317-26.
49. Oda, Y., Herrmann, J., Gitt, M. A., Turck, C. W., Burlingame, A. L., Barondes, S. H. & Leffler, H. (1993) J. of Biol. Chem. 268, 5929-5939.
50. Sanders, R. W., Venturi, M., Schiffner, L., Kalyanaraman, R., Katinger, H., Lloyd, K. O., Kwong, P. D. & Moore, J. P. (2002) J. Virol. 76, 7293-305.
51. Trkola, A., Purtscher, M., Muster, T., Ballaun, C., Buchacher, A., Sullivan, N., Srinivasan, K., Sodroski, J., Moore, J. P. & Katinger, H. (1996) J. Virol. 70, 1100-8.
52. Bewely, C. A. & Otero-Quintero, S. (2001) J. Am. Chem. Soc. 123, 3892-3902.
53. Connor, R. J., Kawaoka, Y., Webster, R. G. & Paulson, J. C. (1994) Virol. 205, 17-23.
54. Rogers, G. N. & D'Souza, B. L. (1989) Virol. 173, 317-22.
55. Rogers, G. N., Paulson, J. C., Daniels, R. S., Skehel, J. J., Wilson, I. A. & Wiley, D.C. (1983) Nature 304, 76-8.
56. Sauter, N. K., Bednarski, M. D., Wurzburg, B. A., Hanson, J. E., Whitesides, G. M., Skehel, J. J. & Wiley, D.C. (1989) Biochem. 28, 8388-96.
57. Rogers, G. N. & Paulson, J. C. (1983) Virol. 127, 361-73.
58. Vallee, F., Karaveg, K., Herscovics, A., Moremen, K. W., and Howell, P. L. (2000). Structural basis for catalysis and inhibition of N-glycan processing class I alpha 1,2-mannosidases. J Biol Chem 275, 41287-41298.
59. Tremblay, L. O., and Herscovics, A. (2000). Characterization of a cDNA encoding a novel human Golgi alpha 1,2-mannosidase (IC) involved in N-glycan biosynthesis. J Biol Chem 275, 31655-31660.
60. Hakomori S. 2001. Tumor-associated carbohydrate antigens defining tumor malignancy: basis for development of anti-cancer vaccines. Adv Exp Med. Biol. 491: 369-402.
61. Hakomori S. 1996. Tumor malignancy defined by aberrant glycosylation and sphingo(glyco)lipid metabolism. Cancer Res. 56: 5309-18.
62. Senra Varela, A., Bosco Lopez Saez J J, and Quintela Sera D. 1997. Serum ceruloplasmin as a diagnostic marker of cancer. Cancer Lett. 121: 139-145.
63. Koenig A, Jain R, Vig R, Norgard-Sumnicht K E, Matta K L, Varki A. 1997. Selectin inhibition: synthesis and evaluation of novel sialylated, sulfated and fucosylated oligosaccharides, including the major capping group of GlyCAM-1. Glycobiology. 7:79-93.
64. Sarkar A K, Rostand K S, Jain R K, Matta K L, Esko J D. 1997. Fucosylation of disaccharide precursors of sialyl LewisX inhibit selectin-mediated cell adhesion. J Biol Chem. 272: 25608-16.
65. Huflejt, M E., and Leffler, H. Galectin-4 in normal tissues and cancer. (2004). Glycoconjugate J, 20: 247-255.
66. Blixt, O., S. Head, T. Mondala, C. Scanlan, M. E. Huflejt, R. Alvarez, M. C. Bryan, F. Fazio, D. Calarese, J. Stevens, N. Razi, D. J. Stevens, J. J. Skehel, I. van Die, D. R. Burton, I. A. Wilson, R. Cummings, N. Bovin, C. H. Wong, and J. C. Paulson. 2004. Printed covalent glycan array for ligand profiling of diverse glycan binding proteins. Proc Natl Acad Sci USA 101:17033-17038.
67. Casey, S. 2005. Microarrays on the spot; Year in review. Pharmaceutical Discovery November/December: 16-20.
69. Seeberger, P. H., and D. B. Werz. 2005. Automated synthesis of oligosaccharides as a basis for drug discovery. Nat Rev Drug Discov 4:751-763.
70. Ye, X. S., and C. H. Wong. 2000. Anomeric reactivity-based one-pot oligosaccharide synthesis: a rapid route to oligosaccharide libraries. J Org Chem 65:2410-2431.
71. Baues, R. J., and G. R. Gray. 1977. Lectin purification on affinity columns containing reductively aminated disaccharides. J Biol Chem 252:57-60.
72. Matsumoto, I., Y. Ito, and N. Seno. 1982. Preparation of Affinity Adsorbents with Toyopearl Gels. Journal of Chromatography 239:747-754.
73. Xia, B., Z. S. Kawar, T. Ju, R. A. Alvarez, G. P. Sachdev, and R. D. Cummings. 2005. Versatile fluorescent derivatization of glycans for glycomic analysis. Nat Methods 2:845-850.
74. Seppällä, I., and O. Mäkelä. 1989. Journal of Immunology 143:1259-1264.
75. Peri, F., P. Dumy, and M. Mutter. 1998. Chemo- and stereoselective glycosylation of hydroxylamino derivatives: A versatile approach to glycoconjugates. Tetrahedron 54:12269-12278.
76. Carrasco, M. R., and R. T. Brown. 2003. A versatile set of aminooxy amino acids for the synthesis of neoglycopeptides. J Org Chem 68:8853-8858.
77. Niikura, K., R. Kamitani, M. Kurogochi, R. Uematsu, Y. Shinohara, H. Nakagawa, K. Deguchi, K. Monde, H. Kondo, and S. Nishimura. 2005. Versatile glycoblotting nanoparticles for high-throughput protein glycomics. Chemistry 11:3825-3834.
78. Blixt, O., I. van Die, T. Norberg, and D. H. van den Eijnden. 1999. High-level expression of the Neisseria meningitidis 1gtA gene in escherichia coli and characterization of the N-acetylglucosaminyltransferase as a useful catalyst in the synthesis of GlcNAcβ1-3Gal and GalNAcβ1-3Gal linkages. Glycobiology 9:1061-1071.
79. Blixt, O., and T. Norberg. 1999. Enzymatic glycosylation of reducing oligosaccharides linked to a solid phase or a lipid via a cleavable squarate linker. Carbohydr Res 319:80-91.
80. Kajihara, Y., N. Yamamoto, T. Miyazaki, and H. Sato. 2005. Synthesis of diverse asparagine linked oligosaccharides and synthesis of sialylglycopeptide on solid phase. Curr Med Chem 12:527-550.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “an antibody” includes a plurality (for example, a solution of antibodies or a series of antibody preparations) of such antibodies, and so forth. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. In addition, where features or aspects of the invention are described in terms of Markush groups, those skilled in the art will recognize that the invention is also thereby described in terms of any individual member or subgroup of members of the Markush group.

What is claimed:

1. A bi-functional spacer of Formula IA or IB: 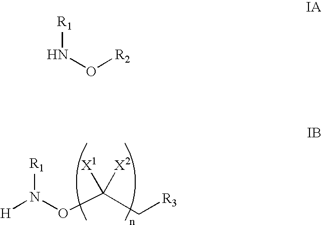
wherein:
R₁ is alkyl, acyl, aryl, lipid, amine, thiol, or hydroxy;
R₂ is alkyl alkylamine, alkylthiol, polyalkylene glycol, peptide, lipid, alkylcarboxylate, alkylcarboxylate alkyl ester, alkylacyl, alkylketone, or alkylaldehyde that can be substituted with one or more amine groups;
R₃ is amine, alkene, alkyne, alkyl, alkylthiol, thiol, hydroxy, carboxylic acid, alkylcarboxylate, alkylcarboxylate alkyl ester, polyalkylene glycol, peptide, lipid, dye, label, acylalkyl, alkylketone, aldehyde, or alkylaldehyde that can be substituted with one or more amine groups;
n is an integer of from 0 to 50; and
X¹ and X² are each hydrogen or halo.

2. The bi-functional spacer of claim 1, wherein the R₁ group is an alkyl.

3. The bi-functional spacer of claim 1, wherein the R₃ group is an amine.

4. The bi-functional spacer of claim 1, wherein the X¹ and X² are each hydrogen.

5. The bi-functional spacer of claim 1, comprising the following formula: 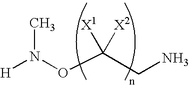
wherein:
n is an integer of from 0 to 50; and
X¹ and X² are each hydrogen or fluoro (F).

6. The bi-functional spacer of claim 1, further comprising a dye or label.

7. The bi-functional spacer of claim 1, wherein spacer has the following formula (IG): 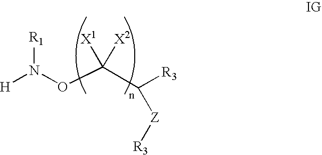
wherein Z is sulfur atom (S) or oxygen atom (O).

8. A library of glycans, each glycan linked to the bi-functional spacer of claim 1.

9. An array of glycan molecules comprising a solid support and a library of glycan molecules, wherein each glycan molecule is covalently attached to the solid support via a bi-functional spacer of claim 1.

10. A glycan linked to the bi-functional spacer of claim 1.

11. The glycan of claim 10, wherein the glycan has formula IIA or IIB 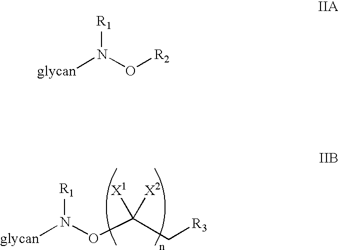
wherein:
R₁ is alkyl, acyl, aryl, lipid, amine, thiol, or hydroxy;
R₂ is alkyl, alkylamine, alkylthiol, polyalkylene glycol, peptide, lipid, alkylcarboxylate, alkylcarboxylate alkyl ester, alkylacyl, alkylketone, or alkylaldehyde that can be substituted with one or more amine groups;
R₃ is amine, alkene, alkyne, alkyl, alkylthiol, thiol, hydroxy, carboxylic acid, alkylcarboxylate, alkylcarboxylate alkyl ester, polyalkylene glycol, peptide, lipid, dye, label, acylalkyl, alkylketone, aldehyde, or alkylaldehyde that can be substituted with one or more amine groups;
n is an integer of from 0 to 50; and
X¹ and X² are each hydrogen or halo.

12. The glycan of claim 11, wherein the R₁ group is an alkyl.

13. The glycan of claim 11, wherein the R₃ group is an amine.

14. The glycan of claim 11, wherein the X¹ and X² are each hydrogen.

15. A library of glycans, each glycan linked to the bi-functional spacer of claim 1.

16. An array of glycan molecules comprising a solid support and a library of glycan molecules, wherein each glycan molecule is covalently attached to the solid support via a bi-functional spacer of claim 1.

17. The array of claim 16, wherein the glycan molecules are printed onto an N-hydroxysuccinimide (NHS)-derivatized solid support.

18. The array of claim 16, comprising 10-100,000 separate, isolated glycans, wherein the glycans are straight or branched chains of allose, altrose, arabinose, glucose, galactose, gulose, fucose, fructose, idose, lyxose, mannose, ribose, talose, or xylose sugar units covalently linked together by alpha (α) or beta (β) covalent linkages; and the sugar units can have N-acetyl, N-acetylneuraminic acid, oxy (═O), sialic acid, sulfate (—SO₄⁻), phosphate (—PO₄⁻), lower alkoxy, lower alkanoyloxy, lower acyl, and/or lower alkanoylaminoalkyl substituents that are present instead of, or in addition to, hydroxy (—OH), carboxylic acid (—COOH) and methylenehydroxy (—CH₂—OH) substituents present on the sugar units.

19. The array of claim 16, wherein the glycans comprise glycoamino acids, glycopeptides, glycolipids, glycoaminoglycans, glycoproteins, cellular components, glycoconjugates, glycomimetics, glycophospholipids, glycosyl phosphatidylinositol-linked glycoconjugates, bacterial lipopolysaecharides or a combination thereof.

20. The array of claim 16, wherein at least one glycan comprises an alpha-Gal-3 glycan, an alpha-Gal-LeX glycan, a Fucα1-3GlcNAc glycan, a Fucα1-4GlcNAc glycan, a Siaα2-6Galβ1-4GlcNAc glycan, a Neu5Acα2-6Galβ1-4GlcNAc[6Su] glycan, a Lewis^{x} (Galβ1-4[Fucα1-3]GlcNAc) glycan, a Neu5Acα2-3-galactoside, a Neu5Acα2-6-sialoside, a Neu5Acα2-8-sialoside or a combination thereof.

21. A method of testing whether a molecule in a test sample can bind to a glycan comprising, (a) contacting glycans in the array of claim 16 with the test sample, and (b) observing whether a molecule in the test sample binds to a glycan in the array.

22. The method of claim 21, wherein the method further comprises determining which molecule in the test sample binds to the glycan.

23. The method of claim 21, wherein the molecule is an antibody, an enzyme, a viral protein, a cellular receptor, a cell type specific antigen, or a nucleic acid.

24. The method of claim 21, wherein the test sample is blood, serum, anti-serum, monoclonal antibody preparation, lymph, plasma, saliva, urine, semen, breast milk, ascites fluid, tissue extract, cell lysate, cell suspension, viral suspension, or a combination thereof.

25. A method for linking a bi-functional spacer of claim 1 to a glycan, comprising mixing the spacer with a glycan in an aqueous buffer with a pH of about pH 4.0 to about 6.9.

26. The method of claim 25, wherein the glycan has a reducing sugar on its terminus.

27. The method of claim 25, wherein the glycan has a ketone, aldehyde, or carboxylate at its terminus.

28. A kit comprising the array of claims 16 and instructions for using the array.
